(19) United States
(12) Patent Application Publication
(10) Pub. No.: US 2026/0140940 A1
(43) Pub. Date: May 21, 2026

(54) Systems and Methods for Enabling Sketch-Based Data Exploration through Data Trend Analysis and ad hoc Annotation

(71) Applicant: Salesforce, Inc., San Francisco, CA (US)

(72) Inventors: Dennis Nathan BROMLEY, Falls Church, VA (US); Diana WANG, Seattle, WA (US); Vidya Raghavan SETLUR, Portola Valley, CA (US)

(21) Appl. No.: 19/390,089

(22) Filed: Nov. 14, 2025

Related U.S. Application Data
(60) Provisional application No. 63/721,402, filed on Nov. 15, 2024.
(60) Provisional application No. 63/765,441, filed on Feb. 28, 2025.
(60) Provisional application No. 63/781,244, filed on Mar. 31, 2025.

(51) Int. Cl. G06F 16/242; G06F 16/2452; G06F 16/248

(52) U.S. Cl. CPC G06F 16/242; G06F 16/2452; G06F 16/248

(57) ABSTRACT

A computer system receives, via a user interface, a first sketch input corresponding to a first measure data field of a dataset. The computer system converts the first sketch input into a first set of line segments and determines respective values for a first set of parameters corresponding to the first set of line segments. The computer system executes a first query against a database of linearized data using the first set of parameters to identify one or more sets of linearized data. Each set of linearized data corresponds to a respective dimensional dataset for the first measure data field. The computer system retrieves, from the database, one or more first dimensional datasets corresponding to the one or more sets of linearized data, generates one or more first data visualizations from the one or more retrieved first dimensional datasets, and displays the first data visualizations via the user interface.

### RELATED APPLICATIONS

This application claims the benefit of and priority to (i) U.S. Provisional Application No. 63/721,402, filed Nov. 15, 2024, titled “SketchQL: Supporting Sketch-Based Querying for Data Trend Analysis,” (ii) U.S. Provisional Application No. 63/765,441, filed Feb. 28, 2025, titled “SketchQL: Supporting Sketch-Based Querying for Data Trend Analysis,” and (iii) U.S. Provisional Application No. 63/781,244, filed Mar. 31, 2025, titled “SKETCHQL: Enabling Sketch-Based Data Exploration Through Trend Analysis and ad hoc Annotation.” Each of the aforementioned applications is incorporated by reference herein in its entirety.

### TECHNICAL FIELD

The disclosed implementations relate generally to data analysis, and more specifically to systems, methods, and user interfaces that enable users to query data via sketch inputs.

### BACKGROUND

The study of data patterns an important aspect of the data analysis and decision-making process. Example of data patterns can include data trends that indicate a general change in data attributes (e.g., data fields, or data values of a data field) over time. Other examples of data patterns include hurricane paths, wind patterns, or flight trajectories. The identification of data patterns can in turn lead to the recognition of anomalies or deviations from normal or expected values of a dataset, due to factors such as significant events, seasonality, and market conditions.

### SUMMARY

Visual data analysis tools often visualize trends as line charts. These tools can also provide additional computation functionality such as moving averages, trend lines, or regression analysis to indicate how the data changes over time.

Traditional search systems rely on accurately understanding queries to deliver relevant search results. However, the precision and recall of these search systems often depend on mapping the mental model of the search intent with the metadata and keywords that represent content, a process that can be complex due to the subjective nature of how users conceptualize and describe their search goals. Users may struggle to accurately convey their data exploration intent, especially when the patterns they are searching for are subtle or difficult to articulate using conventional query languages. For example, differentiating between a “sharp rise” and a “gradual increase” in data trends can be ambiguous and imprecise when relying solely on keywords or basic query terms.

For content such as images and sound, the traditional text-based or user interface-controlled input often lacks the flexibility to capture the full spectrum of user intent. For instance, in an image search, users may know the visual style or composition they seek but find it difficult to encapsulate this in keywords. Similarly, for music content retrieval, users might search for a specific auditory quality or mood that does not neatly translate into existing categorical tags or descriptors.

Accordingly, there is a need for improved systems and methods that capture the subtle complexities of analytical intent, especially when users seek to identify data patterns that are difficult to describe using traditional query methods or natural language.

Some embodiments of the present disclosure are directed to SketchQL, a tool that integrates a sketch-based user interface with a search mechanism to explore data patterns. In some embodiments, SketchQL provides a sketch-driven query pipeline that translates freeform drawings into normalized geometric parameters (e.g., per-segment midpoints, lengths, angles, slopes, and/or time context), compares them against preprocessed, linearized datasets at multiple epsilon resolutions, and returns best-fit results using weighted alignment and dynamic programming with early-exit pruning. In some embodiments, SketchQL may incorporate saliency from annotations and multimodal metadata (color, stroke thickness, nib type, pressure, dwell time, speed, tilt) to weight segments and adapt matching tolerances, enabling precise yet robust querying.

AS disclosed, SketchQL includes a sketch-based user interface that enables users to draw (e.g., via a mouse, a stylus, a hand sketch, or a hand gesture) shapes representing desired data patterns (e.g., shapes or contours) on a digital canvas. Example data patterns can include shapes and/or contours. In some embodiments, the data patterns can include data trends that indicate a general change in data attributes (e.g., data fields and/or data values of data fields) over time or geospatial paths in data. In some embodiments, SketchQL can search for complex data patterns that may be difficult to express through traditional text queries. For instance, users could sketch anticipated geographical data patterns they wish to monitor, such as hurricane paths or wind patterns (e.g., having geographical units/coordinates such as longitude and latitude coordinates), or flight trajectories (e.g., where the units of measurement are longitude, latitude, and altitude).

In some embodiments, SketchQL is integrated with a flexible yet precise geometric search mechanism with bimodal large language model (LLM)-backed data-analytics. As disclosed, in some embodiments, in addition to expressing trends and time-based paths, the SKETCHQL user interface provides a large language model (LLM)-backed sketch-annotation engine that gives the user an open-ended tool for augmenting their sketch queries. This engine integrates customary natural language control with additional modalities of expressing intent, such as handwritten text and free-hand scribbles and circles, with an LLM that parses and analyzes the annotations to generate a corresponding SQL query, which is then run against the preprocessed dataset. The system interprets these shapes to retrieve matching data visualizations. In some embodiments, the system interprets these shapes by comparing them to a pre-processed dataset, and translating the sketch into a set of query terms that capture the geometric and temporal aspects of the data. In some embodiments, a user can further control their data search by annotating the visualization with scribbles and cross-outs, inclusion circles, natural language directives, and ad hoc LLM-backed data analytics.

In some embodiments, SketchQL's sketch-driven query pipeline includes preprocessing data into self and global normalization spaces, performing linearization (e.g., Douglas-Peucker-based) segmentation, storing per-segment properties, and supporting signal:signal similarity scoring with penalties for rotation, translation, scale, segment skipping, segment count, and stretch. In some embodiments, SketchQL organizes datasets into shape-based clusters and surfaces ranked, contiguous autocompletion options for partial sketches, thereby narrowing the search space and accelerating interactive refinement. In some embodiments, for sketches that do not match existing data, SketchQL converts the combined shape into compact alert descriptors and monitors real-time streams with lightweight parameter comparisons to trigger automated workflows. It also supports multimodal LLM-backed annotation parsing to convert inclusion/exclusion marks and textual directives into SQL, intersects these results with trend matches, and renders consolidated visualizations, delivering a scalable, low-latency, and high-precision end-to-end solution for sketch-based data exploration and automation.

As disclosed, in some embodiments, SketchQL enhances the expressiveness of queries by enabling users to specify trends through sketches, eliminating the need for technical query language. In some embodiments, SketchQL interprets the sketch inputs using a predefined set of quantitative trend descriptors that categorize the visual features of the sketch—such as slope direction, curvature, and magnitude—and matches them with corresponding data trends. Advantageously, this enables users to bypass the complexities of textual queries, making data exploration more accessible and precise.

As disclosed, in some embodiments, SketchQL enhances data exploration tools by providing a more expressive, user-friendly interface that caters to both novice and expert users. Businesses benefit by enabling more efficient and effective data analysis, allowing teams to quickly identify important trends without the need for specialized query knowledge. For customers, particularly those without a deep background in data science, SketchQL makes it easier to interact with and understand their data, empowering them to make more informed decisions based on visually-defined trends.

Accordingly, SketchQL provides a specific technical solution to a computer-centric problem of how to express and execute complex trend queries that are difficult to state in text. For example, as disclosed, SketchQL converts sketches into normalized geometric parameters and runs highly optimized alignment and scoring. This improves the functioning of the computer by reducing CPU cycles, memory bandwidth, and latency via (i) offline preprocessing into linearized segments at multiple epsilon levels, (ii) per-segment midpoints, lengths, angles normalized to 0-1, (iii) Manhattan-distance midpoint differencing, (iv) angle normalization and weighting to penalize rotation highly, (v) dynamic programming with early exit pruning using a maximum Error threshold, and (vi) least-errors path alignment with segment skipping penalties.

The systems, methods, and user interfaces of this disclosure each have several innovative aspects, no single one of which is solely responsible for the desirable attributes disclosed herein.

In one aspect, a method for analyzing data is implemented at a computer system that includes one or more processors and memory. The method includes receiving, via a user interface, a first sketch input corresponding to a first measure data field of a dataset. The method includes converting the first sketch input into a first set of line segments. The method includes determining respective values for a first set of parameters corresponding to the first set of line segments. The method includes executing a first query against a database of linearized data using the first set of parameters to identify one or more sets of linearized data from the database, where each set of linearized data corresponds to a respective dimensional dataset for the first measure data field. The method includes retrieving, from the database, one or more first dimensional datasets corresponding to the one or more sets of linearized data. The method includes generating one or more first data visualizations from the one or more retrieved first dimensional datasets. The method also includes displaying, via the user interface, the one or more first data visualizations.

In another aspect, a method for automating workflows is implemented at a computer system that includes one or more processors and memory. The method includes receiving a sketch input. The method includes in response to receiving the sketch input, executing a query against a database to determine whether the database includes one or more datasets whose data distribution matches a shape of the sketch input. The method includes in accordance with a determination that the database does not include a dataset whose distribution matches the shape of the sketch input, generating an alert condition according to the shape of the sketch input. The method includes receiving a data stream subsequent to generating the alert condition. The method includes determining whether data in the data stream includes a distribution that matches the shape of the sketch input. The method includes in accordance with a determination, based on processing data in the data stream, that at least a portion of the data in the data stream includes a distribution that matches the shape of the sketch input, (i) determining that the alert condition is satisfied; (ii) generating a workflow instruction; and (iii) at least partially controlling a workflow using the workflow instruction.

In another aspect, a method is implemented at a computer system that includes a display, one or more sensors, memory, and one or more processors. The method includes receiving, via the display, a sketch input directed to a data source. The method includes in response to receiving the sketch input, determining one or more of (i) one or more annotations included with the sketch input, and (ii) metadata corresponding to the sketch input. The method includes determining a context or saliency of the sketch input according to the one or more annotations and/or the metadata. The method includes determining a set of parameters for the sketch input according to the determined context or saliency. The method includes executing a query against a database using the set of parameters to retrieve one or more datasets. The method includes generating one or more data visualizations from the one or more retrieved datasets. The method also includes displaying, via the display, the one or more data visualizations.

In another aspect, a method is implemented at a computer system that includes one or more processors and memory. The method includes receiving, via a user interface, a first portion of a sketch input. The first portion of the sketch input has a first shape. The method includes in response to receiving the first portion of the sketch input, determining a first set of parameters corresponding to the first portion of the sketch input. The method includes executing a query against a database using the first set of parameters. The database includes datasets that are organized into a plurality of data clusters according to respective shapes of the datasets that are determined from respective data distributions of the dataset. The method includes determining that a first data cluster of the plurality of data clusters has a first data distribution that, when visualized, matches the first shape of the first portion of the sketch input. The method includes identifying a plurality of second data clusters according to the determined first cluster. The method includes determining a plurality of shapes corresponding to the plurality of second data clusters. The method includes generating a plurality of visual representations, each visual representation corresponding to a respective shape of the plurality of shapes. The method also includes displaying, via the user interface, the plurality of visual representations as a plurality of options for a second portion of the sketch input, where the second portion is contiguous to the first portion.

In another aspect, a method is implemented at a computer system that includes one or more processors and memory. The method includes receiving, via a user interface, a sketch input and an analytics query. The method includes converting the sketch input into a set of line segments. The method includes determining respective values of a set of parameters corresponding to the set of line segments. The method includes executing a query against a database using the set of parameters to retrieve one or more datasets. The method also includes performing data analytics on the one or more retrieved datasets in accordance with the analytics query.

In another aspect, a method for preparing data for subsequent analysis is implemented at a computer system that includes one or more processors and memory. The method includes obtaining a plurality of datasets. Each dataset of the plurality of datasets includes (i) at least one dimension field, (ii) at least one measure field, and (iii) data values corresponding to the at least one dimension field and the at least one measure field. The method includes, for a respective dataset in the plurality of datasets, for each measure field in the respective dataset, for each normalization schema of one or more normalization schemas: (a) normalizing data in the respective dataset, for a respective measure field, according to a respective normalization schema, to obtain a normalized dataset for the respective measure according to the respective schema; (b) converting the normalized dataset for the respective measure according to the respective schema into one or more sets of linearized data, wherein each set of linearized data includes a respective set of linear segments. The method includes for each set of linearized data, determining respective values for a set of parameters corresponding to the set of linearized data. The method also includes saving the respective values with the respective dataset into a database.

In accordance with some embodiments, a computing device (e.g., client device) includes a display, one or more processors, and memory coupled to the one or more processors. The memory stores one or more programs configured for execution by the one or more processors. The one or more programs include instructions for performing any of the methods disclosed herein.

In accordance with some embodiments, a non-transitory computer readable storage medium stores one or more programs configured for execution by a computing device (e.g., client device) having a display, one or more processors, and memory. The one or more programs include instructions for performing any of the methods disclosed herein.

In accordance with some embodiments, a computer system includes one or more processors and memory coupled to the one or more processors. The memory stores one or more programs configured for execution by the one or more processors. The one or more programs include instructions for performing any of the methods disclosed herein.

In accordance with some embodiments, a non-transitory computer readable storage medium stores one or more programs configured for execution by a computer system having one or more processors, and memory. The one or more programs include instructions for performing any of the methods disclosed herein.

Thus methods, systems, and graphical user interfaces are disclosed that support data queries based on sketch inputs.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the inventive subject matter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

For a better understanding of the aforementioned systems, methods, and graphical user interfaces, as well as additional systems, methods, and graphical user interfaces that provide data visualization analytics, reference should be made to the Detailed Description of Implementations below, in conjunction with the following drawings in which like reference numerals refer to corresponding parts throughout the figures.

FIG. 1 illustrates an example operating environment, in accordance with some embodiments.

FIG. 2 provides a block diagram of a client device, in accordance with some embodiments.

FIGS. 3A and 3B provide a block diagram of a server system, in accordance with some embodiments.

FIG. 3C illustrates an architectural overview of SketchQL, in accordance with some embodiments.

FIG. 3D illustrates a data processing flow for SketchQL, in accordance with some embodiments.

FIGS. 4A to 4C illustrate a display of a client device, in accordance with some embodiments.

FIGS. 5A to 5G illustrate a user interface for a sketch-based data query system, in accordance with some embodiments.

FIGS. 6A to 6D illustrate a linearization process, in accordance with some embodiments.

FIGS. 7A to 7D illustrate a linearization process, in accordance with some embodiments.

FIG. 8A illustrates an example of a signal linearized at different Peucker-epsilon levels, in accordance with some embodiments.

FIG. 8B illustrates the role of epsilon in Douglas-Peucker segmentation.

FIG. 9 illustrates an exemplary algorithm for backend preprocessing, in accordance with some embodiments.

FIG. 10 shows an example of aligning a continuous sketch to a data signal, in accordance with some embodiments.

FIG. 11 illustrates an example algorithm for query processing, in accordance with some embodiments.

FIG. 12 illustrates an example of aligning a discontinuous sketch, in accordance with some embodiments.

FIGS. 13A to 13C illustrate a process for generating a connected graph of shape data, in accordance with some embodiments.

FIGS. 14A to 14F illustrate query refinement using cluster analysis, in accordance with some embodiments.

FIG. 14G illustrates another example of signal clustering, in accordance with some embodiments.

FIGS. 15A to 15E illustrate an abstract query analytics process, in accordance with some embodiments.

FIGS. 16A to 16P are screenshots illustrating user interactions with the SketchQL user interface, in accordance with some embodiments.

FIGS. 17A to 17F provide a flowchart of an example process for analyzing sketch input data, in accordance with some embodiments.

FIGS. 18A to 18C provide a flowchart of an example process for generated automated workflows, in accordance with some embodiments.

FIGS. 19A and 19B provide a flowchart of an example process for analyzing sketch input data, in accordance with some embodiments.

FIGS. 20A to 20D provide a flowchart of an example process for analyzing sketch input data, in accordance with some embodiments.

FIG. 21 provides a flowchart of an example process for proxy data analytics, in accordance with some embodiments.

FIGS. 22A and 22B provide a flowchart of an example process for analyzing data, in accordance with some embodiments.

FIGS. 23A to 23E illustrate an example SketchQL annotation interpretation and generated SQL, in accordance with some embodiments.

FIG. 24A to 24H illustrates an example LLM prompt for parsing baby name annotations, in accordance with some embodiments.

FIG. 25A to 25M illustrate an example LLM prompt for parsing storm track annotations, in accordance with some embodiments.

Reference will now be made to implementations, examples of which are illustrated in the accompanying drawings. In the following description, numerous specific details are set forth in order to provide a thorough understanding of the present invention. However, it will be apparent to one of ordinary skill in the art that the present invention may be practiced without requiring these specific details.

### DETAILED DESCRIPTION OF IMPLEMENTATIONS

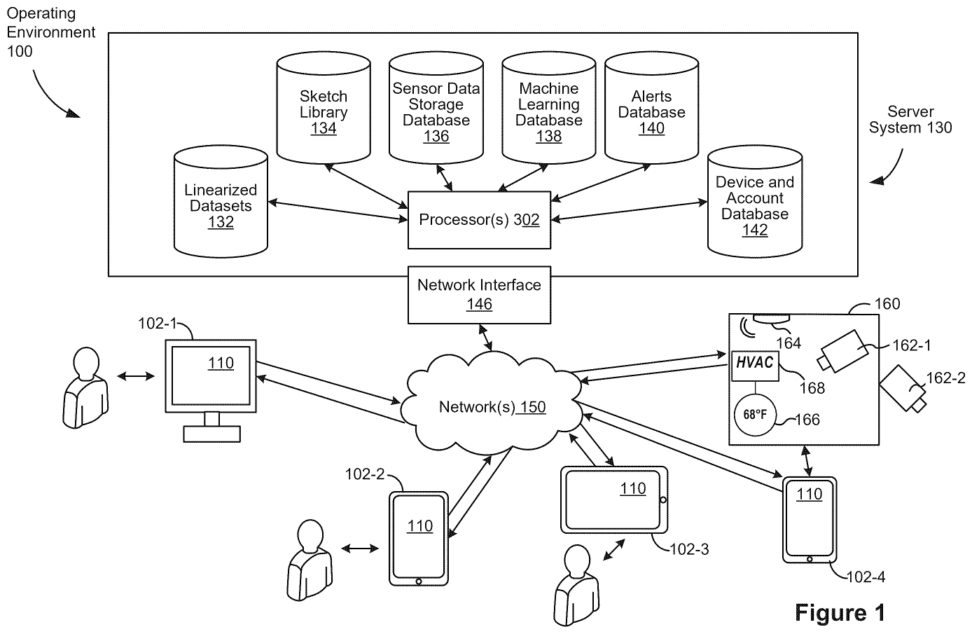

FIG. 1 illustrates an example operating environment 100 where a sketch-based query system can be implemented, in accordance with some embodiments.

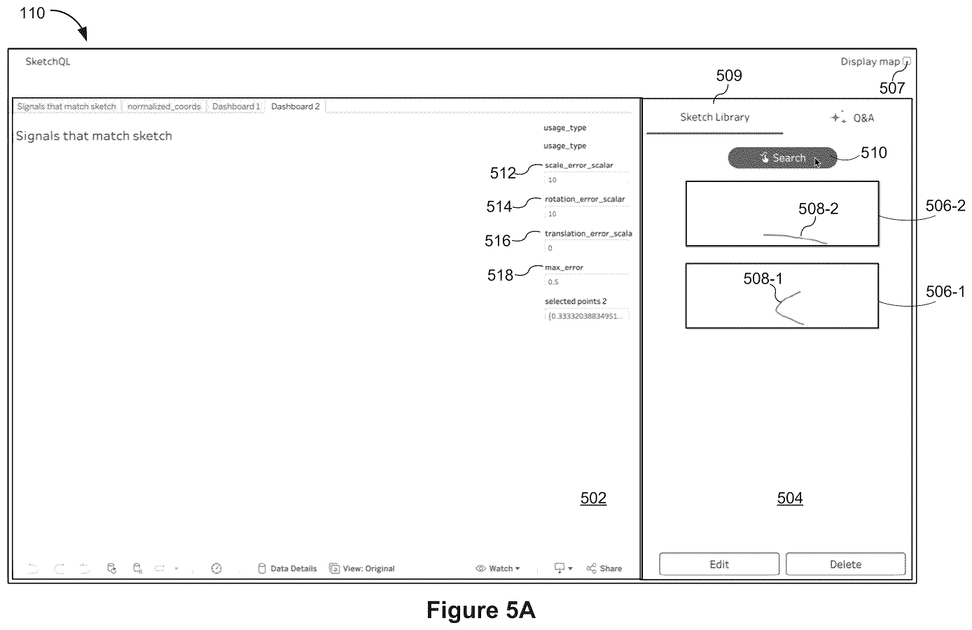

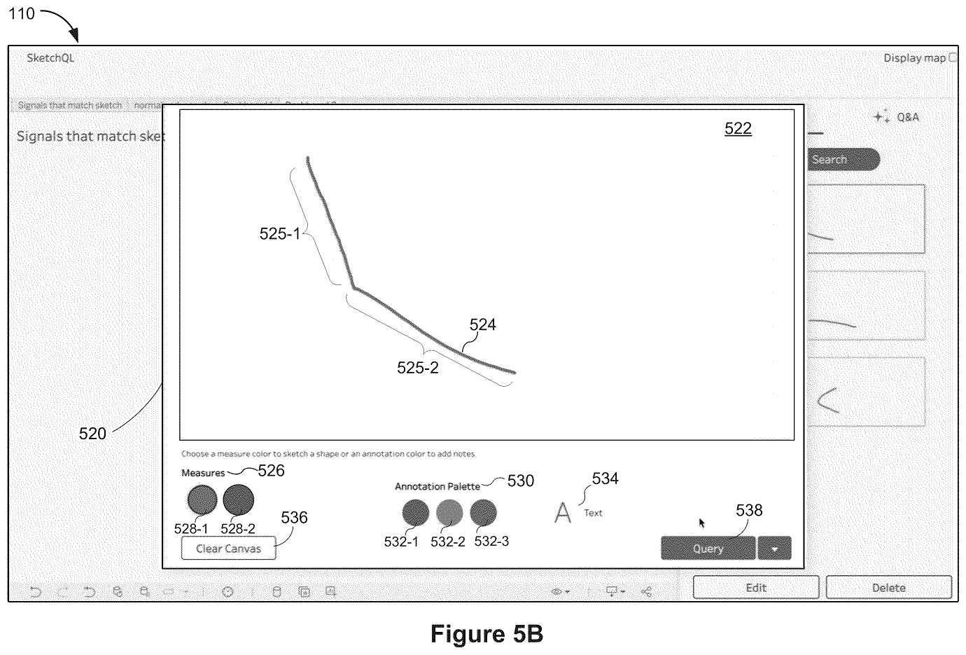

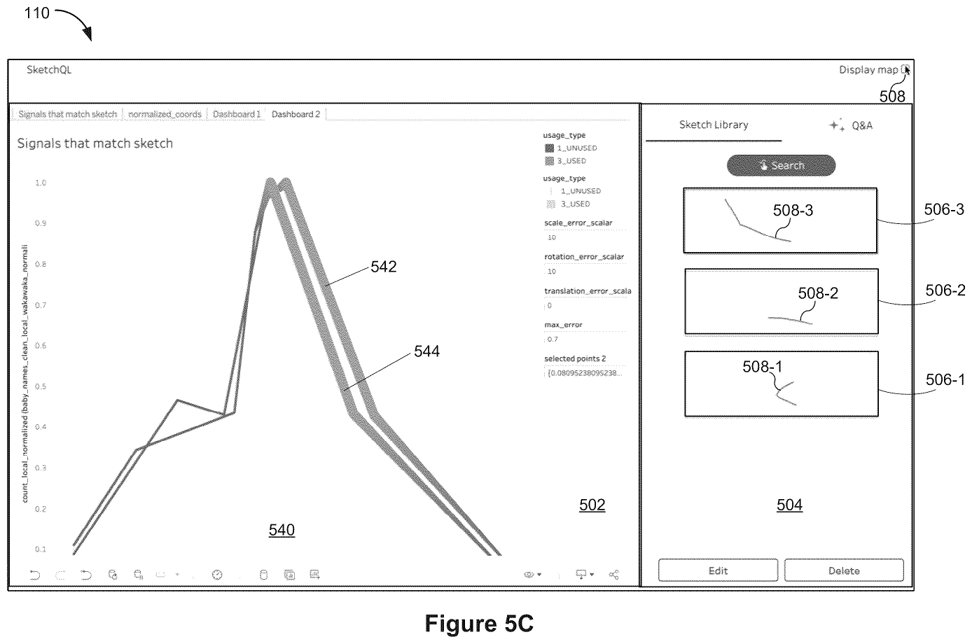

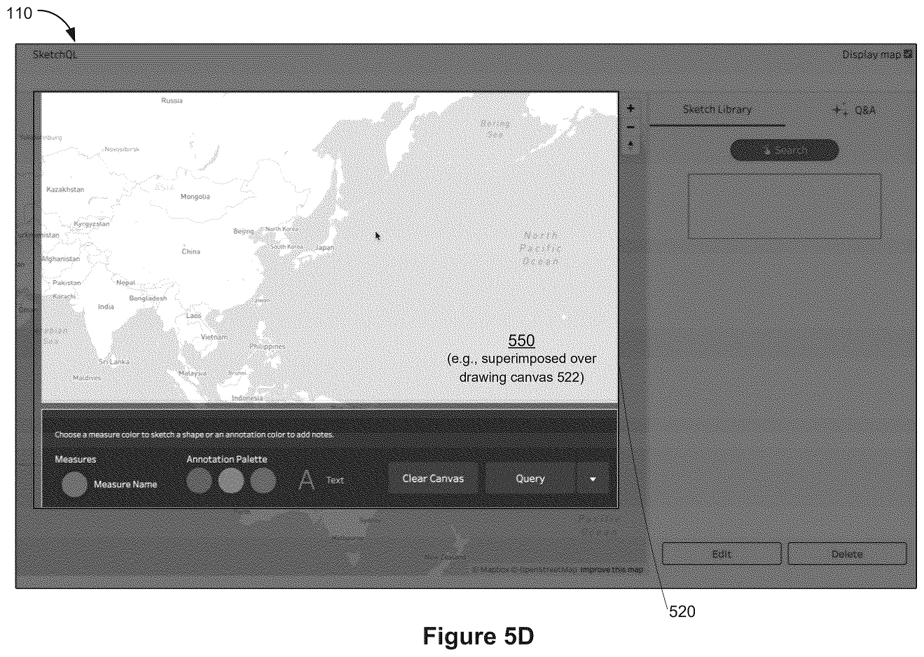

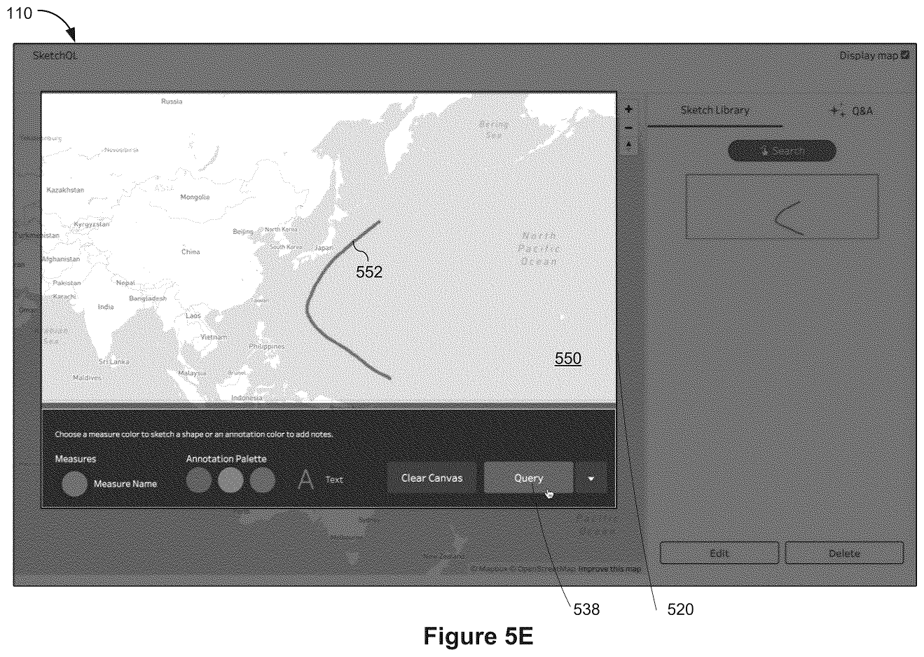

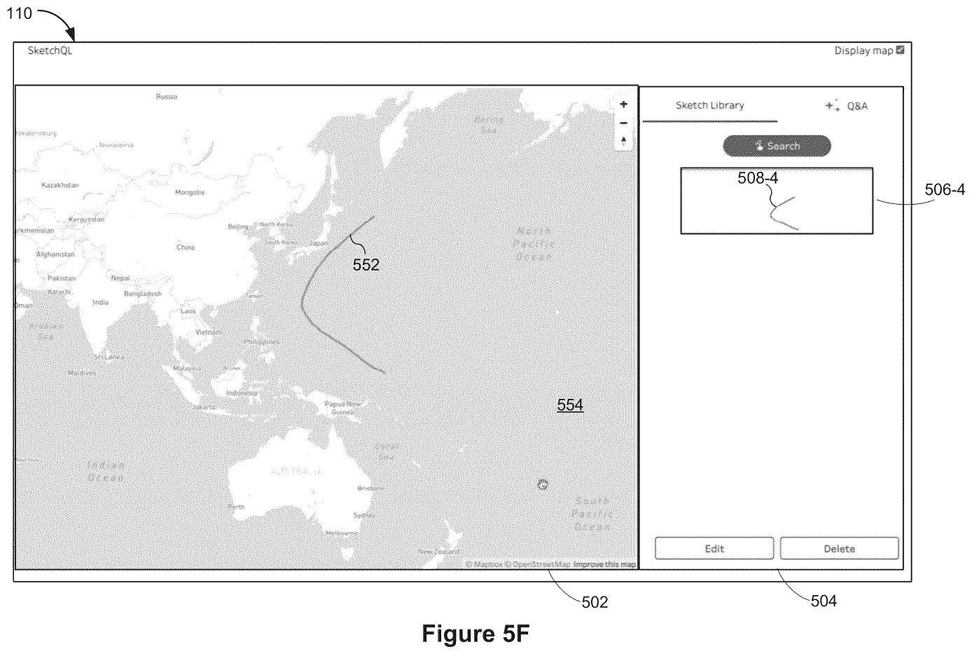

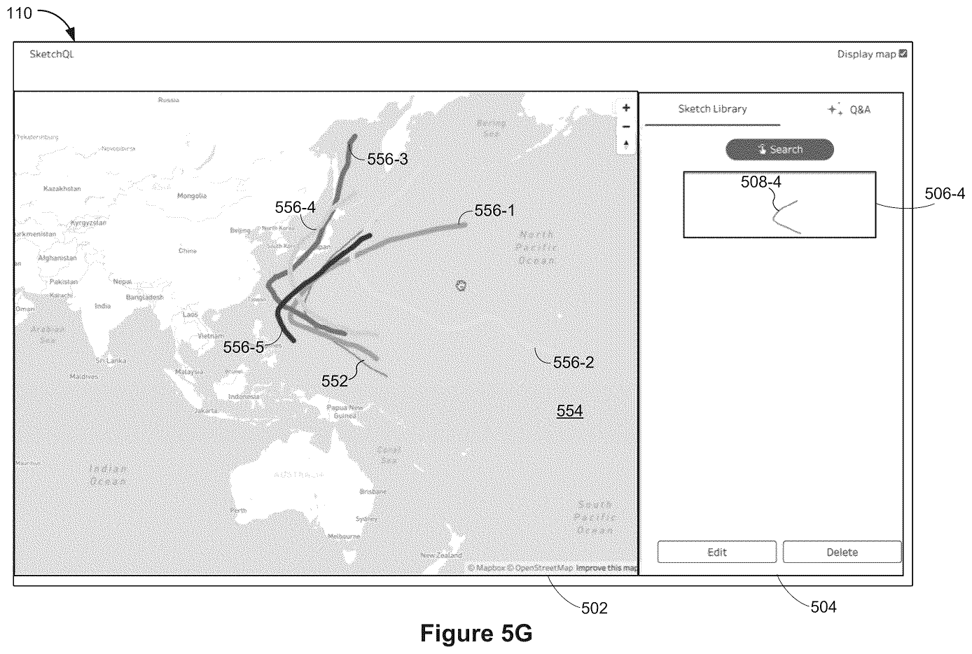

In some embodiments, the operating environment 100 includes one or more client devices 102 (e.g., client device 102-1 to 102-4) (e.g., a computing device) that are communicatively connected with one another via network(s) 150 and/or with a server system 130. Various examples of client device 102 include a workstation, a desktop computer, a laptop computer, a tablet computer, or other portable electronic device (e.g., a smartphone)) and other computing devices that have a display and a processor capable of running a sketch-based query application 230. In some embodiments, application 230 comprises a web-based application. In some embodiments, client device 102 can be a virtual reality (VR) device, an augmented reality (AR) device, or a spatial computing device that blends digital content with the physical world. In some embodiments, client device 102 is configured to execute a sketch-based query application 230 that includes a user interface 110. Details of the user interface 110 are described with respect to FIGS. 6A-5G and 16A-16P.

In some embodiments, network(s) 150 include local area networks (LANs) and wide area networks (WANs) such as the Internet. In some implementations, the one or more networks 150 are implemented using any known network protocol, including various wired or wireless protocols, such as Ethernet, Universal Serial Bus (USB), FIREWIRE, Long Term Evolution (LTE), Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol.

In some embodiments, the operating environment 100 includes a physical structure 160. The physical structure 160 may be used as a warehouse, factory, construction site, farm, laboratory, office space, retail store, hospital, and the like. For example, the physical structure 160 may be used as a distribution center, an e-commerce fulfillment center, an automobile assembly plant, an electronics manufacturing facility, a supermarket, or a retailer store. It will be appreciated that the physical structure 160 has an open floor plan, high ceilings, and support structures (e.g. columns or beams) and may include different functional areas designed for efficiency, safety, and scalability.

In some embodiments, the physical structure 160 includes one or more sensors that are configured to monitor an environment within and/or surrounding the physical structure 160. For example, the one or more sensors can include one or more surveillance cameras 162 (e.g., surveillance camera 162-1 and surveillance camera 162-2). The surveillance cameras 162 may detect a person's or a vehicle's approach to or departure from the physical structure 160, identify and/or report any abnormal incidents, and/or control settings on a security system (e.g., to activate or deactivate the security system). In some embodiments, the one or more sensors can include one or more hazard detection units 164. The hazard detection units 164 may detect the presence of a hazardous substance or a substance indicative of a hazardous substance (e.g., smoke, fire, and/or carbon monoxide). In some embodiments, the one or more sensors can include one or more thermostats 166. In some embodiments, a thermostat 166 can detect ambient climate characteristics (e.g., temperature and/or humidity) and control an HVAC system 168 accordingly.

In some embodiments, the operating environment 100 includes server system 130. Server system 130 includes one or more processors 302 and a network interface 146. In some embodiments, the processor(s) 302 are communicatively connected to one or more databases, such as a database of linearized datasets 132, a sketch library 134, a sensor data storage database 136, a machine learning database 138, an alerts database 140, and a device and account database 142.

In some embodiments, the database of linearized datasets 132 stores a plurality of sets of linearized data (e.g., a plurality of linearized datasets). In some embodiments as used herein, linearized data refers to raw data (e.g., raw datasets or data sources 351) that has been converted into linear form by applying a linearization algorithm. Each set of linearized data includes a respective set of line segments, corresponding to one or more dimensional levels-of-detail and a measure of interest. In some embodiments, a set of linearized data corresponds to a respective tolerance value of the plurality of tolerance values of the linearization algorithm (e.g., epsilon values, if the linearization algorithm is the Douglas-Peucker algorithm). In some embodiments, a set of linearized data is associated with either a global normalization or a self-normalization scheme. The global normalization scheme normalizes the dataset to the database-wide minimum and maximum measure values, whereas the self-normalization scheme normalizes the dataset to the minimum and maximum measure values within that dataset. In some embodiments, a set of linearized data includes respective values for a set of parameters. The set of parameters can include one or more of: (i) a midpoint of a line segment, (ii) a length of a line segment, (iii) an angle between two adjacent line segments in the set of linearized data, (iv) an angle between a line segment and a horizontal axis, and (v) a time rate of change of respective values of the measure of interest. The respective values include (a) a value (e.g., an absolute value or a normalized value between zero and one) corresponding to a midpoint of a respective line segment, (b) a value (e.g., an absolute value or a normalized value between zero and one) corresponding to a length of a respective line segment, (c) a numerical angle value (e.g., an absolute angle between 0° and 360°, or a normalized value between zero and one) between two respective adjacent line segments in the set of linearized data, (d) a numerical angle value (e.g., an absolute angle between 0° and 360°, or a normalized value between zero and one) between a respective line segment and the horizontal axis, and (v) a value for a time rate of change (e.g., a velocity or an acceleration) of the measure of interest.

In some embodiments, the sketch library 134 stores sketches (e.g., shapes of sketches) from previous searches (e.g., previous sketch inputs), which can be retrieved and reused for future queries.

In some embodiments, the sensor data storage database 136 stores raw or processed data received from sensors of client devices 102, sensors of the physical structure 160 (e.g., cameras 162, hazard detection units 164, and thermostats 166) and associated information, as well as various types of metadata, such as explicit metadata and implicit metadata from obtained or derived from the sensors of client devices 102, characteristics of signal emitters and detectors, lookup tables, modulation signals, and sampling rates. In some embodiments, this data is used for generating additional information associated with each user profile or account.

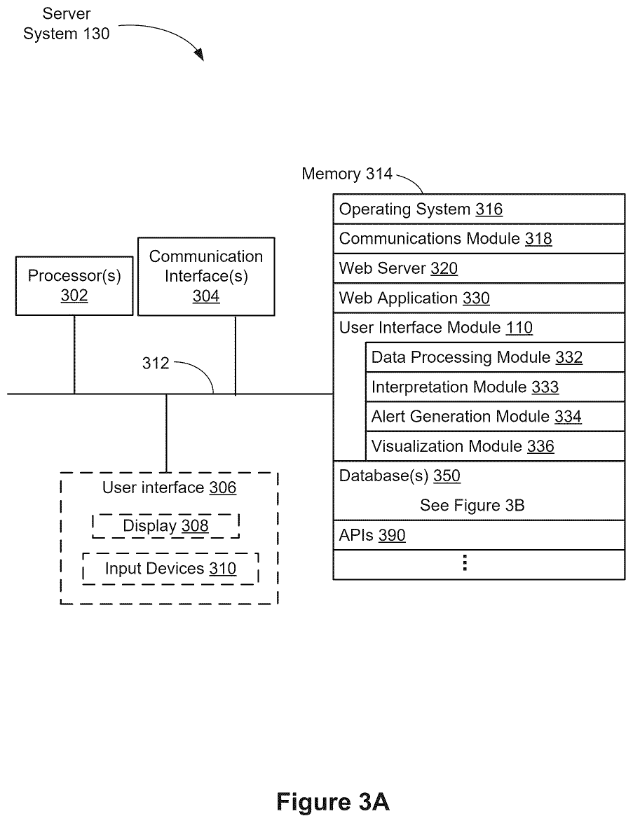

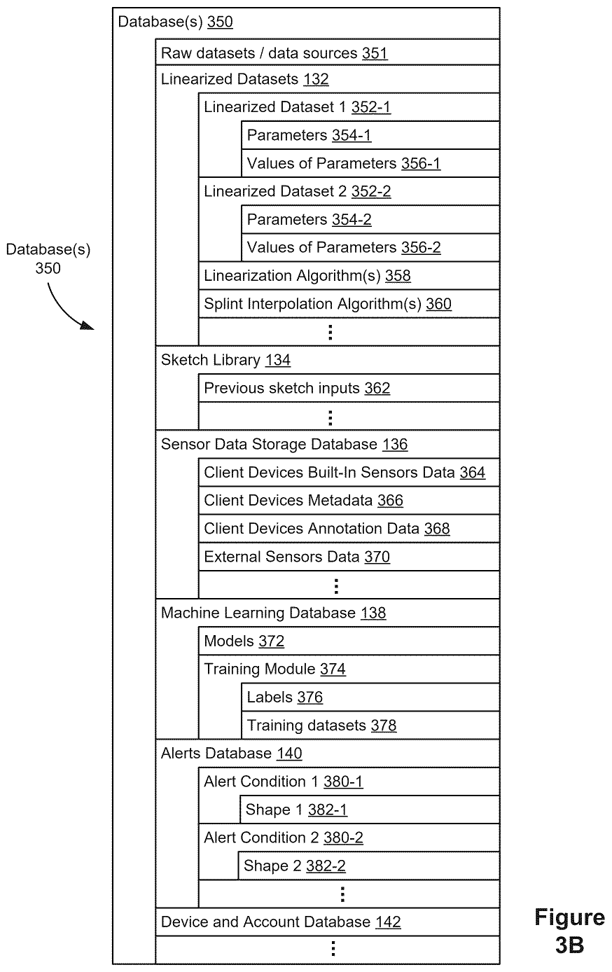

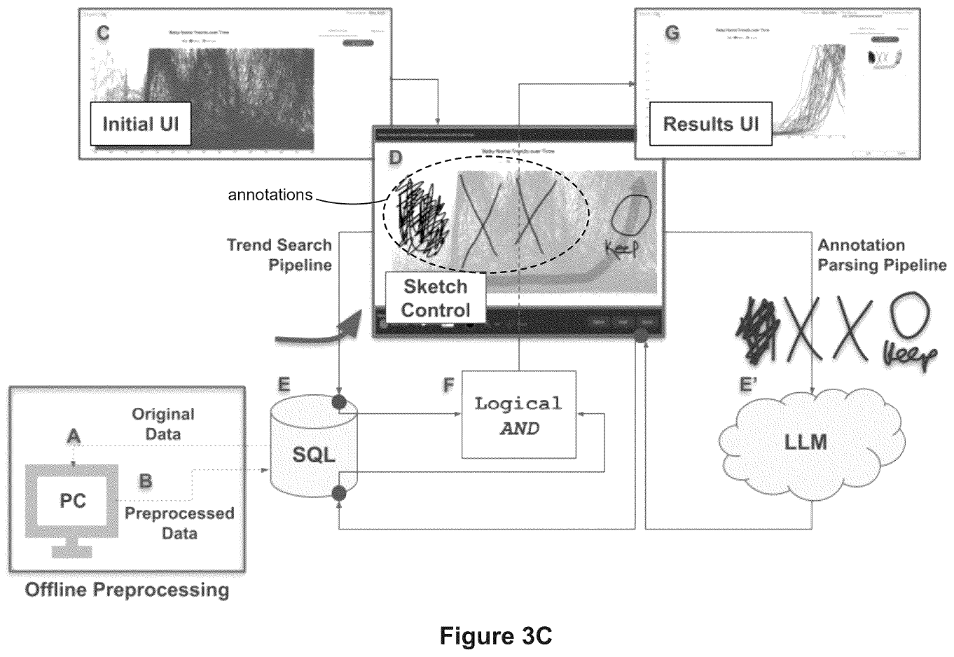

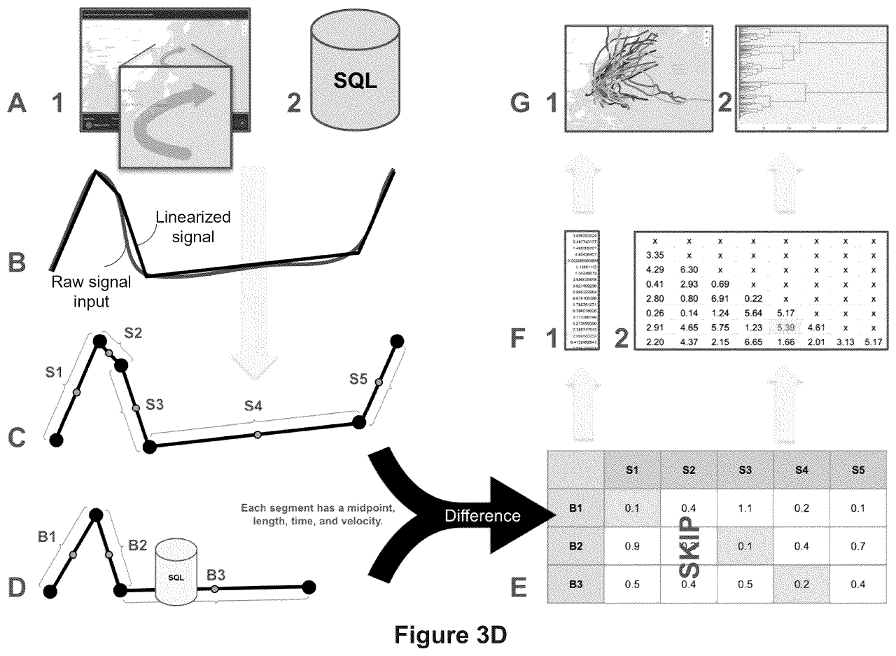

In some embodiments, the machine learning database 138 stores machine learning based data processing models and associated training data. Further details of the machine learning database are discussed with respect to FIG. 3B.

In some embodiments, the alerts database 140 stores shapes of sketch inputs that are of interest to a user. In some embodiments, this data is used for triggering automated task workflows and actions (e.g., when it is determined that received data has a distribution that matches a shape of the sketch input).

In some embodiments, the device and account database 142 stores a plurality of user profiles for accounts registered with the server system 130. In some embodiments, a user profile includes account credentials for each account and identifies one or client devices 102 and/or sensors linked to the account. In some embodiments, the user profile includes information related to capabilities, device characteristics, and lookup tables for devices and sensors linked to the account.

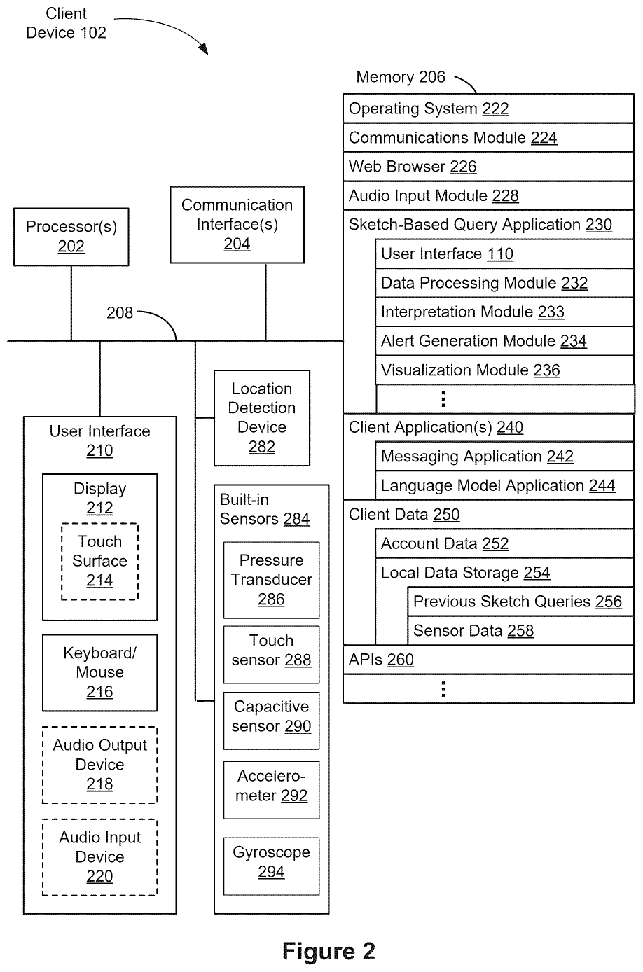

FIG. 2 is a block diagram illustrating a representative client device 102 associated with a user account in accordance with some embodiments. In some embodiments, client device 102 is also referred to as a computing device. Various examples of client device 102 include a desktop computer, a laptop computer, a tablet computer, and other computing devices that have a display and a processor capable of running a sketch-based query application 230 (e.g., SketchQL). In some embodiments, application 230 comprises a web-based application. In some embodiments, client device 102 is a virtual reality (VR) device, an augmented reality (AR) device, or a spatial computing device that blends digital content with the physical world. Client device 102 typically includes one or more processing units (processors or cores) 202, one or more network or other communication interfaces 204, memory 206, and one or more communication buses 208 for interconnecting these components. In some embodiments, the communication buses 208 include circuitry (sometimes called a chipset) that interconnects and controls communications between system components.

In some embodiments, client device 102 includes a user interface 210. The user interface 210 typically includes a display device 212 (e.g., a display generation component). In some embodiments, client device 102 includes input devices such as a keyboard, mouse, and/or other input buttons 216. Alternatively or in addition, in some embodiments, the display device 212 includes a touch-sensitive surface 214, in which case the display device 212 is a touch-sensitive display. In some embodiments, the touch-sensitive surface 214 is configured to detect various swipe gestures (e.g., continuous gestures in vertical and/or horizontal directions) and/or other gestures (e.g., single/double tap). In devices that have a touch-sensitive display 214, a physical keyboard is optional (e.g., a soft keyboard may be displayed when keyboard entry is needed). The user interface 210 also includes an audio output device 218, such as speakers or an audio output connection connected to speakers, earphones, or headphones. Furthermore, some client devices 102 use a microphone and voice recognition to supplement or replace the keyboard. In some embodiments, client device 102 includes an audio input device 220 (e.g., a microphone) to capture audio (e.g., speech from a user).

In some embodiments, client device 102 includes a location detection device 282, such as a GPS (global positioning satellite) or other geo-location receiver, for determining the location of the client device.

In some embodiments, client device 102 includes one or more built-in sensors 284, such as one or more of: a pressure transducer 286 (e.g., pressure sensor) a resistive touch sensor 288, a capacitive sensor 290, an accelerometer 292, and a gyroscope 294.

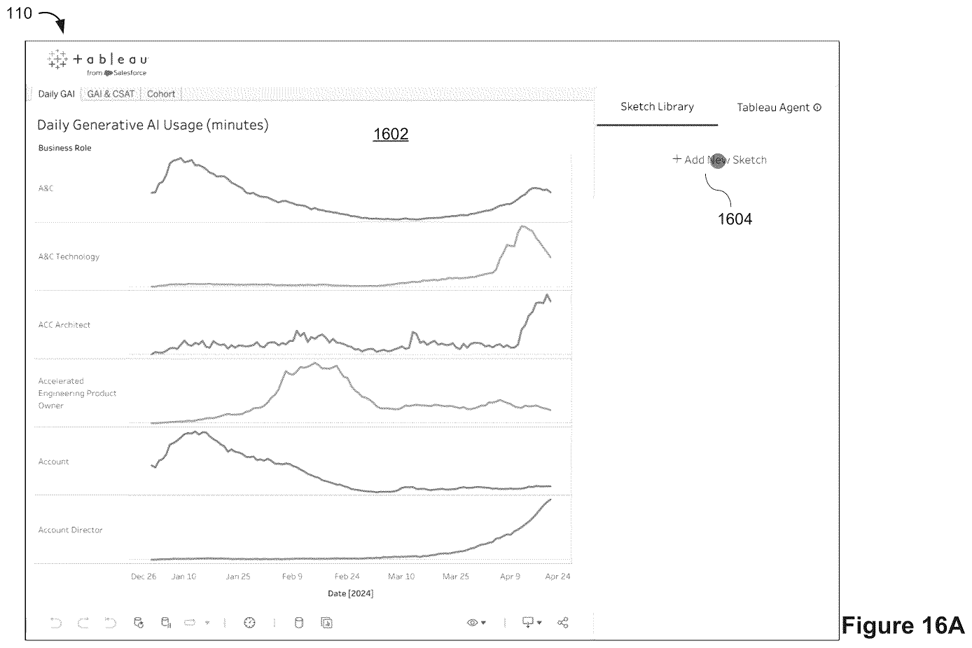

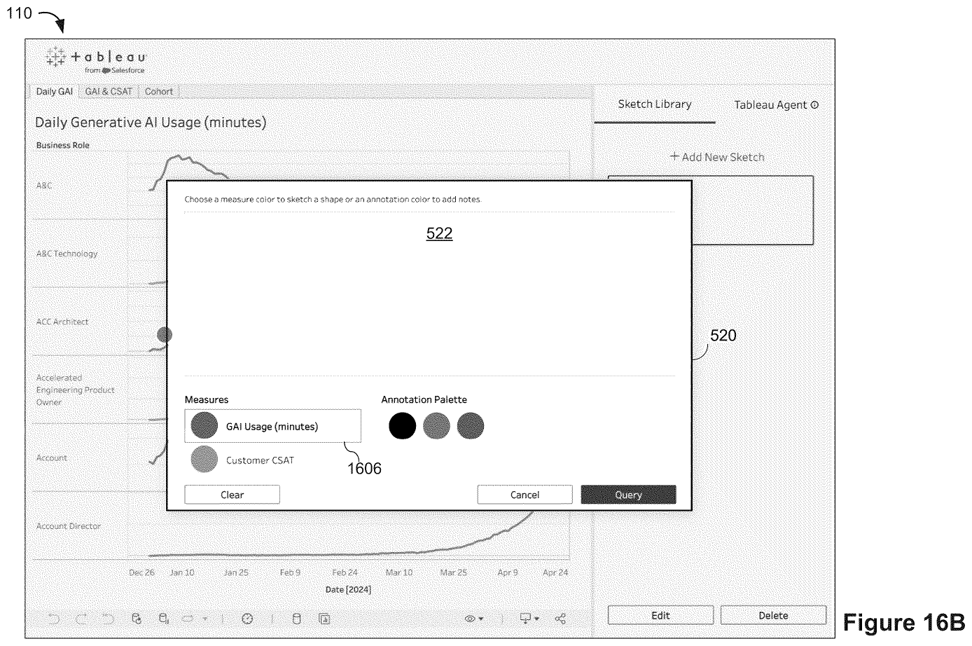

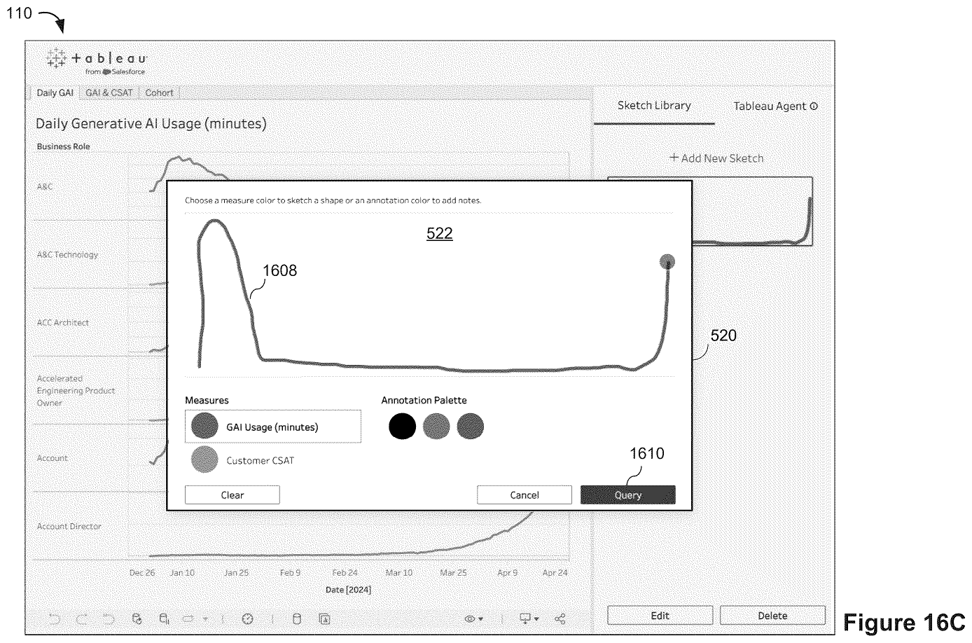

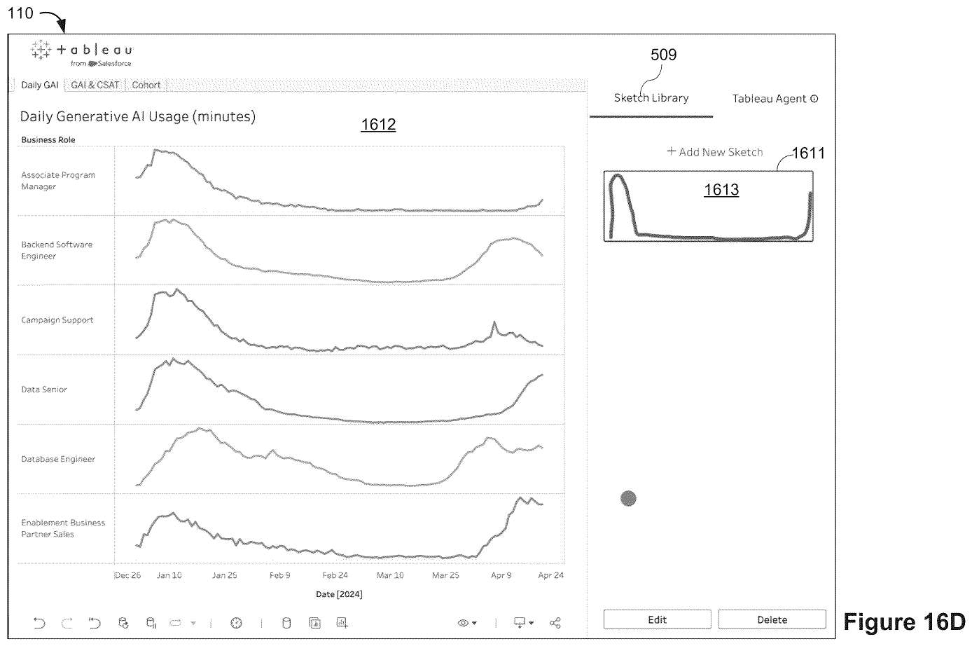

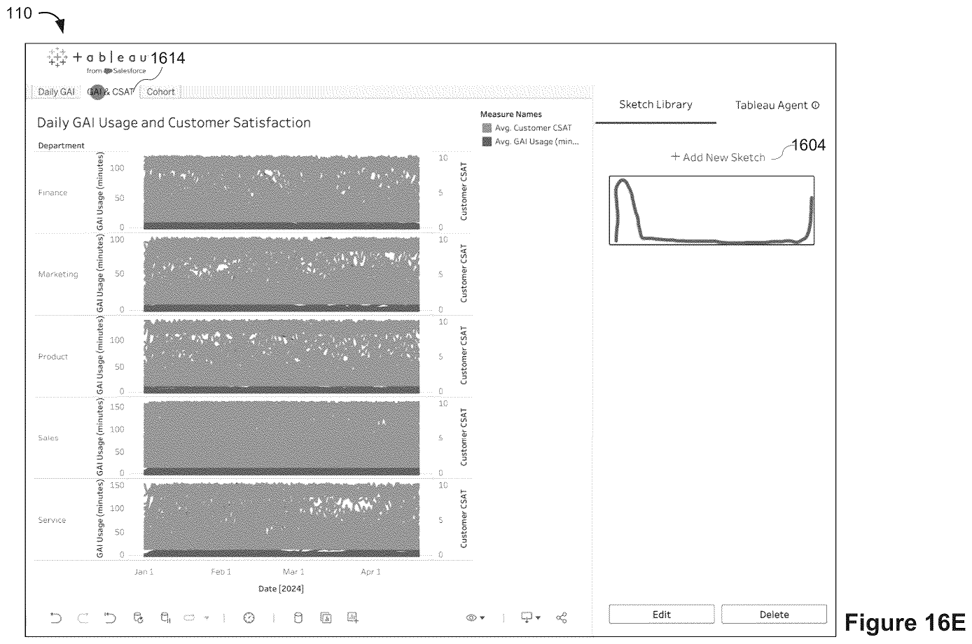

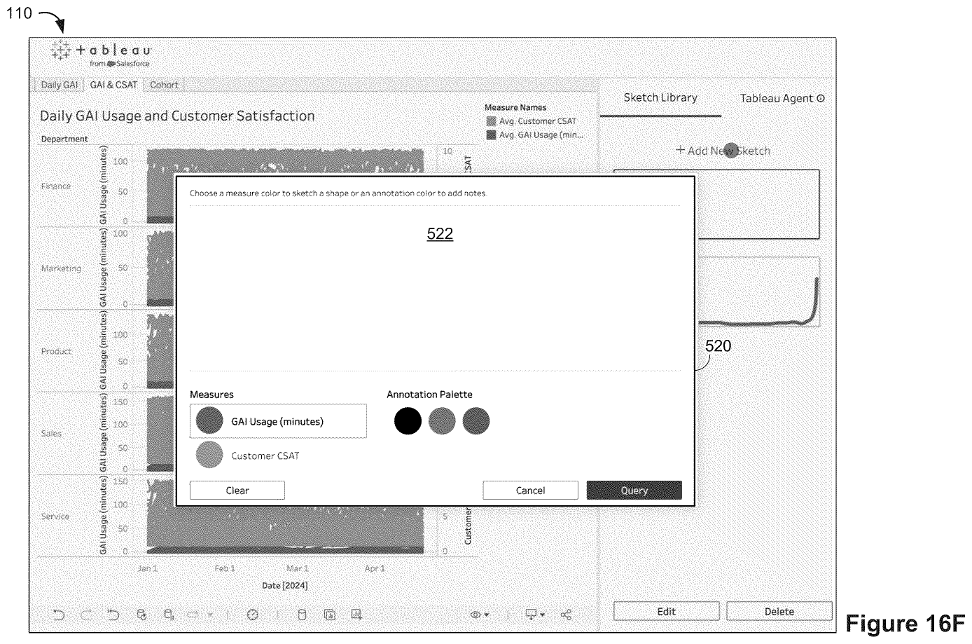

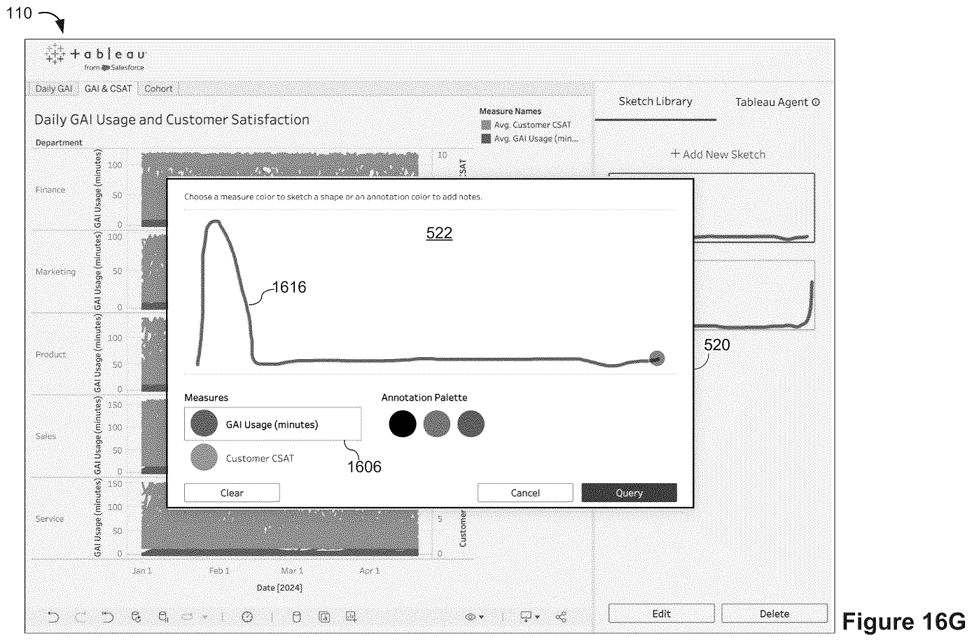

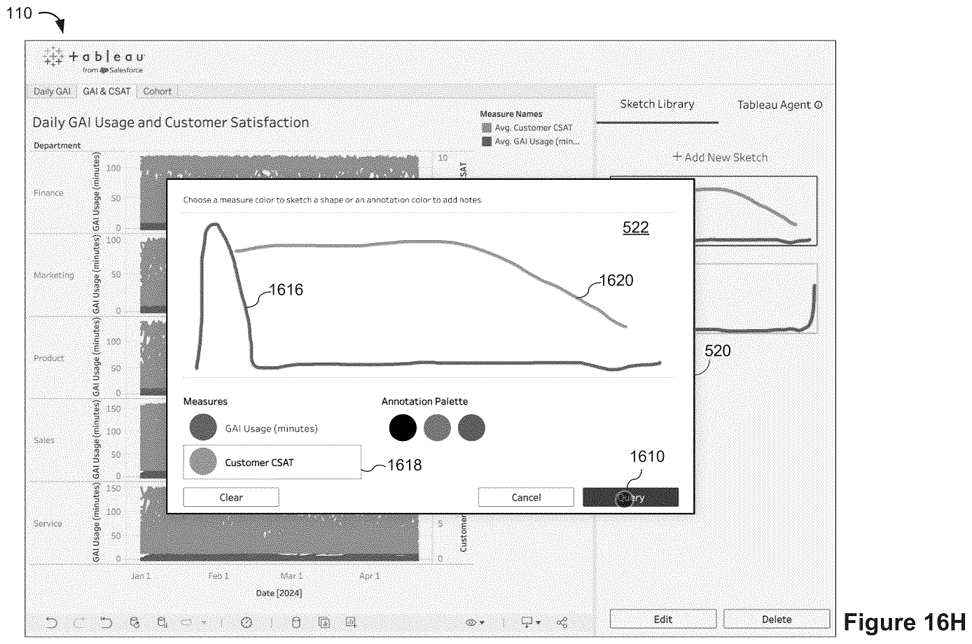

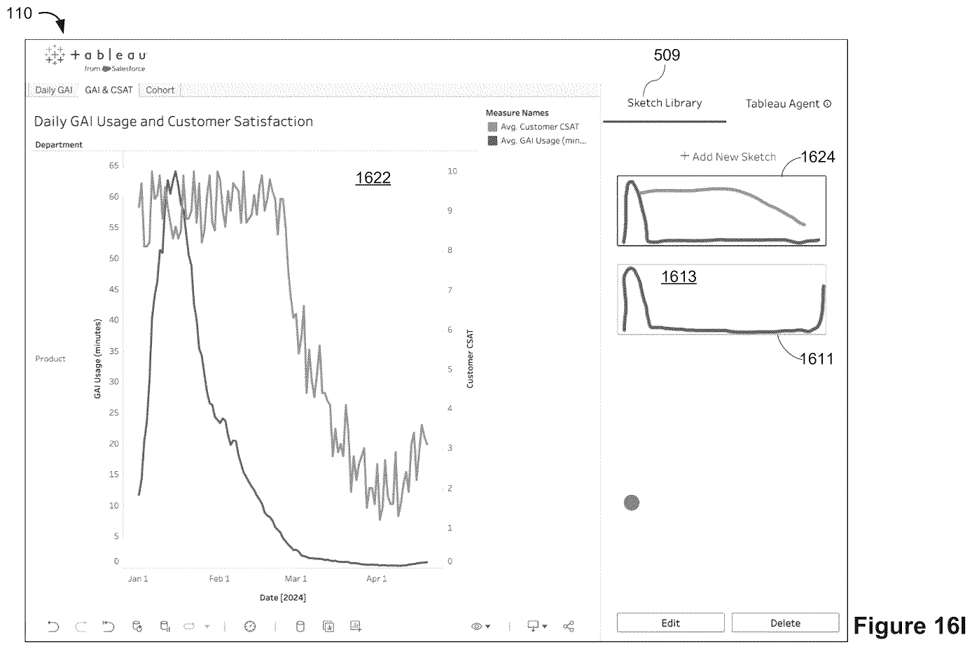

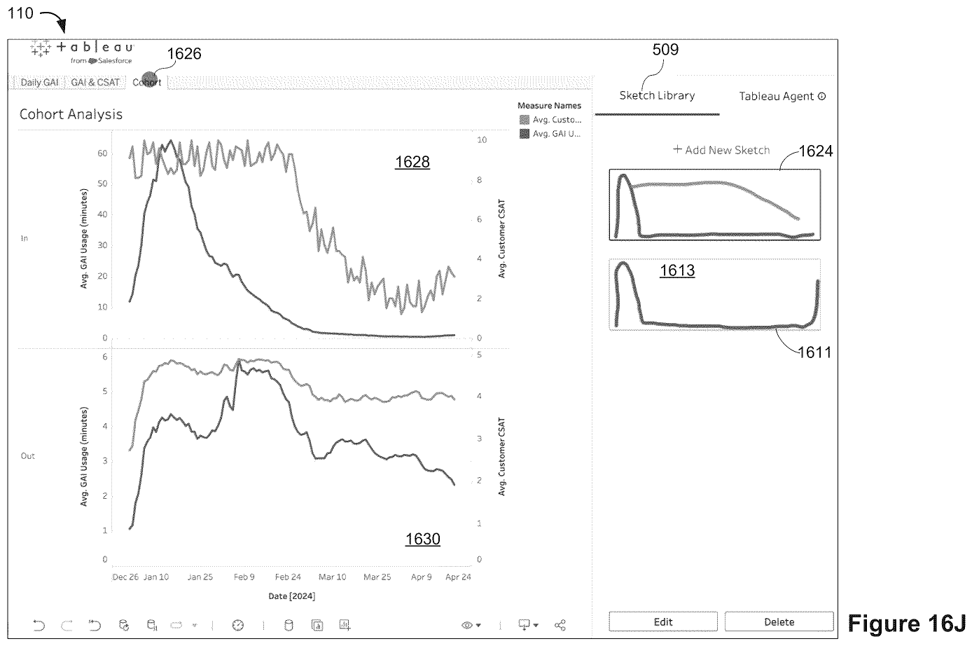

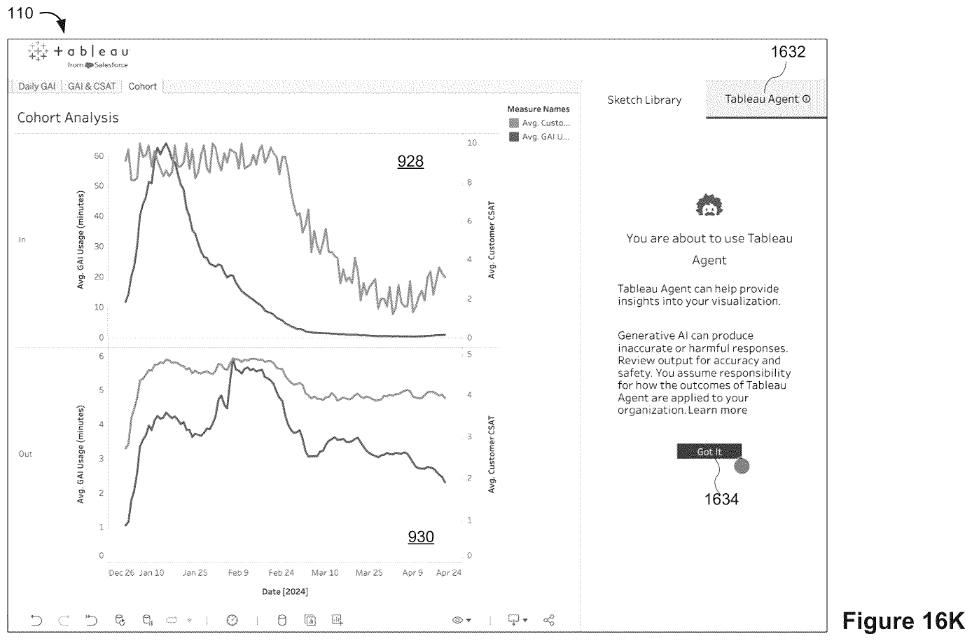

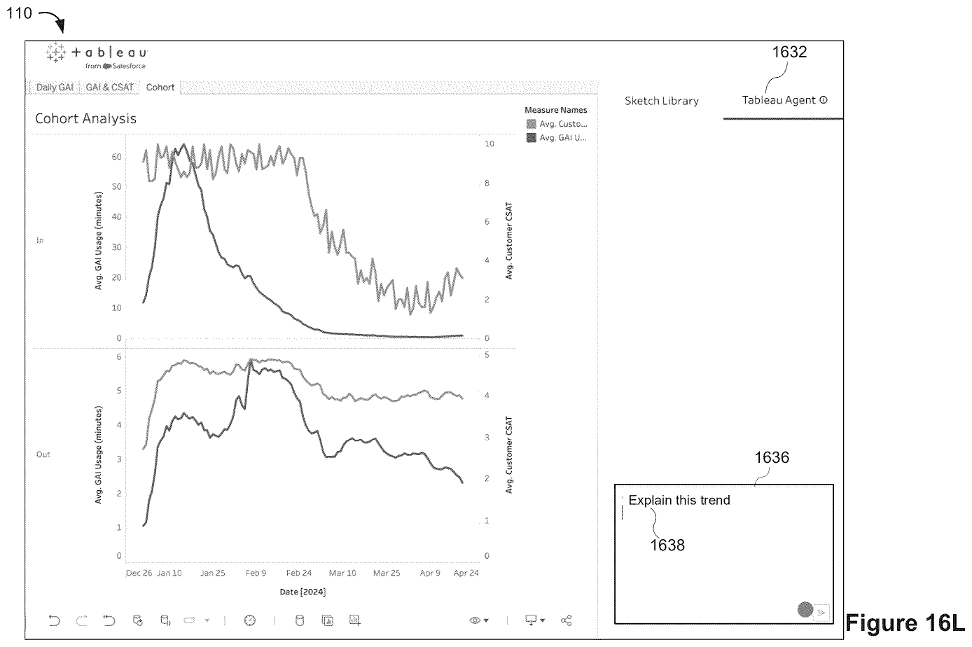

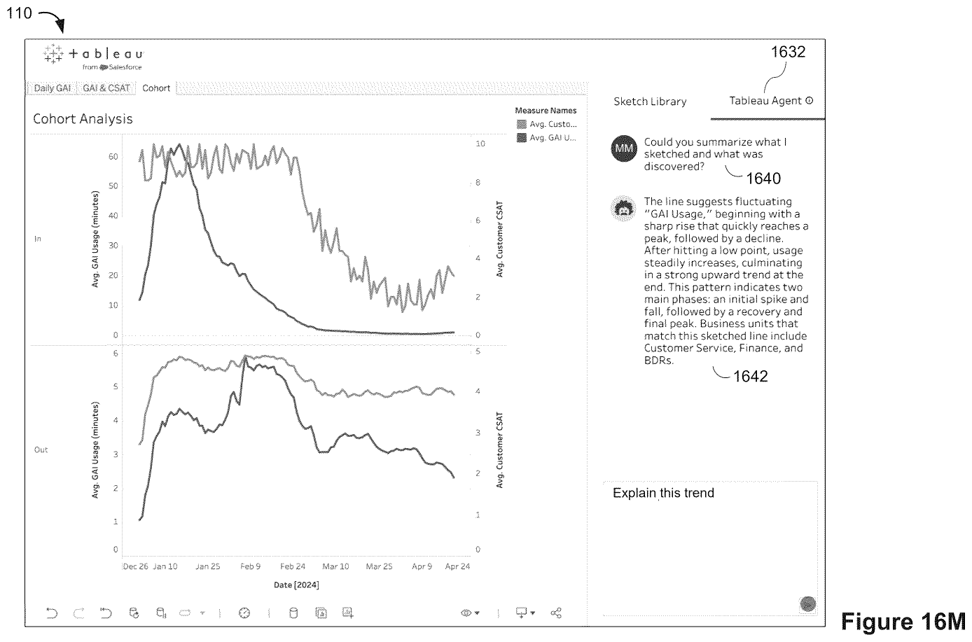

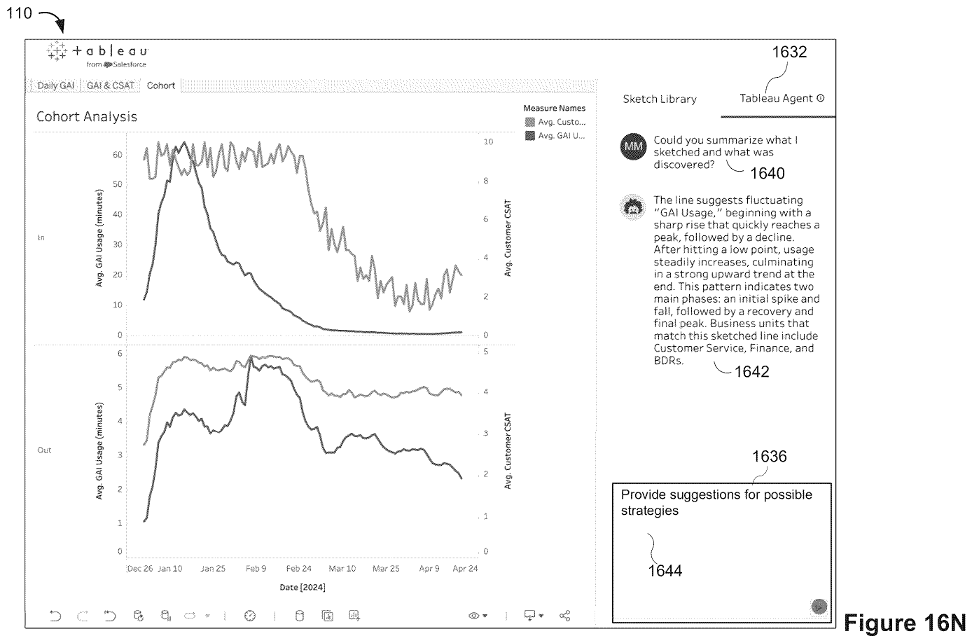

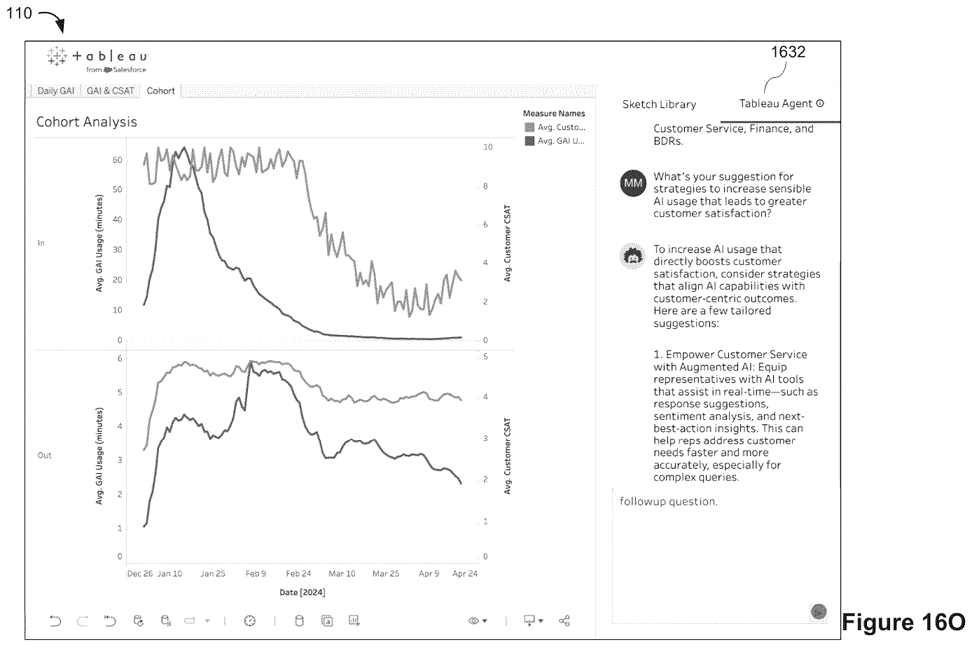

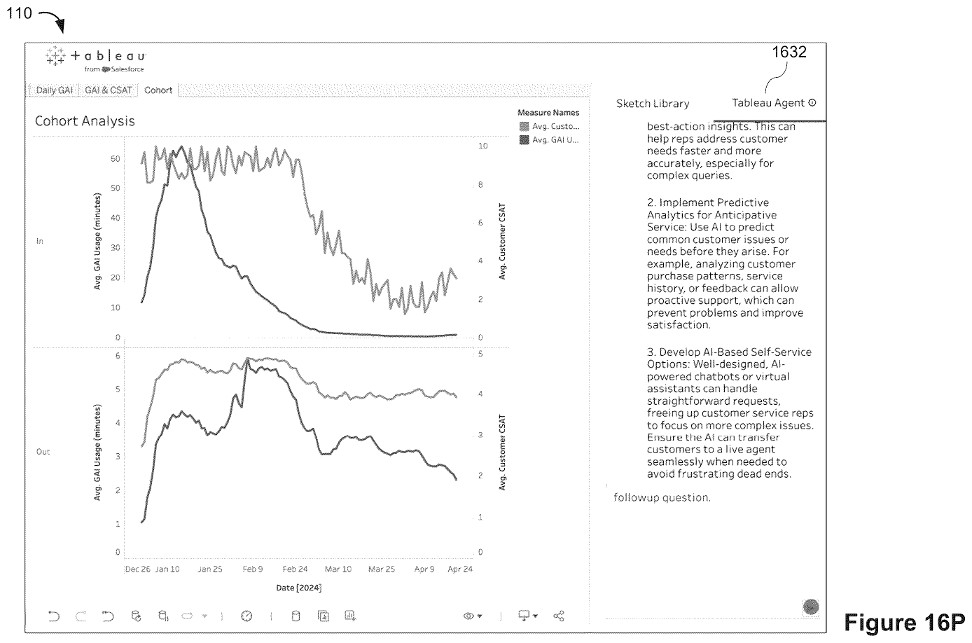

In some embodiments, the memory 206 includes high-speed random-access memory, such as DRAM, SRAM, DDR RAM, or other random-access solid-state memory devices. In some embodiments, the memory 206 includes non-volatile memory, such as one or more magnetic disk storage devices, optical disk storage devices, flash memory devices, or other non-volatile solid-state storage devices. In some embodiments, the memory 206 includes one or more storage devices remotely located from the processors 202. The memory 206, or alternatively the non-volatile memory devices within the memory 206, includes a non-transitory computer-readable storage medium. In some embodiments, the memory 206, or the computer-readable storage medium of the memory 206, stores the following programs, modules, and data structures, or a subset or superset thereof:
an operating system 222, which includes procedures for handling various basic system services and for performing hardware dependent tasks;
a communications module 224, which is used for connecting client device 102 to other client devices 102, sensors in physical structure 160, and server system 130 via the one or more communication interfaces 204 (wired or wireless), such as the Internet, other wide area networks, local area networks, metropolitan area networks, and so on;
a web browser 226 (or other application capable of displaying web pages), which enables a user to communicate over a network with remote computers or devices;
an audio input module 228 (e.g., a microphone module), which processes audio captured by the audio input device 220. The captured audio may be sent to a remote server (e.g., a server system 130) and/or processed by an application executing on the client device 102 (e.g., the application 230);
a sketch-based query application 230 (e.g., SketchQL) that is configured to receive a visual sketch as an interactive input modality to define a data query, and translate the sketch into a data query. In some embodiments, the sketch-based query application 230 includes:
   a user interface 110 (e.g., a web-based user interface), as described in FIGS. 5A-5G and 16A-16P;
   a data processing module 232 for processing data such as sketch inputs, annotations, inputs from built-in sensors 284, explicit metadata, implicit metadata, and prompts. For example, in some embodiments, data processing module 232 translates sketch inputs into data queries. In some embodiments, data processing module 232 uses models 372 in machine learning database 138 to process the data;
   an interpretation module 233 for interpreting annotations and/or metadata received via user interface 110;
   an alert generation module 234 for generating alert conditions according to shapes of sketch inputs received via the user interface 110; and
   a visualization module 236 for generating and rendering data visualizations;
one or more client applications 240 that are executed by client device 102, such as a messaging application 242, a language model application 244, and/or other web or non-web based applications;
client data 250 storing data associated with the user account and electronic devices, including, but not limited to:
   account data 252 storing information related to user accounts loaded on client device 102, wherein such information includes cached login credentials, user interface settings, display preferences, authentication tokens and tags, password keys, etc.; and
a local data storage 254 for selectively storing raw or processed data associated with client device 102, such as previous sketch queries 256 and/or sensor data 258 from built-in sensors 284 of the client device 102; and
APIs 260 for receiving API calls from one or more applications (e.g., a web browser 226, sketch-based query application 230, and/or client applications 240, translating the API calls into appropriate actions, and performing one or more actions.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some embodiments, the memory 206 stores a subset of the modules and data structures identified above. Furthermore, the memory 206 may store additional modules or data structures not described above. In some embodiments, a subset of the programs, modules, and/or data stored in the memory 206 is stored on and/or executed by server system 130.

In various implementations, the models and/or modules described herein may be classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc. The AI technology may be implemented by a computer including a processor or a central processing unit (CPU) coupled to one or more storage system(s), non-transitory machine readable medium(s), memory, or other machine readable storage medium(s).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, a plurality of input prompts may be provided to the AI technology for the purpose of eliciting particular responses. In various implementations, the plurality of input prompts may correspond to the particular field or task to which the AI technology is trained. Additionally, the AI technology may be implemented along with a plurality of additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

Although FIG. 2 shows a client device 102, FIG. 2 is intended more as a functional description of the various features that may be present rather than as a structural schematic of the implementations described herein. In practice, and as recognized by those of ordinary skill in the art, items shown separately could be combined and some items could be separated. In addition, some of the programs, functions, procedures, or data shown above with respect to the client device 102 may be stored or executed on server system 130.

FIGS. 3A and 3B illustrate a block diagram of a server system 130, in accordance with some embodiments. Server system 130 typically includes one or more processors 302 (e.g., processing units/cores, or CPUs), one or more network interfaces 304 (e.g., network interface 146), memory 314, and one or more communication buses 312 for interconnecting these components. In some embodiments, server system 130 includes a user interface 306, which includes a display 308 and one or more input devices 310, such as a keyboard and a mouse. In some embodiments, the communication buses 312 include circuitry (sometimes called a chipset) that interconnects and controls communications between system components.

In some embodiments, the memory 314 includes high-speed random access memory, such as DRAM, SRAM, DDR RAM, or other random access solid state memory devices, and may include non-volatile memory, such as one or more magnetic disk storage devices, optical disk storage devices, flash memory devices, or other non-volatile solid state storage devices. In some embodiments, the memory 314 includes one or more storage devices remotely located from the CPUs 302. The memory 314, or alternatively the non-volatile memory devices within the memory 314, comprises a non-transitory computer readable storage medium.

In some embodiments, the memory 314 or the computer readable storage medium of the memory 314 stores the following programs, modules, and data structures, or a subset thereof:
an operating system 316, which includes procedures for handling various basic system services and for performing hardware dependent tasks;
a network communications module 318, which is used for connecting server system 130 to other computers via the one or more communication network interfaces 304 (wired or wireless) (e.g., network interface 146) and one or more communication networks, such as the Internet, other wide area networks, local area networks, metropolitan area networks, and so on;
a web server 320 (such as an HTTP server), which receives web requests from users and responds by providing responsive web pages or other resources;
a web application 330 for translating sketch inputs into data. In some embodiments, the web application 330 may be downloaded and executed by a web browser 226 on a user's client device 102. In general, a web application 330 has the same functionality as a desktop application 230, but provides the flexibility of access from any device at any location with network connectivity, and does not require installation and maintenance. In some embodiments, the web application 330 includes various software modules to perform certain tasks, such as:
   a user interface module 110, which provides the user interface for all aspects of the web application 330;
   a data processing module 332, which has the same functionality as data processing module 232;
   an interpretation module 333, which has the same functionality as interpretation module 233;
   an alert generation module 334 for generating alert conditions according to shapes of sketch inputs received via the user interface 110 (or user interface module 110); and
   a visualization module 336, which has the same functionality as visualization module 236;
one or more databases 350, which are described in FIG. 1 and FIG. 3B; and
APIs 390 for receiving API calls from one or more applications (e.g., a web server 320, a web application 330), translating the API calls into appropriate actions, and performing one or more actions.

FIG. 3B is a block diagram of the one or more databases 350, in accordance with some embodiments.

In some embodiments, database(s) 350 include one or more raw datasets or one or more raw data sources 351.

In some embodiments, database(s) 350 include a database of linearized datasets 132. In some embodiments, the database of linearized datasets 132 includes multiple linearized datasets 352, such as linearized dataset 1 352-1 and linearized dataset 2 352-2. The linearized datasets 352 are generated (e.g., converted) from raw datasets or raw data sources using linearization algorithm(s) 358 or spline interpolation algorithm(s) 360. Some examples of raw datasets or raw data sources include time-series data or trend data depicting changes in values of measure fields over time (e.g., change in profits over time, change in popularity of baby names over time). Other examples of raw datasets or raw data sources include hurricane paths on a 2D map, or flight trajectories, or wind patterns on a globe. A linearized dataset includes a respective set of parameters 354 and respective values 356 corresponding to the respective set of parameters 354. For example, FIG. 3B shows that linearized dataset 1 352-1 includes parameters 354-1, where parameters 354-1 include corresponding values of parameters 356-1. FIG. 3B also shows that linearized dataset 2 352-2 includes parameters 354-2, where parameters 354-2 include corresponding values of parameters 356-2.

In some embodiments, the database of linearized datasets 132 includes one or more linearization algorithms 358. An example linearization algorithm is the Douglas-Peucker algorithm (or Ramer-Douglas-Peucker algorithm), which is an algorithm that decimates a curve composed of line segments to a similar curve with fewer points, by recursively dividing the line). Another example linearization algorithm is the Visvalingam-Whyatt algorithm, which is an algorithm that decimates a curve composed of line segments to a similar curve with fewer points. For example, given a polygonal chain (often called a polyline), the Visvalingam-Whyatt algorithm attempts to find a similar chain composed of fewer point.). Another example linearization algorithm is the Reumann-Witkam routine, which is an algorithm that simplifies polylines by removing points that fall outside a user-defined tolerance. Another example linearization algorithm is the Opheim routine. The O(n) Opheim routine is similar to the Reumann-Witkam routine, and can be seen as a constrained version of that Reumann-Witkam routine. Opheim uses both a minimum and a maximum distance tolerance to constrain the search area. Other examples of linearization algorithms include the Lang simplification, or any other linear fit algorithms.

In some embodiments, the database of linearized datasets 132 includes one or more spline interpolation algorithms 360. Example spline interpolation algorithms include linear spline, quadratic spline, or cubic spline interpolation. The spline interpolation algorithm fits multiple low-degree polynomials between adjacent points of a set of data points of a dataset or data source.

In some embodiments, the database of linearized datasets 132 includes datasets that are organized into a plurality of data clusters according to respective shapes (e.g., patterns) of the datasets that are determined from respective data distributions of the dataset.

In some embodiments, database(s) 350 include a sketch library 134. In some embodiments, sketch library 134 stores sketches (e.g., shapes of sketches) from previous sketch inputs 362, corresponding to previous searches (e.g., previous sketch inputs), that is received via client devices 102. which can be retrieved for future queries (e.g., instead of querying the database of linearized datasets 132). In some embodiments, the sketch library 134 can be used as a search query dataset to trigger task automation.

In some embodiments, database(s) 350 include a sensor data storage database 136. Sensor data storage database 136 stores sensor data from built-in sensors 284 of client device 102 (e.g., as client devices built-in sensors data 364).

In some embodiments, sensor data storage database 136 stores metadata from client devices 102 (e.g., as client devices metadata 366). In accordance with some embodiments, the server system 130 (or the client device 102) incorporates metadata to identify the saliency of the sketch features as part of intent interpretation. In some embodiments, the metadata includes explicit metadata. Explicit metadata can include a color of the sketch input, a pen thickness (e.g., coarse or fine) that is used to input a respective portion of the sketch input, or a nib type (e.g., diffuse, tight, or patterned) of an input device that is used for the sketch input. In some embodiments, the metadata includes implicit metadata. Implicit metadata can include a pressure detected by the display while the sketch input is received, a dwell time for a respective portion of the sketch input, or a drawing speed for a respective portion of the sketch input. In some embodiments, the server system 130 is configured to translate the sketch input into a query process by assigning different weights to different segments of the sketch input according to the client devices metadata 366. For example, based on metadata indicating that a first portion of a sketch input is drawn with a higher drawing pressure compared to a second portion of the sketch input, the server system (e.g., via data processing module 332) may assign a weigher weight to the first portion of the sketch input and assign a lower weight to the second portion of the sketch input.

In some embodiments, sensor data storage database 136 stores annotations from client devices 102 (e.g., as client devices annotation data 368). For example, user can specify a timespan corresponding to their sketch inputs, such as such as days, months, or years or a specific date or range of dates.

In some embodiments, sensor data storage database 136 stores sensor data from external sensors (e.g., cameras 162, hazard detection units 164, and thermostats 166, located in physical structure 160) as external sensors data 370.

In some embodiments, database(s) 350 include a machine learning database 138. Machine learning database 138 includes one or more models 372. Non-limiting examples of models 372 include a neural network, a support vector machine, a Naive Bayes model, a nearest neighbor model, a boosted trees model, a random forests model, a clustering model, a large language model (LLM), a vision language model (VLM), a large vision model (LVM), and an AI agent. As used herein, the term “model” refers to a machine learning model or algorithm. In some embodiments, the one or more models 372 are trained using sketch inputs, sensor data, annotations data, and/or metadata that are identified in accordance with the various embodiments of the present disclosure. In some embodiments, at least a portion of the sensor data, annotations data, and/or metadata is used as independent variables for the training. In some embodiments, the machine learning database 138 includes a training module 374 that includes labels 376 and one or more training datasets 378, for training the models 372.

In some embodiments, a model 372 is an unsupervised learning algorithm. One example of an unsupervised learning algorithm is cluster analysis.

In some embodiments, a model 372 is supervised machine learning. Nonlimiting examples of supervised learning algorithms include, but are not limited to, logistic regression, neural networks, support vector machines, Naive Bayes algorithms, nearest neighbor algorithms, random forest algorithms, decision tree algorithms, boosted trees algorithms, multinomial logistic regression algorithms, linear models, linear regression, GradientBoosting, mixture models, hidden Markov models, Gaussian NB algorithms, linear discriminant analysis, or any combinations thereof. In some embodiments, a model is a multinomial classifier algorithm. In some embodiments, a model is a 2-stage stochastic gradient descent (SGD) model. In some embodiments, a model is a deep neural network (e.g., a deep-and-wide sample-level classifier).

In some embodiments, SketchQL applies or implements advanced deep learning models (e.g., models 372) for enhanced sketch accuracy and granularity. For example, in some embodiments, the deep learning models can improve the interpretation accuracy of complex sketches, such as cyclical trends or seasonal variations. In some embodiments, the models 372 are configured to support more granular temporal resolutions in sketches. Users could specify or highlight trends over different time scales, such as days, months, or years, directly through their sketches.

In some embodiments, database(s) 350 include an alerts database 140 for storing alert conditions 380 (e.g., alert condition 1 380-1 and alert condition 2 380-2). In some embodiments, each alert condition is associated with a respective corresponding data shape 382 (e.g., a sketched shape, from a sketch input) that is of interest to a user. In some embodiments, the server system determines that an alert condition is met when data received by the server system 130 has a data distribution that corresponds to shape 382. In some embodiments, when an alert condition is met, the server system 130 is configured to trigger an automated task workflow and action.

In some embodiments, database(s) 350 include a device and account database 142, which is described with reference to FIG. 1.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some embodiments, the memory 314 stores a subset of the modules and data structures identified above. Furthermore, the memory 314 may store additional modules or data structures not described above.

In various implementations, the models and/or modules described herein may be classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc. The AI technology may be implemented by a computer including a processor or a central processing unit (CPU) coupled to one or more storage system(s), non-transitory machine readable medium(s), memory, or other machine readable storage medium(s).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, a plurality of input prompts may be provided to the AI technology for the purpose of eliciting particular responses. In various implementations, the plurality of input prompts may correspond to the particular field or task to which the AI technology is trained. Additionally, the AI technology may be implemented along with a plurality of additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

Although FIGS. 3A and 3B show a server system 130, FIGS. 3A and 3B are intended more as a functional description of the various features that may be present rather than as a structural schematic of the implementations described herein. In practice, and as recognized by those of ordinary skill in the art, items shown separately could be combined and some items could be separated. In addition, some of the programs, functions, procedures, or data shown above with respect to a server system 130 may be stored or executed on a client device 102. In some embodiments, the functionality and/or data may be allocated between a client device 102 and one or more servers 130. Furthermore, one of skill in the art recognizes that FIG. 3 need not represent a single physical device. In some embodiments, the server functionality is allocated across multiple physical devices in a server system. As used herein, references to a “server” include various groups, collections, or arrays of servers that provide the described functionality, and the physical servers need not be physically colocated (e.g., the individual physical devices could be spread throughout the United States or throughout the world).

FIG. 3C illustrates an architectural overview of SketchQL, in accordance with some embodiments. FIG. 3D illustrates a data processing flow, in accordance with some embodiments.

Referring to FIG. 3C, the data journey begins at panels A and B, with offline preprocessing that simplifies the original data into linear segments via a linearization algorithm such as the Douglas-Peucker (DP) simplification algorithm. The algorithm then calculates various geometric properties (see FIG. 3D). The interactive user experience then begins at Panel C, when the user is presented with the initial view of the data. Upon launching the sketch control panel (Panel D) and sketching a data trend and/or data annotations, the sketch is passed to the trend search pipeline while, in parallel, the data annotation sketch is sent down a annotation parsing pipeline. The trend search pipeline invokes the align( ) user-defined function in the SQL database (Panel E) which returns all the data that match the sketched data trend. In some embodiments, in parallel, the data annotation sketch is sent to an LLM (Panel 3E′) (e.g., language model application 2444 or models 372) for image parsing. The LLM performs image analysis and generates a SQL query that will recover the data indicated by the sketched annotations (e.g., those data in or out of exclusion regions). This SQL query is returned to SKETCHQL where it is then sent to the SQL database (Panel E) for execution. The results of the trend search query and the annotation query are then intersected (Panel F) and sent to the final results user interface (Panel G) for presentation to the user.

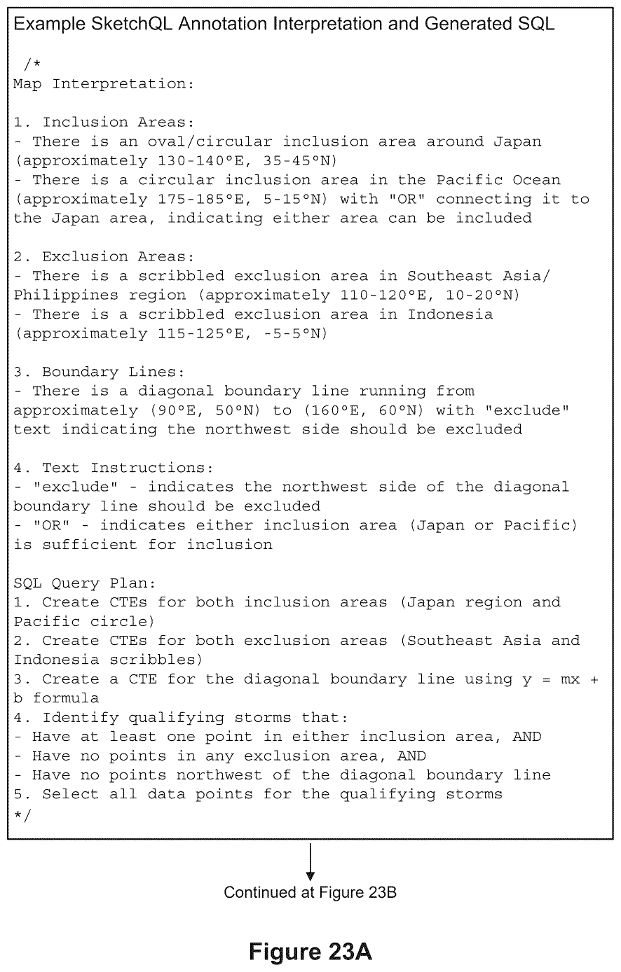

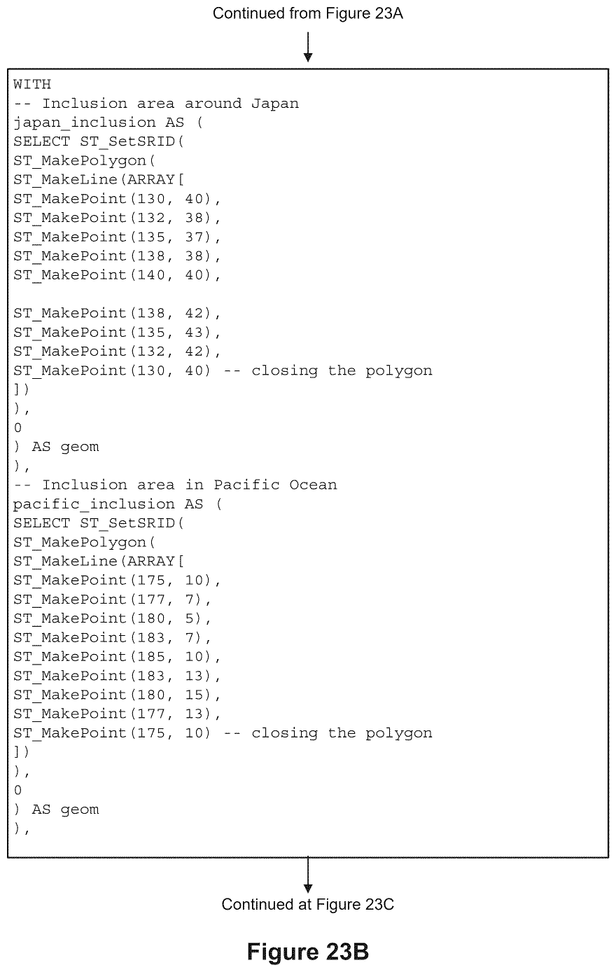

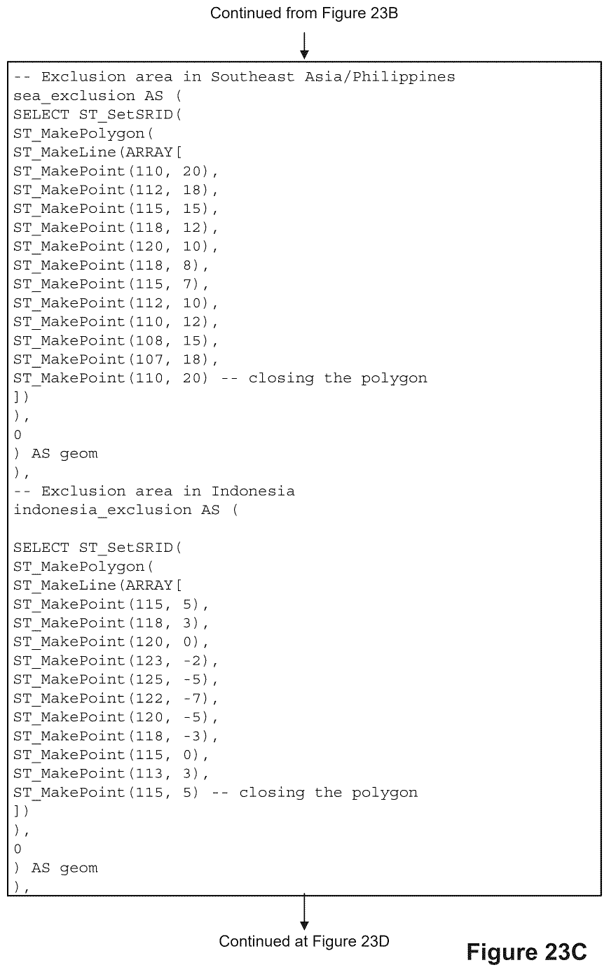

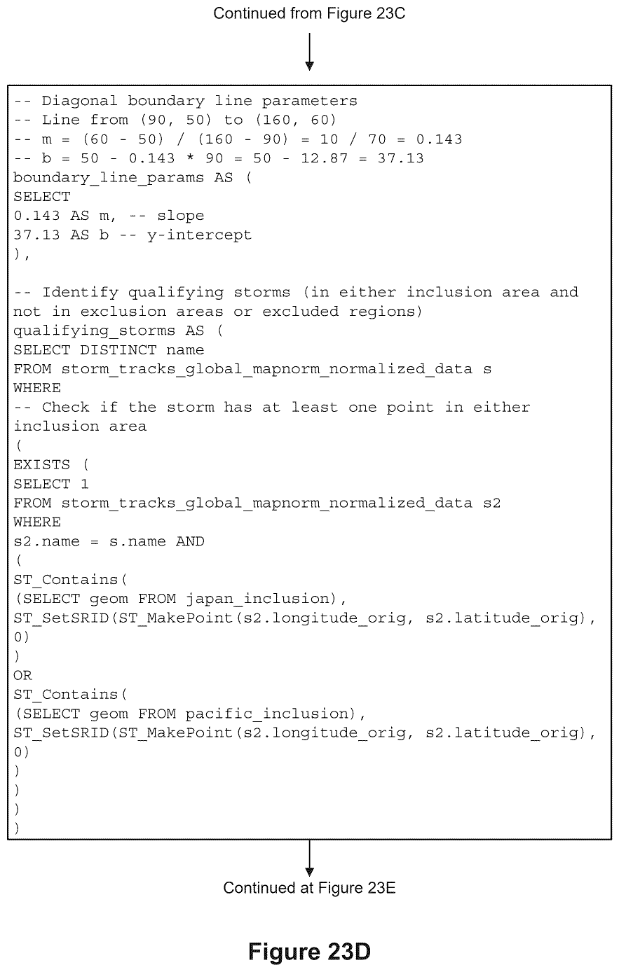

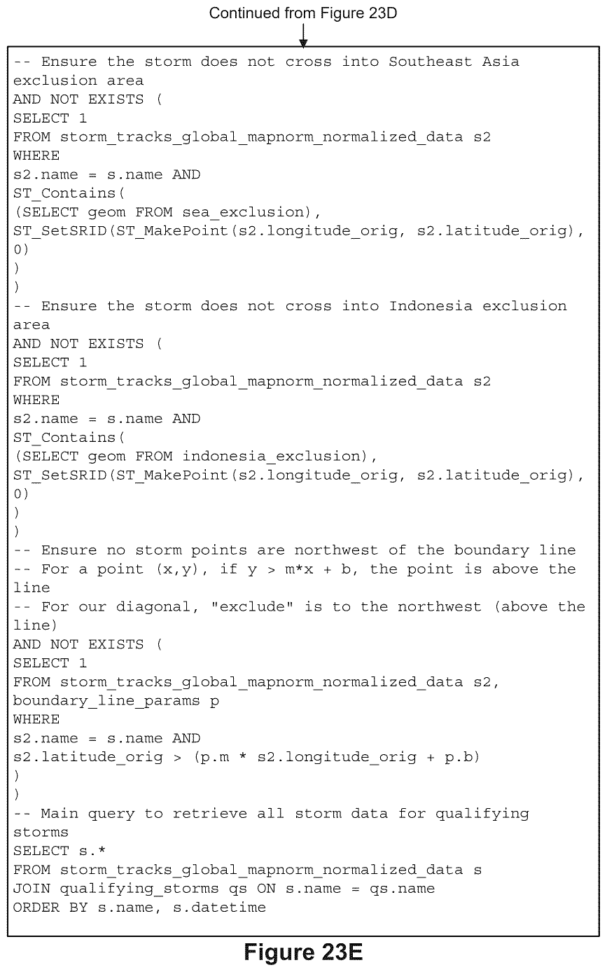

FIGS. 23A to 23E illustrate an example SketchQL annotation interpretation and generated SQL, in accordance with some embodiments.

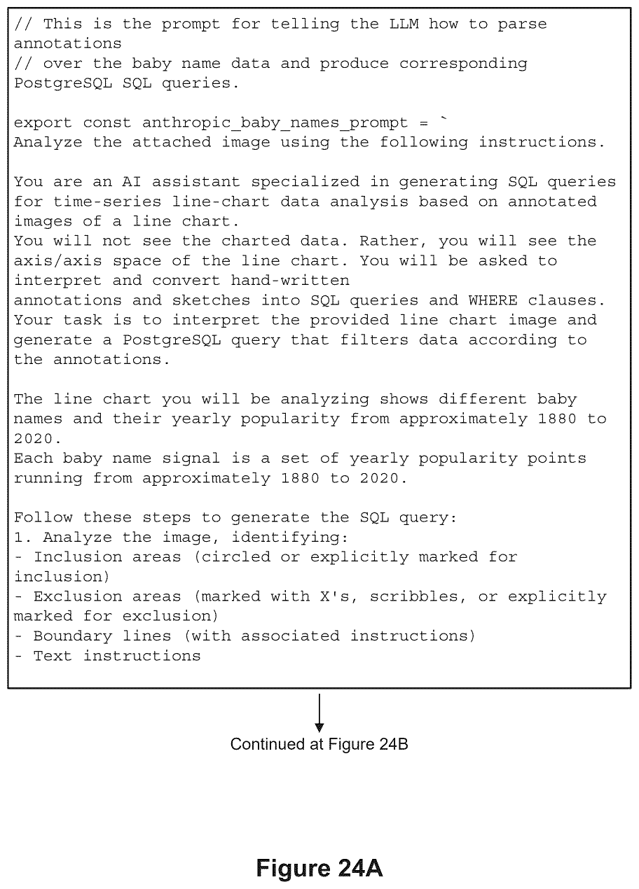

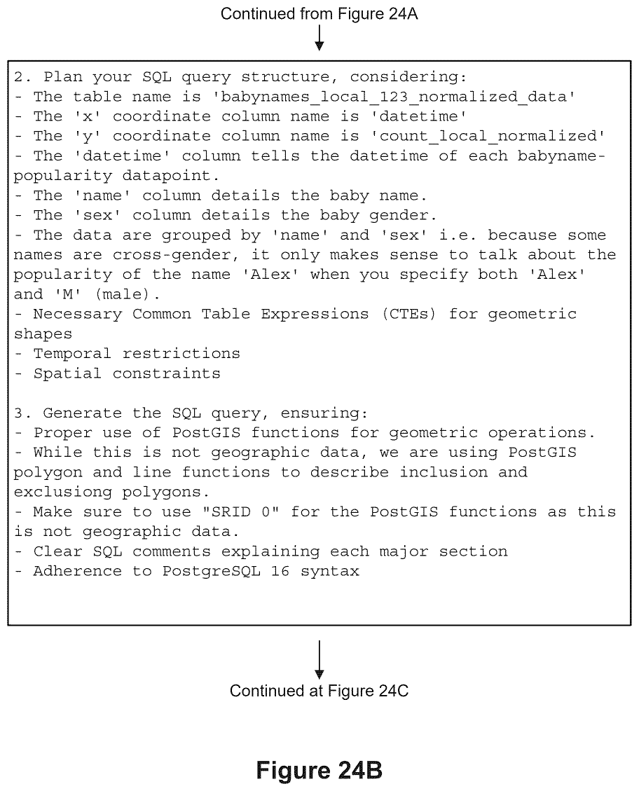

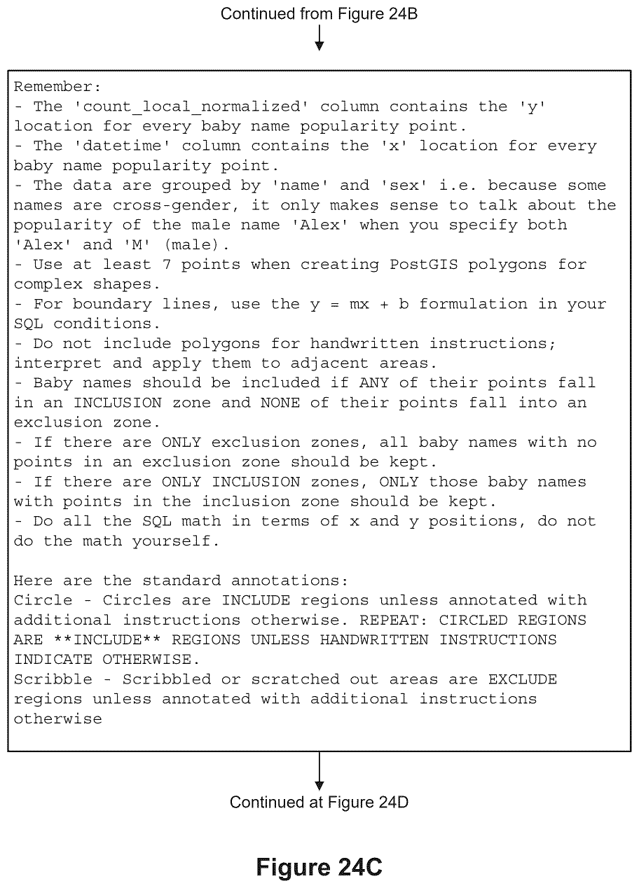

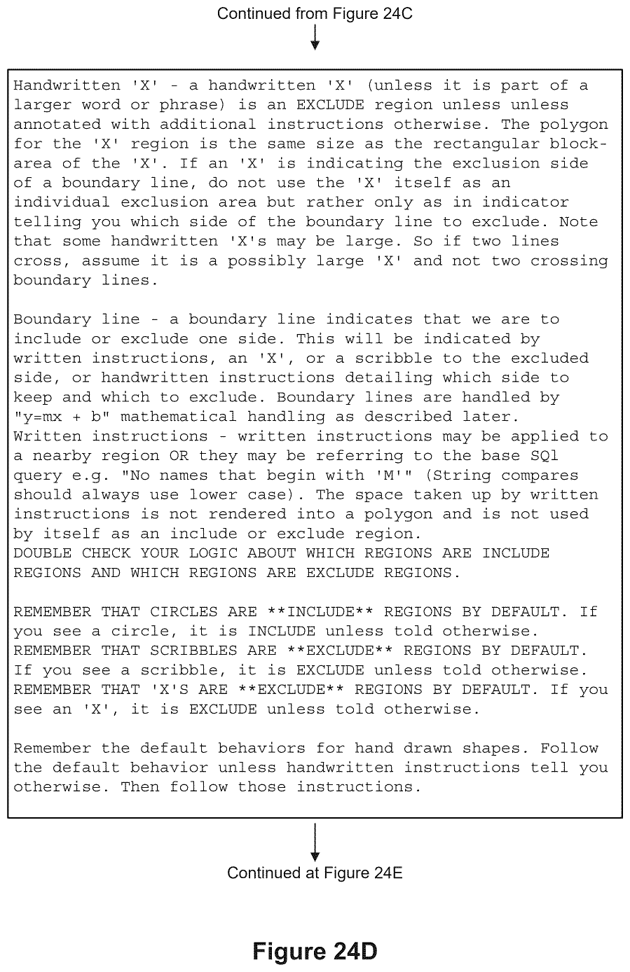

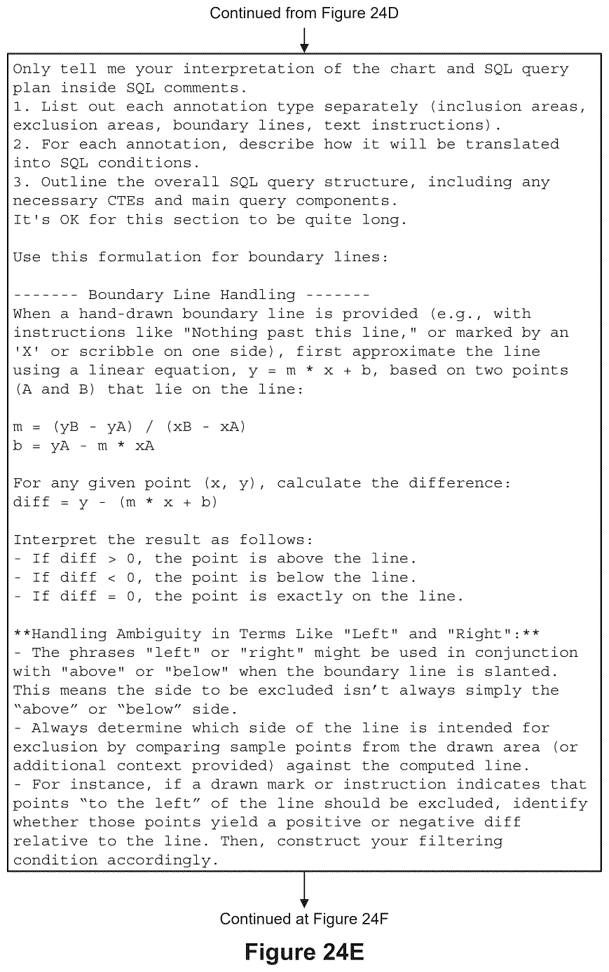

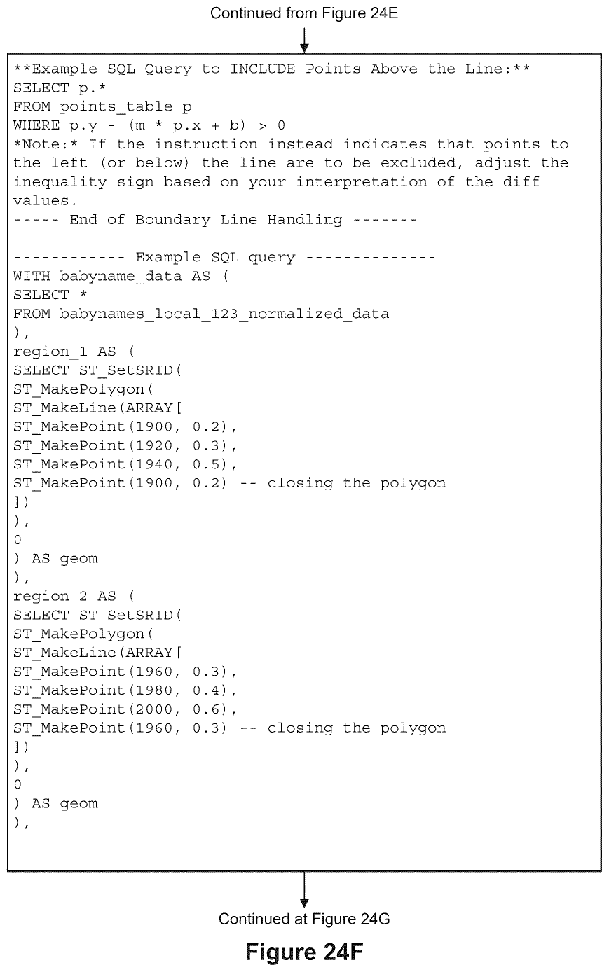

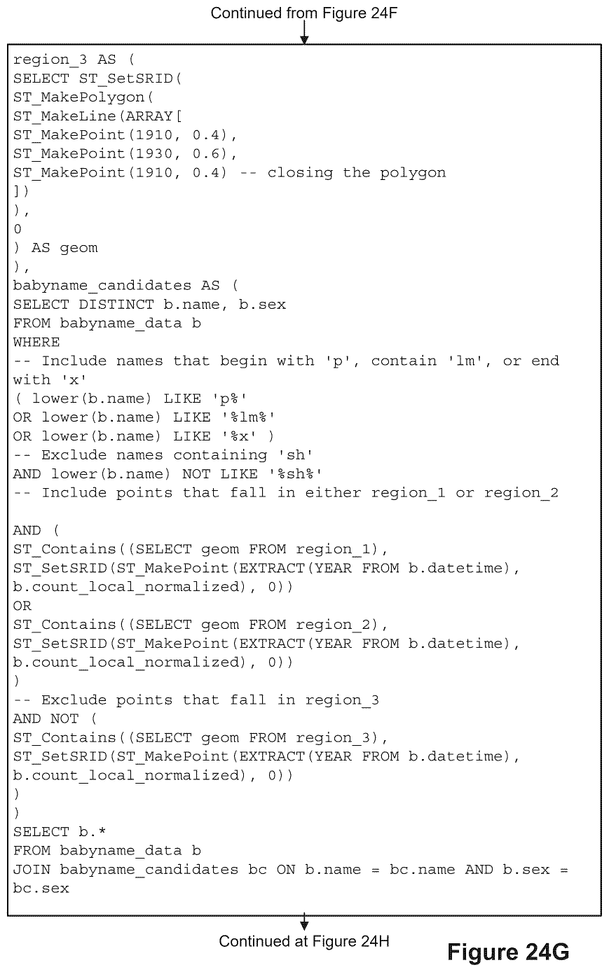

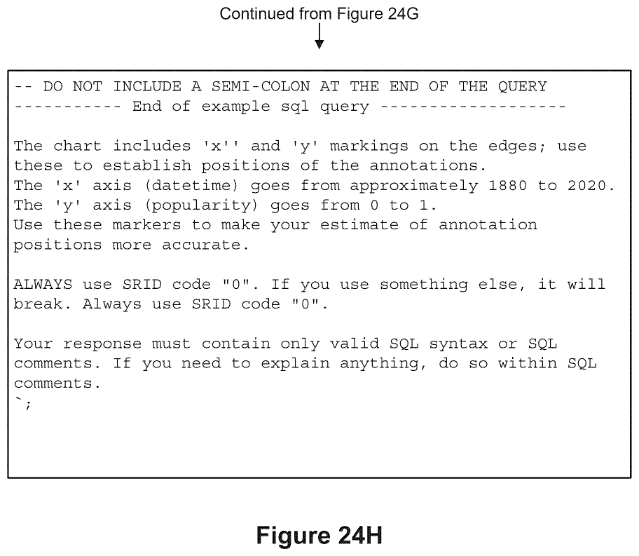

FIG. 24A to 24H illustrate an example LLM prompt for parsing baby name annotations, in accordance with some embodiments.

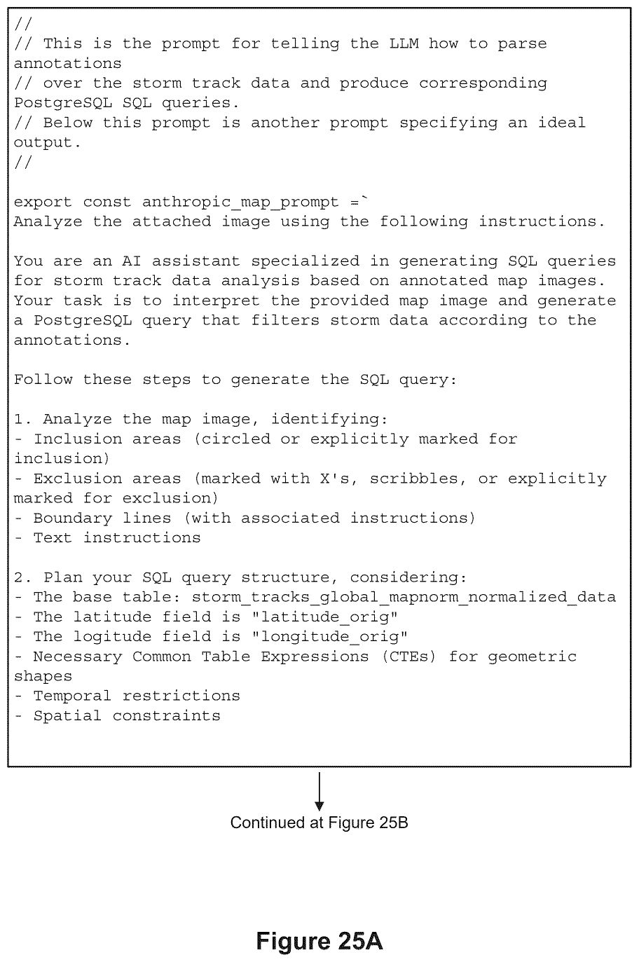

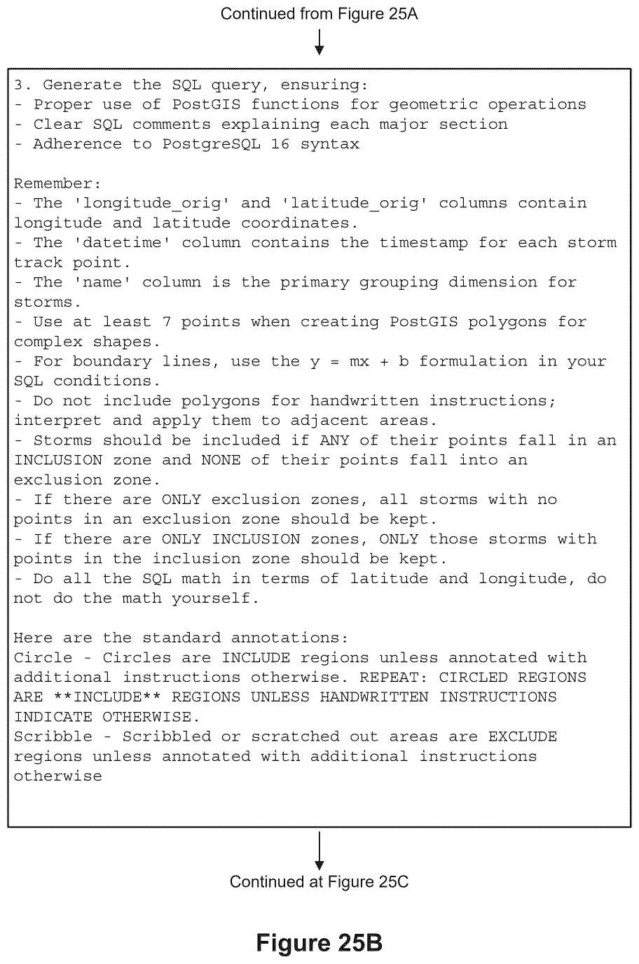

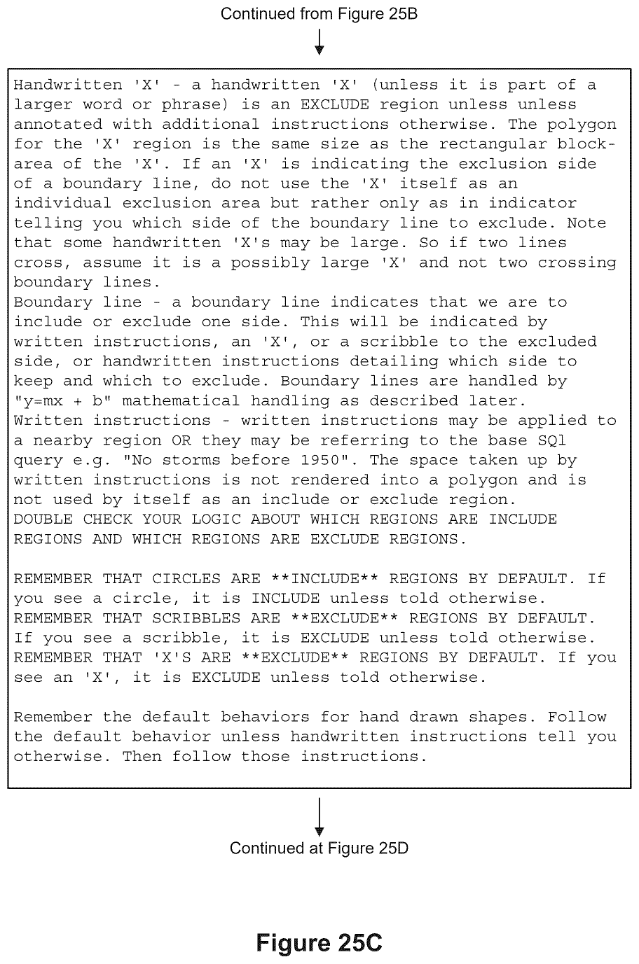

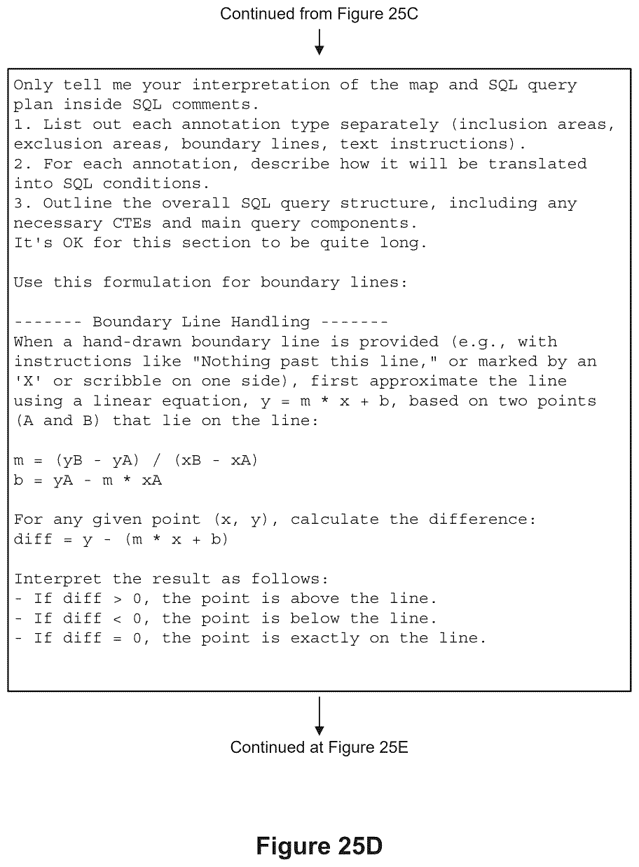

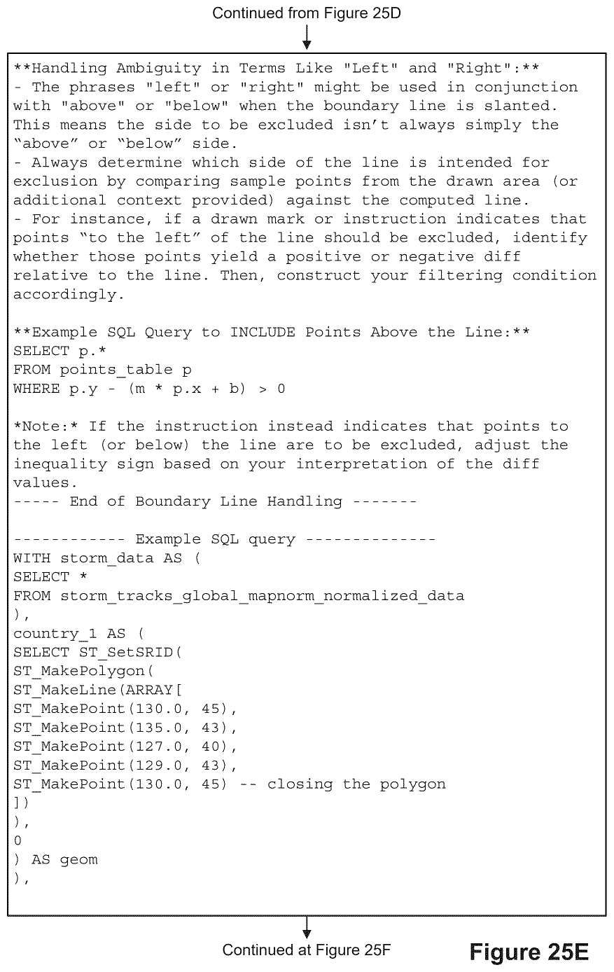

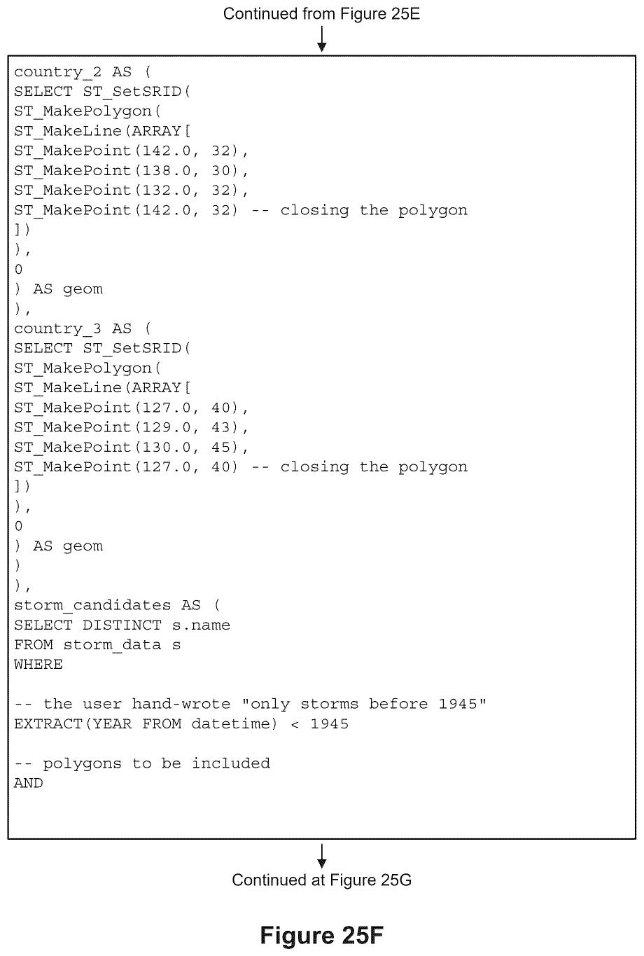

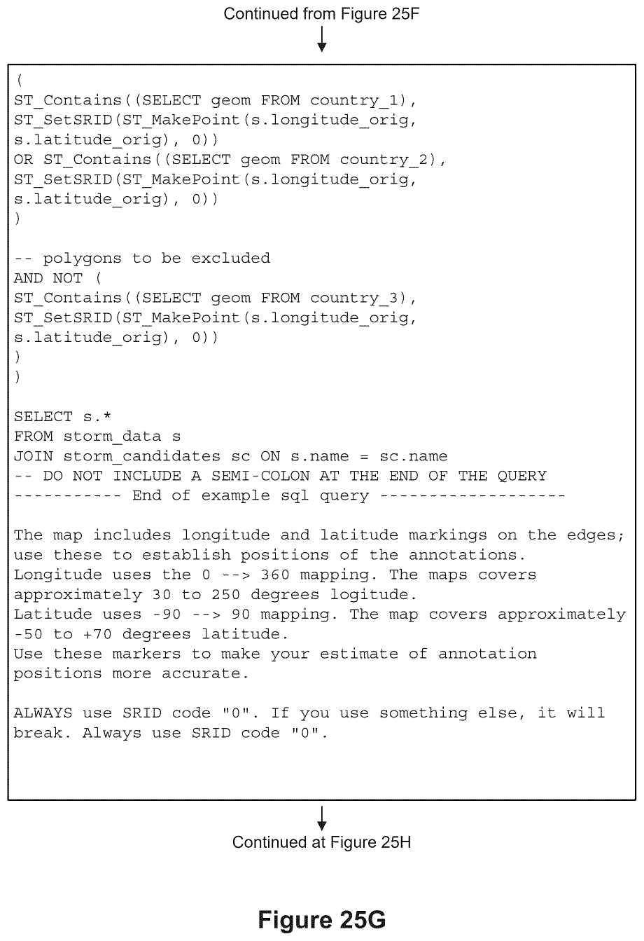

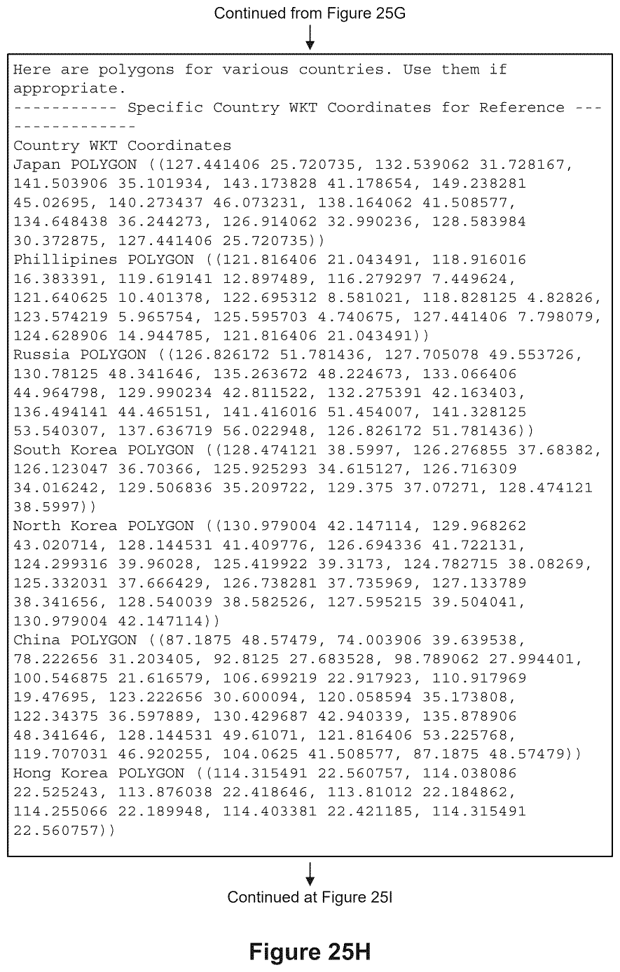

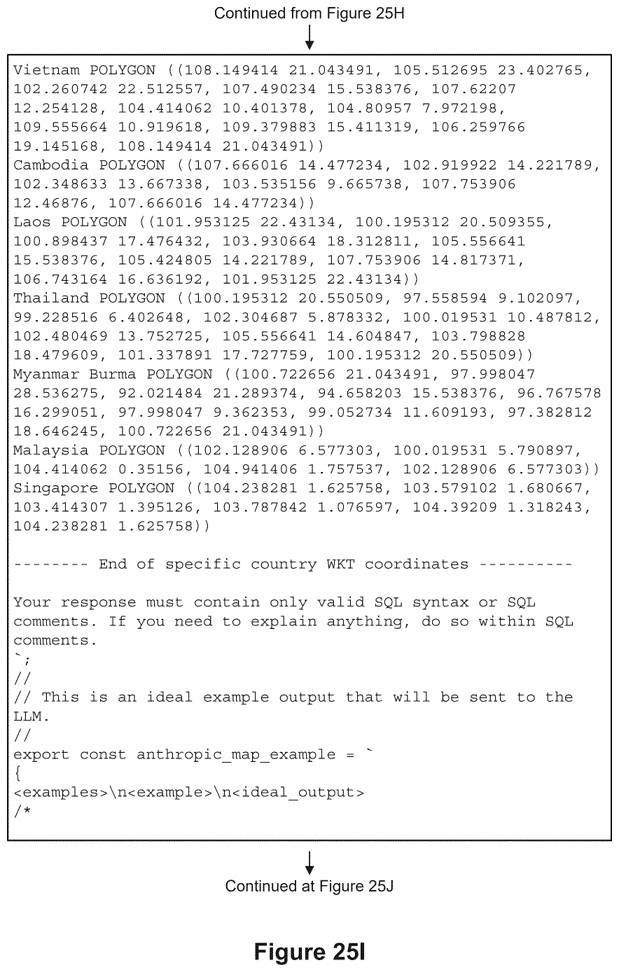

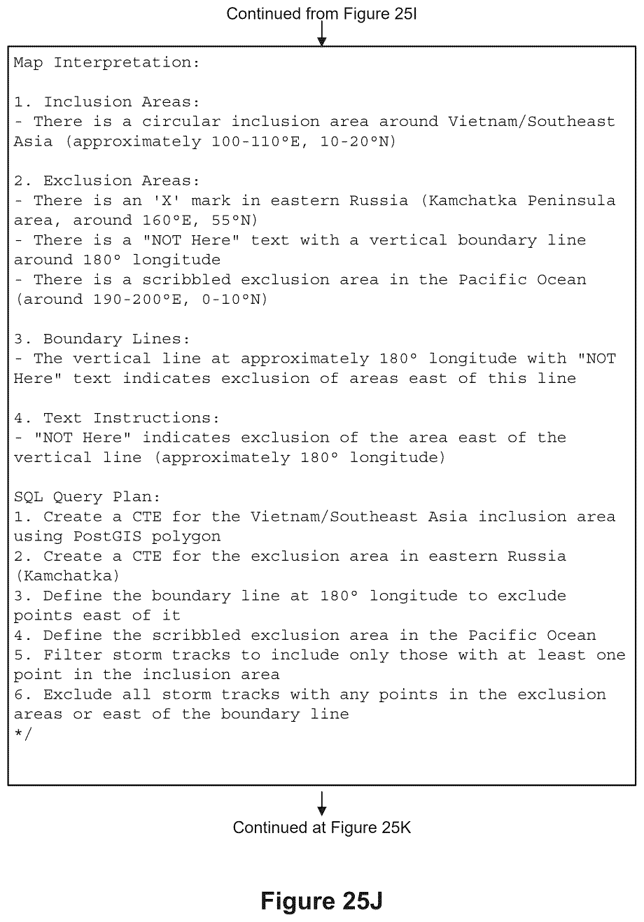

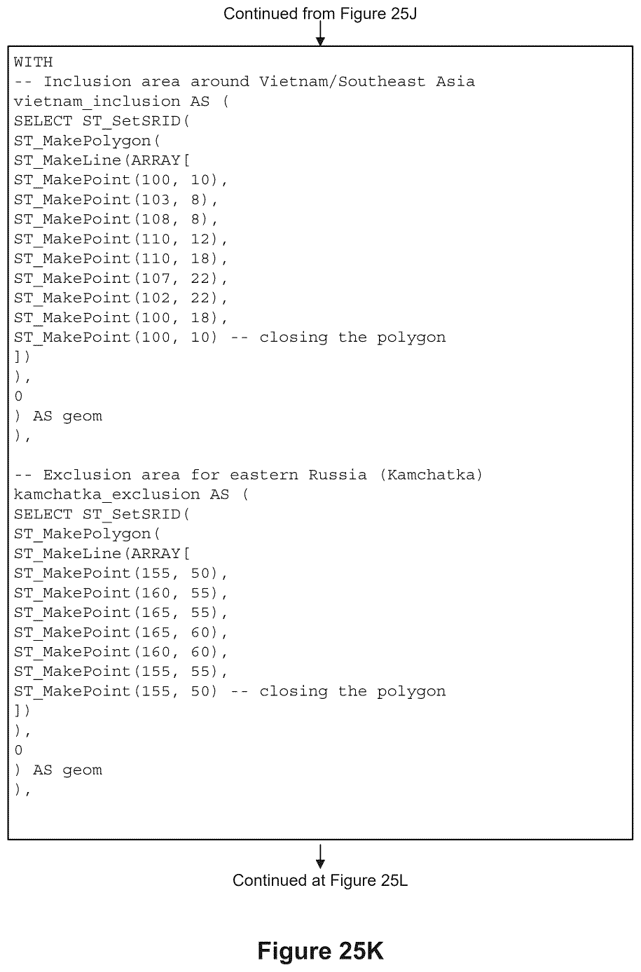

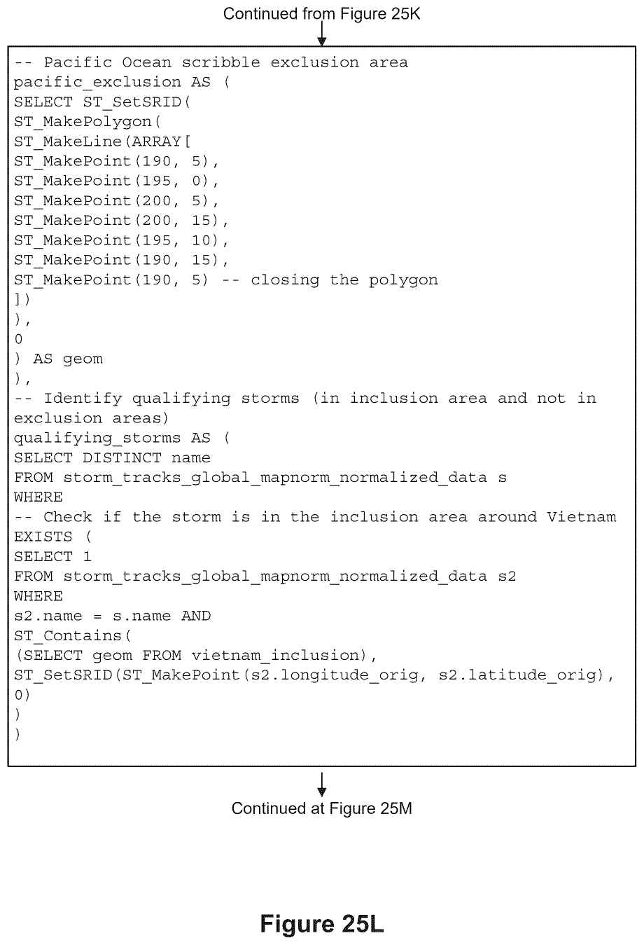

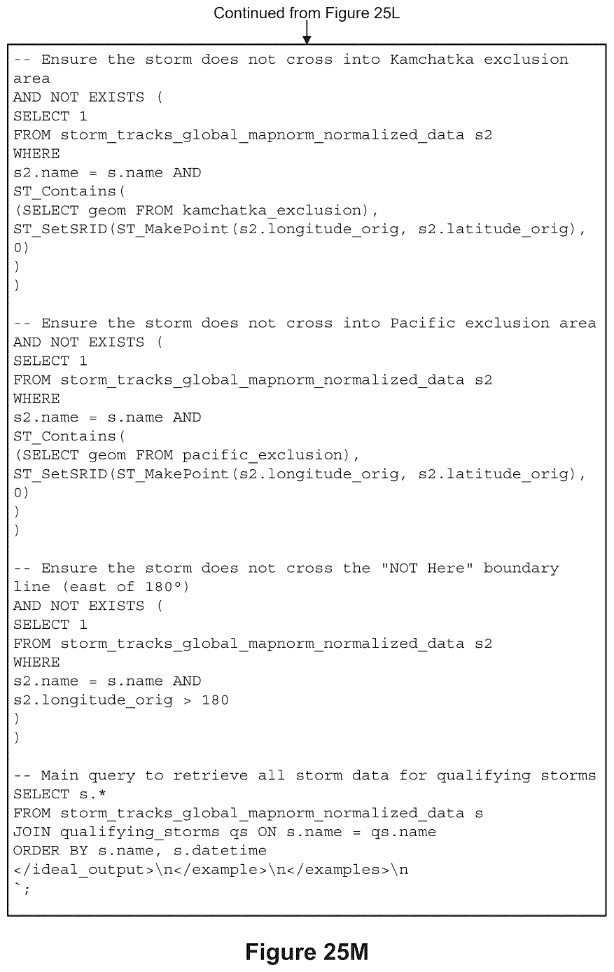

FIG. 25A to 25M illustrate an example LLM prompt for parsing storm track annotations, in accordance with some embodiments.

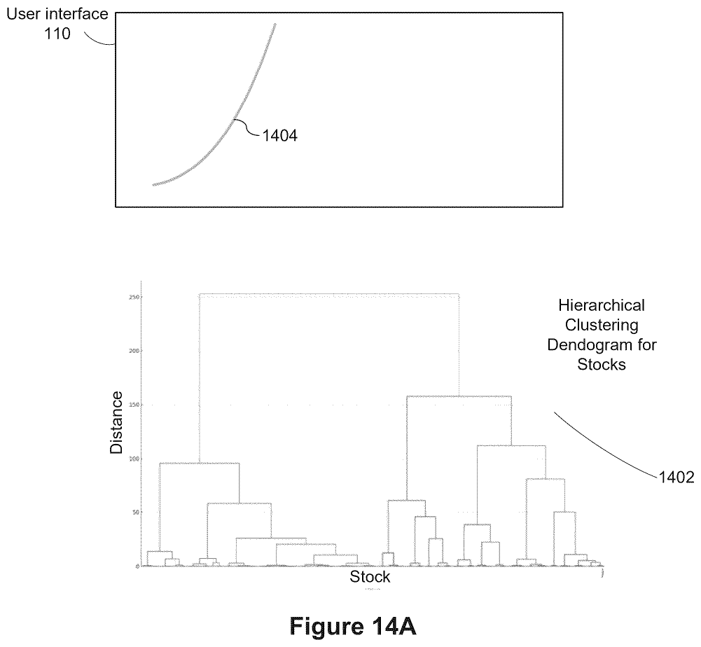

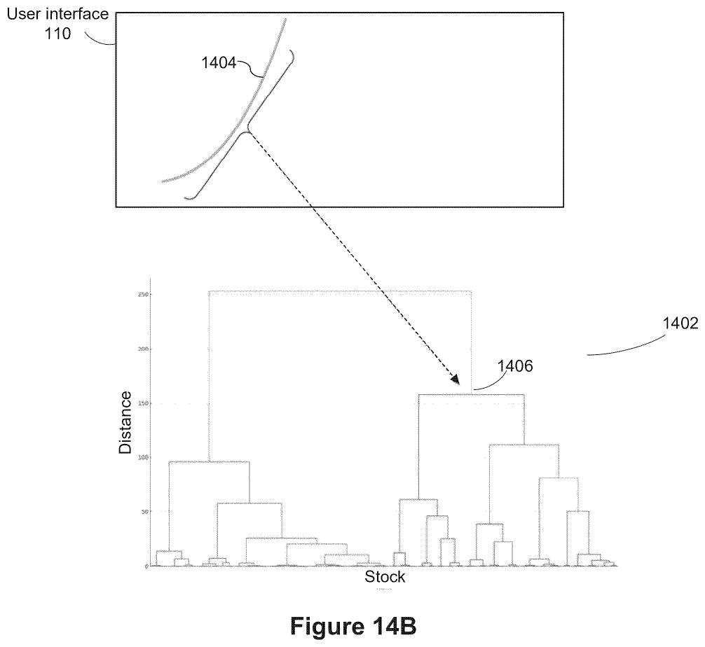

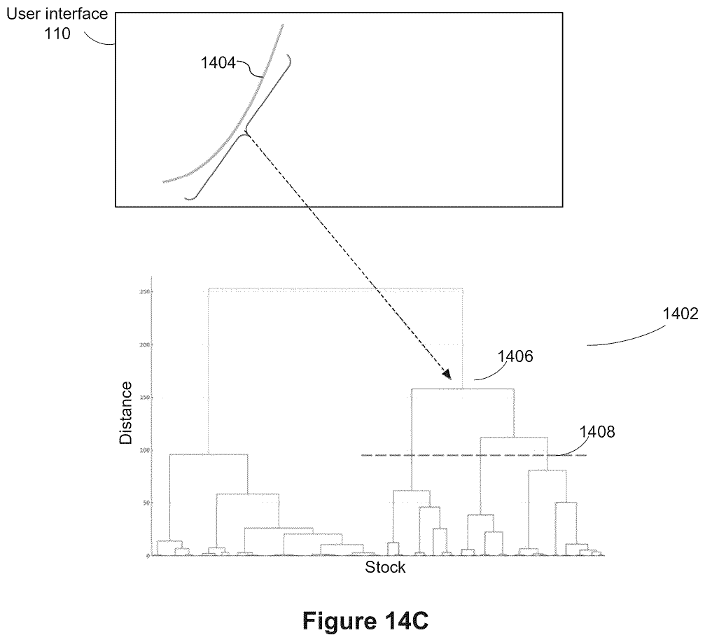

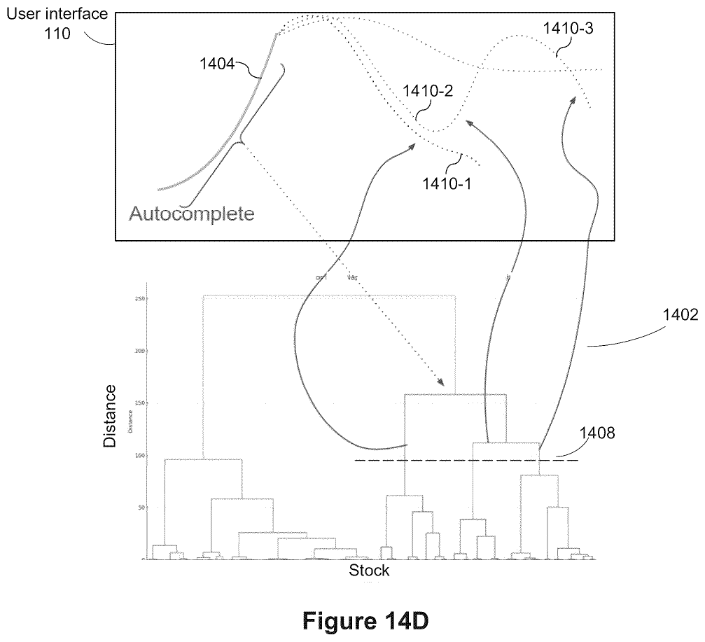

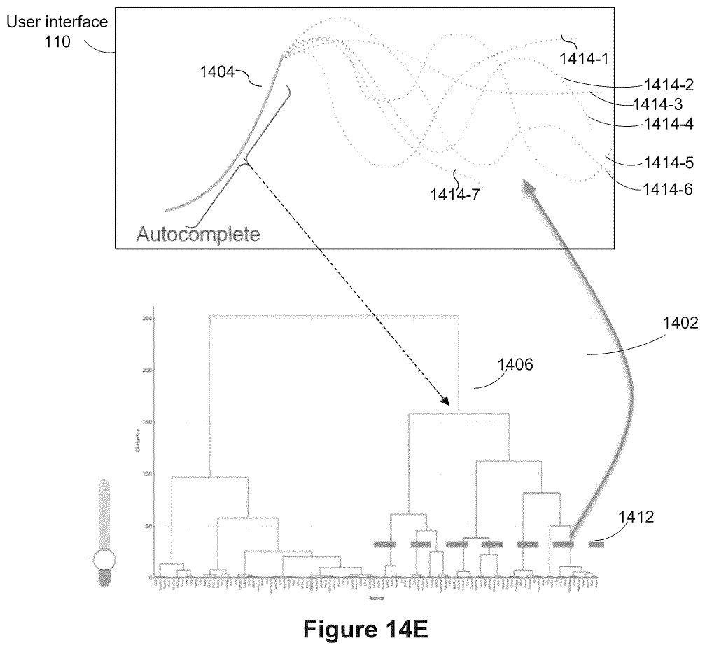

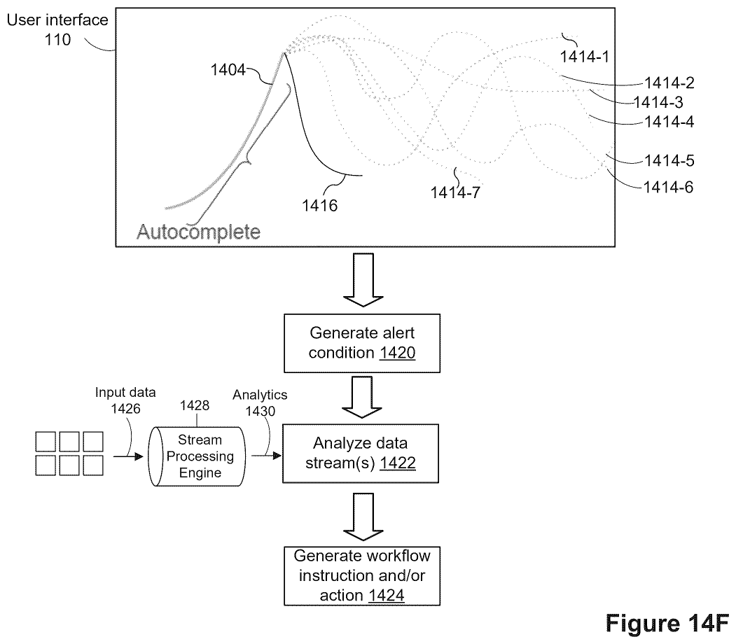

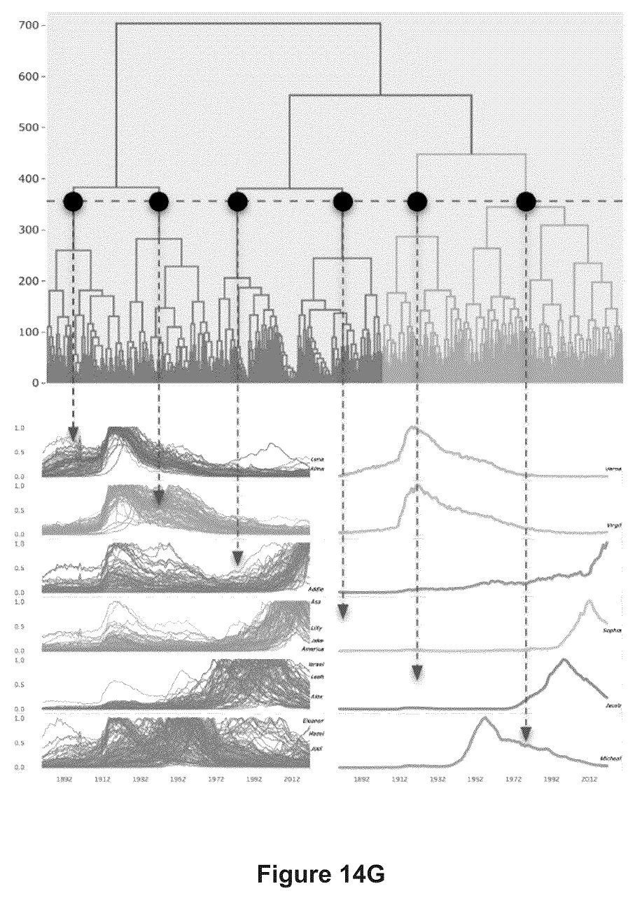

FIG. 3D illustrates a data processing flow for SketchQL, in accordance with some embodiments. Panels A and G show user interactions with 2D storm tracks data. For simplicity of illustration, 1D signal data depicted in panels B to F are used to illustrate the algorithm. The background arrows in FIG. 3D indicate logical data flow. Referring to panel A, a raw input signal originates from either a user sketch (A1) or the database of searchable signals (A2). Panel B shows the raw signal (indicated in blue line) is linearized via Douglas-Peucker simplification algorithm, to generate a linearized signal (indicated in black line). Panel C illustrates the geometry of the simplified signal's segments is analyzed. Panel D depicts another signal from the database of searchable signals is simplified with Douglas-Peucker and analyzed. Panel E shows that the two signals' geometric properties are compared on a per-segment basis. If the signal from panel A originated as a single user sketch, then the difference calculated in panel E will be one of many in a 1×N table (panel F1, highlighted). This table is sorted and the best-fit (e.g., least-error) signals are shown in the user interface, as illustrated in panel G. If the signal from panel A originated from the database as part of an all×all comparison, then the difference calculated in panel E will be one of many in an N×N table (panel F2, highlighted). This table is used for signal:signal analysis such as hierarchical clustering, as illustrated in panel G2, and further discussed with reference to FIGS. 14A to 14E.

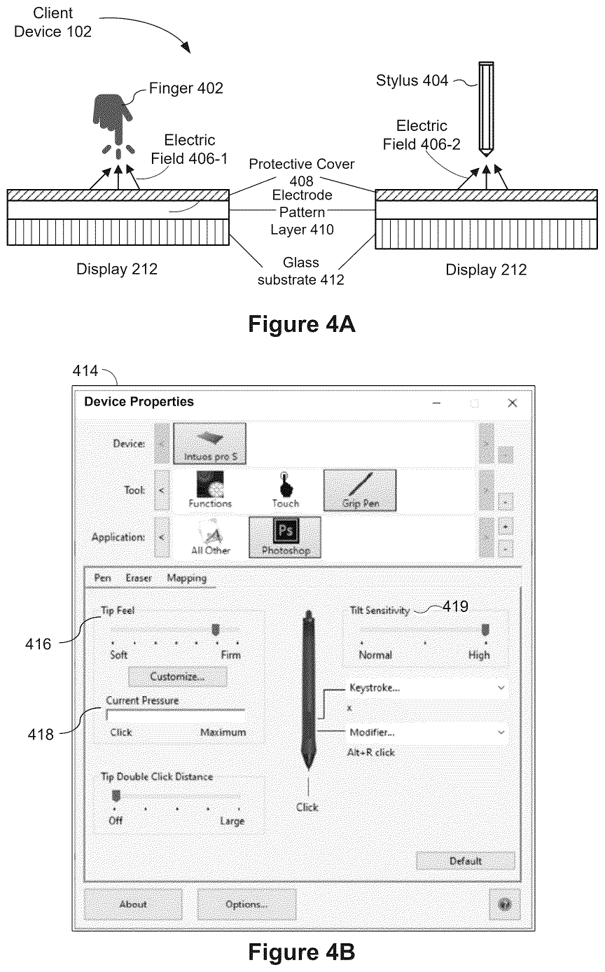

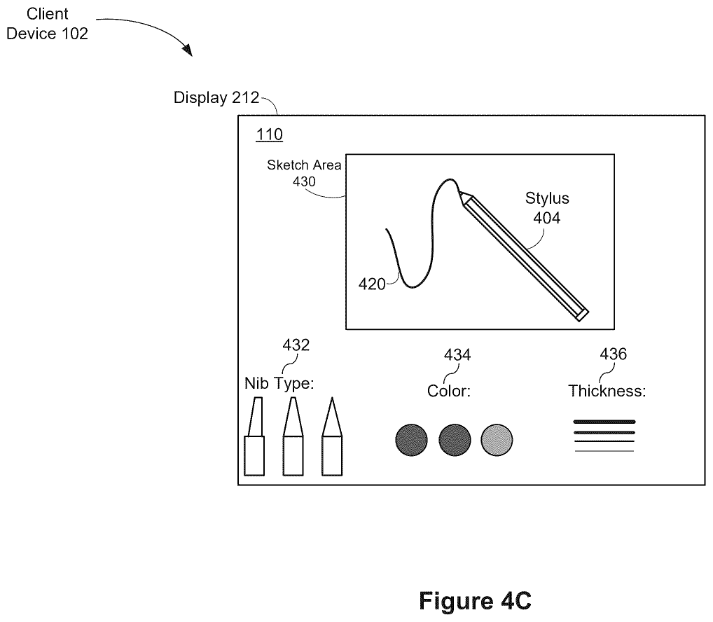

FIGS. 4A to 4C illustrate display properties of client device 102, in accordance with some embodiments. In accordance with some embodiments of the present disclosure, pressure, pause, and/or thickness of stroke can be used to convey salient information about the properties of the sketch input.

FIG. 4A illustrates that, in some embodiments, the display 212 includes a protective cover 408, an electrode pattern layer 410 where a specific arrangement of electrodes (e.g., one or more capacitive sensors 290) is embedded within the display, and a glass substrate 412. In this example, the display 212 is a capacitive touchscreen that is configured to detect touch by sensing changes in an electric field (e.g., electric field 406-1 or 406-2) created on its surface when a finger 402 or a stylus 404 touches the screen. In some embodiments, the display 212 comprises a resistive touchscreen that is configured to detect touch via pressure transducers 286 when a physical pressure applied to the display.

FIG. 4B illustrates that in some embodiments, the client device 102 is configured to detect properties such as a tip feel 416 (e.g., whether the tip that is used to input the sketch is soft or firm), a pressure 418, and a tilt 419 that is measured from a tilt sensor of stylus 404.

FIG. 4C illustrates a user interface 110 that is displayed on display 212 of client device 102, in accordance with some embodiments. The user interface 110 includes a sketch area 430 that is configured to receive a sketch input 420. In this example, the user interface 110 displays one or more options for selecting a nib type 432 of an input device (e.g., finger 402 or stylus 404) that is used for the sketch input, a color 434 of the sketch input, and a line thickness 436 of the sketch input.

As disclosed, in some embodiments, additional information such as sketch metadata can be attached to the linearized sketches. In a touch screen environment, parameters such as stylus pressure or angle can be incorporated to identify the saliency of the sketch features as part of intent interpretation. For instance, different pens (e.g., large, small, or angled) or different nib types (e.g., diffuse, tight, or patterned) may be implemented for the drawing canvas, similar to tools such as Adobe Photoshop. Other metadata such as explicit metadata and implicit metadata are also possible. Each of these metadata may allow the user to inform the query process in some way e.g. especially weight some particular segment, allow some other segment to be optional.

FIGS. 5A to 5G illustrate a user interface 110 for a sketch-based data query system, in accordance with some embodiments. The sketch-based data query system, also referred to herein as SketchQL, supports sketch-based data queries by receiving a sketch input (e.g., drawing input) and returning data whose patterns and/or distributions match the sketch input (e.g., match a shape of the sketch input). The user interface 110 (e.g., SketchQL interface) is designed to explore data through sketch-based inputs. In some embodiments, SketchQL is implemented as a web application, utilizing React.js and Typescript for the frontend user interface, and an HTML canvas, D3, and Mapbox for rendering data and drawing vector sketches. Backend functionality is implemented using PostgreSQL 16.6, Node.JS, Python 3.12, the OpenAI Javascript API, and the Anthropic Claude 3.7 Sonnet LLM.

FIG. 5A shows that the user interface 110 includes a left panel 502 and a right panel 504, in accordance with some embodiments. The left panel 502 is configured to display data signals that match a sketch input. In some embodiments, upon receiving a sketch input, the sketch-based data query system can convert the sketch input into a set of line segments using a linearization algorithm or a spline interpolation algorithm. In some embodiments, these line segments can be sent to the backend (e.g., server system 130) where they are compared to linearized versions of univariate or multi-variate data that are either generated on-the-fly or have been pre-processed. In some embodiments, the comparison can involve scoring each backend dataset based on an amount of rotation, translation, and scaling transforms required to make its line segments match the frontend sketch's line segments. A dataset whose line segments perfectly align with the frontend sketch's line segments—thus requiring zero line transformations—would receive a score of zero and would be a perfect match. By contrast, line segments that require non-zero transformations to align with the frontend would receive a non-zero score. the higher the non-zero score, the worse the match. In some embodiments, the backend returns a score for each dataset to the frontend, where the frontend can then use those scores to filter, sort, or otherwise inform the data presentation to the analyst

FIG. 5A illustrates that, in some embodiments, the user interface 110 displays (e.g., on the left panel 502) one or more options, such as an option 512 that enables specification of a limit on the scale transform error (e.g., a scalar value), an option 514 that enables specification of a limit on the rotation transform error (e.g., a scalar value), an option 516 that enables specification of a limit on the translation transform error (e.g., a scalar value), and an option 518 that enables specification of a limit on a maximum error (e.g., a scalar value).

In some embodiments, the user interface 110 displays an option 507 that, when selected, enables a map to be displayed. This feature will be discussed in FIGS. 5D to 5G.

The user interface 110 includes a right panel 504. The right panel 504 includes a tab 509 that, when selected, displays a set of representations (e.g., representation 506-1 and representation 506-2), corresponding to a collection of previous search queries (e.g., sketch queries) that are stored in sketch library 134. Each representation 506 includes a corresponding shape 508 (e.g., contour) of the input query.

In FIG. 5A, the user interface 110 receives selection of search affordance 510.

FIG. 5B shows that in response to receiving selection of search affordance 510, the user interface 110 displays a sketch input dialog 520 that includes a drawing canvas 522. In some embodiments, the drawing canvas 522 is an HTML canvas. The sketch input dialog 520 comprises a large whiteboard style-like drawing area with multiple drawing tools and an outlined area (e.g., drawing canvas 522) indicating the drawing region. The axes of the drawing region run from (0,0) in the lower-left corner to (1,1) in the upper-right corner. In some embodiments, the user can indicate via a Boolean GUI checkbox whether these 0-1 axis ranges correspond to a self-normalization or global normalization scheme. This Boolean value will be sent to the backend and cause the query to be run against either the self or global normalized points, angles, and lengths. In either case, on the frontend, the sketching is always done in 0-1 normalized space.

The system interprets sketch inputs (e.g., drawn by hand or other input devices such as a mouse or a stylus) by analyzing a drawing input (e.g., sketch input 524) on the drawing canvas 522, which directly queries the data to match the desired data shape. In some embodiments, the sketches are labeled using a predefined vocabulary of quantitative trend descriptors, which categorize the sketches based on attributes such as slope direction, curvature, and magnitude. This allows for faceted search behavior, where users can filter results based on specific trend characteristics. The strokes of the sketch are then translated into a set of text query terms that incorporate both the geometric features of the sketch and the temporal context in which the data exists.

The sketch input dialog 520 can display different colored pens (e.g., with color 528-1 and color 528-2) that lets the user indicate which measure data field to search for while keeping both queries in the same visual and cognitive editing space. Stated another way, the user can query one or more measures (e.g., measure data fields) in a single sketch by sketching with different colored drawing pens. Each per-measure colored line will be linearized using a linearization algorithm; these will then be sent to the backend to query for the indicated measure. In some embodiments, the user might also choose to indicate a specific epsilon value (e.g., tolerance value for linearization algorithm) rather than searching all of them. Sketches may also be disconnected sketch segments instead of a single, continuous line. Ultimately, the linearized segments from sketches will be sent to the backend for comparison against the preprocessed data.

In some embodiments, the sketch input dialog 520 displays an annotation palette 530 with different annotation colors (e.g., colors 532-1 to 532-3), which may be used in a whiteboard-style manner to annotate the sketch, but only the measure colors are used for data queries. In some embodiments, the sketch input dialog 520 displays a text option 534 that, when selected, enables a user to add explanatory information or text annotations (e.g., text labels) to a sketch input. Annotations can include sketched visual information such as crossed-out or scribbled-out regions to exclude, circled regions to include, boundary lines, text (e.g. “only storms after 1970”), and ad hoc instructions. In some embodiments, the sketch input dialog 520 displays “clear canvas” option 536 that, when selected, erases the sketch inputs and/or associated annotations from the drawing canvas 522. In some embodiments, the user interface 110 can also display one or more timeline options that enable a user to define a time span for the sketch, or a time difference (e.g., time delta) between two points on the sketch.

In FIG. 5B, the user inputs a sketch input 524 (e.g., sketch input or drawing input) for the measure field corresponding to color 528-1. In this example, the sketch input 524 is a downward slope with two portions 525-1 and 525-2. The user selects query icon 538, which causes a search query to be executed.

FIG. 5C shows that in response to user selection of the query icon 538, the user interface 110 displays two datasets 542 and 544. Each dataset includes a respective portion that matches the shape of the sketch input 524.

In some embodiments, the search query corresponding to sketch input 524 is stored in sketch library 134. FIG. 5C illustrates that the right panel 504 updates display of the set of representations 506, to include representation 506-3 having a shape 508-3 that corresponds to the sketch input 524.

FIG. 5D illustrates a scenario where the option 507 is selected (e.g., toggled on). In this instance, the sketch input dialog 520 displays a map 550 that is superimposed over the drawing canvas 522. In some embodiments, the map 550 is encoded with geographic coordinates, such as latitude and longitude coordinates.

In FIG. 5E, the user interface 110 receives sketch input 552 via the sketch input dialog 520. In this example, the sketch input 552 is a query for a storm path (e.g., having longitude and latitude coordinates). The user interface 110 receives selection of the query icon 538.

FIG. 5F shows the user interface 110 display a map 554 that includes sketch input 552 on the left panel 502. The right panel 504 displays representation 506-4 having shape 508-4 corresponding to the sketch input 552.

In FIG. 5G, the user interface 110 displays, on map 554, datasets 556 (e.g., dataset 556-1 to dataset 556-5) with shapes that match the shape the sketch input 552.

In some embodiments, SketchQL is configured to handle time series data such as individual stock prices over time, baby name popularity over time, storm path over time. In some embodiments, SKETCHQL can handle most time series data signals as long as they have a continuous datetime measure field, one or more groupable dimensions, and at least one continuous measure. For example, the storm tracks data set shown in the example of FIGS. 5E to 5G comprises five columns (data_row_id, name, datetime, latitude, longitude) and 8,570 rows while the baby names data set comprises five columns (data_row_id, name, datetime, sex, and count) and 75,544 rows.

In some embodiments, the user interface 110 can be combined with LLM- and multimodal-based sketch interfaces. By combining the intuitive, visual input of sketches with natural language processing capabilities of LLMs, users can express complex data queries in a more natural and flexible manner. For example, users can draw trends, patterns, or hypotheses on a digital canvas, while the LLM interprets and translates these sketches into meaningful data queries. LLMs could also be used to enhance the system's understanding of ambiguous or underspecified sketches, inferring the user's intent even when the sketches are imprecise or incomplete. Additionally, the combination of LLMs and sketch interfaces could support multimodal feedback loops. For example, users could ask the system to modify the drawn trends by specifying changes in text, such as altering the time period, adding conditions, or suggesting alternative hypotheses. Incorporating sketch-based interfaces alongside traditional input methods (like text queries and direct manipulation interfaces) could create a more expressive mixed initiative data exploration tool. This capability would enable users to switch between modes depending on their analytical task or personal preference.

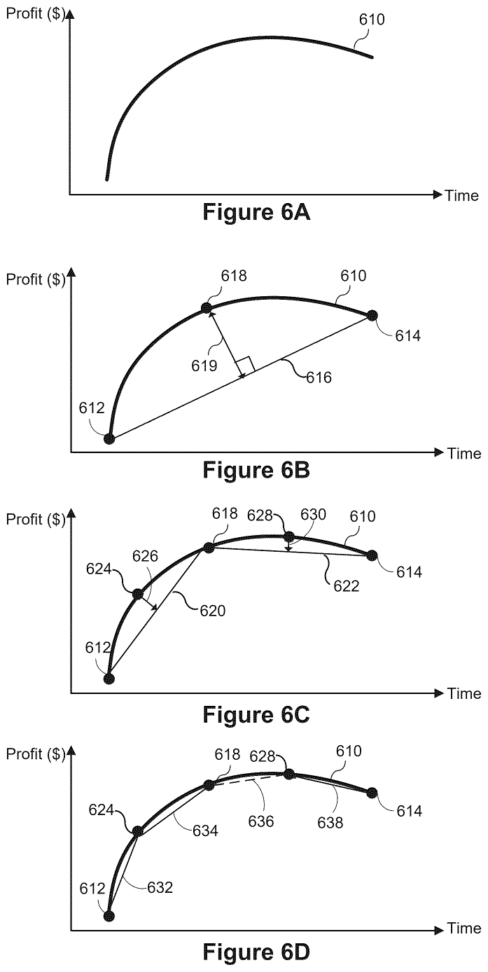

FIGS. 6A to 6D illustrate a linearization process in accordance with some embodiments. In some embodiments, the linearization process is executed by a linearization algorithm.

FIG. 6A depicts a curve 610 showing profit over time. FIG. 6B identifies the two end points 612 and 614 to be retained. A line segment 616 is drawn between the two end points 612 and 614. Points on the curve 610 between the two end points are examined to determine a point 618, on the curve 610, that has a largest perpendicular distance 619 to the line segment 616. In the case where the linearization algorithm is the Douglas-Peucker algorithm, the perpendicular distance 619 is also known as the epsilon value (e.g., a tolerance value).

FIG. 6C shows the line segment 616 is replaced by (i) line segment 620 connecting point 612 and point 618 and (ii) line segment 622 connecting point 618 and point 614. The algorithm recursively processes these two line segments, by (i) determining a point 624, on the curve 610, that has a largest perpendicular distance 626 to the line segment 620 and (ii) determining a point 628, on the curve 610, that has a largest perpendicular distance 630 to the line segment 622.

FIG. 6D shows that the curve 610 can be simplified (e.g., converted) into a set of line segments 632, 634, 636, and 638.

In the example of FIGS. 6A to 6D, the linearization algorithm is applied by calculating a perpendicular distance (e.g., distance 619, distance 626, and distance 630) from the straight-line segment to the curve. In some instances, the perpendicular distance (e.g., vector) includes a time component (e.g., x-component) and a profit component (e.g., y-component). Because the vector has components of two data fields (e.g., profit and time), its units are non-intuitive.

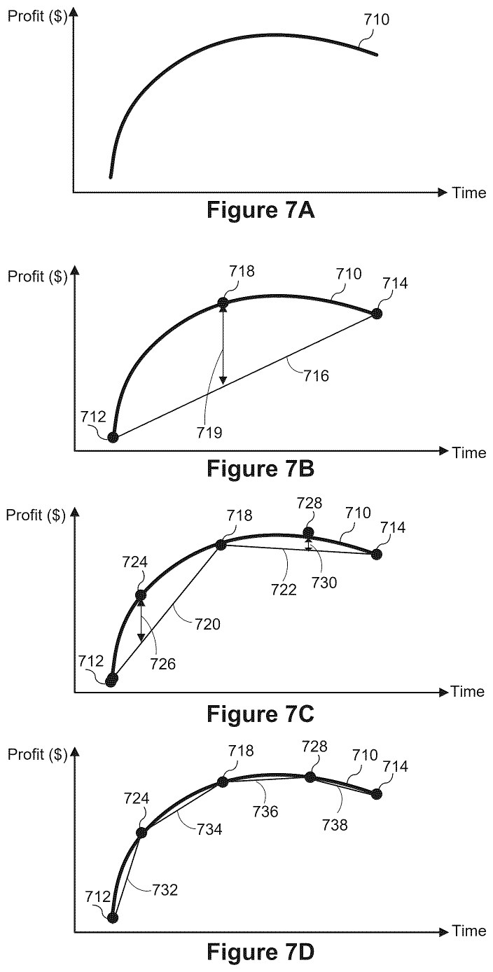

FIGS. 7A to 7D illustrate a linearization process by applying a linearization algorithm using a vertical vector, in accordance with some embodiments.

FIG. 7A shows a curve 710 of profit over time. In FIG. 7B, the two end points of the curve 710, namely point 712 and point 714, are identified and retained. A line segment 716 connecting point 712 and point 714 is drawn. The linearization algorithm identifies a point 718, on the curve 710. The point 718 that has a largest vertical distance 719 from the curve 710 to the line segment 716.

In FIG. 7C, the line segment 616 is replaced by (i) line segment 720 connecting point 712 and point 718 and (ii) line segment 722 connecting point 718 and point 714. The algorithm determines a point 724, on the curve 710, that has a largest vertical distance 726 to the line segment 720. The algorithm also determines a point 728, on the curve 710, that has a largest vertical distance 730 to the line segment 722.

FIG. 7D shows that the curve 710 can be simplified (e.g., converted) into a set of line segments 732, 734, 736, and 738.

In the example of FIGS. 7A to 7D. the linearization algorithm calculates a vertical distance (e.g., vector) (e.g., distance 719, distance 726, or distance 730), which has only a vector component with units of the measure field (e.g., dollars, for profit).

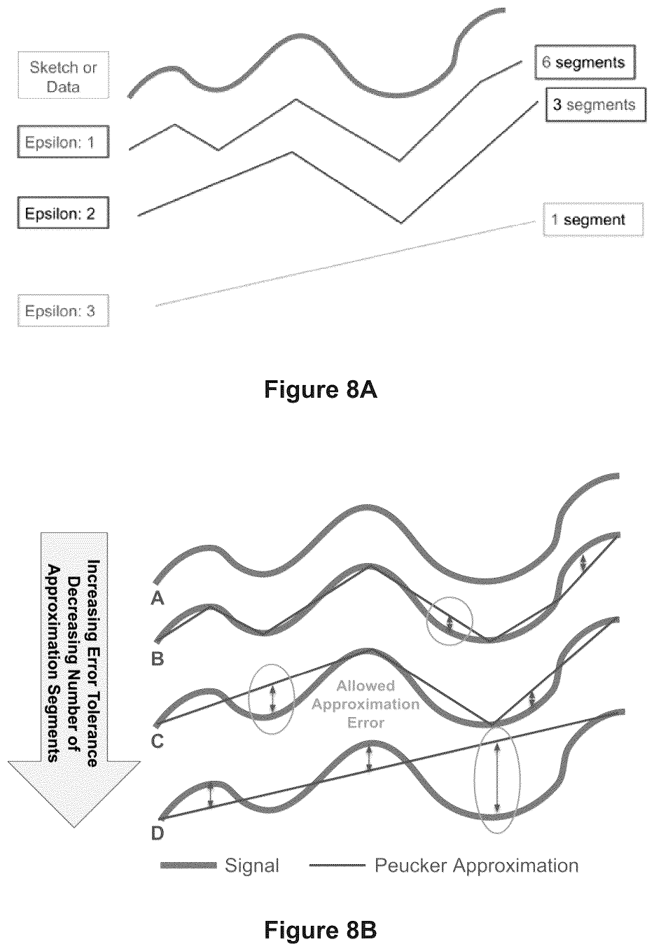

FIG. 8A illustrates an example of a sketch or data that is linearized at different Peucker-epsilon levels, in accordance with some embodiments. In some embodiments, the Douglas-Peucker algorithm produces different levels of resolution depending on the epsilon value. The epsilon value indicates the degree of error that the linear approximation is allowed to make.

A user begins on the frontend with a sketch on the canvas (see FIGS. 5A to 5G). This sketch is linearized into line segments using a linearization algorithm. Example linearization algorithms include the Douglas-Peucker algorithm, the Visvalingam-Whyatt algorithm, the Reumann-Witkam algorithm, and the Opheim algorithm. In some embodiments, the sketch is linearized into line segments by applying a spline interpolation algorithm. These line segments are then sent to the backend, where they are compared to linearized versions of univariate or multi-variate data, which may be linearized at different epsilon levels (e.g., tolerance levels) as illustrated in the example of FIG. 8A.

FIG. 8B illustrates the role of epsilon in Douglas-Peucker segmentation.

Given an original signal (A), the algorithm produces different levels of resolution depending on the epsilon (error tolerance) value (B-D). Because the epsilon value indicates the degree of error that the linear approximation is allowed to make, higher allowable error results in fewer simplification segments.

In some embodiments, each backend data set (e.g., aggregated at the user-selected dimensional level of detail) is scored based on the amount of rotation, translation, and scaling transforms required to make its line segments match the frontend sketch's line segments. A dataset whose line segments perfectly align with the frontend sketch's line segments—thus requiring zero line transformations—would receive a score of zero and would be a perfect match. By contrast, line segments that require non-zero transformations to align with the frontend would receive a non-zero score. the higher the non-zero score, the worse the match. In some embodiments, the backend returns a score for each dataset to the frontend, where the frontend can then use those scores to filter, sort, or otherwise inform the data presentation to the analyst.

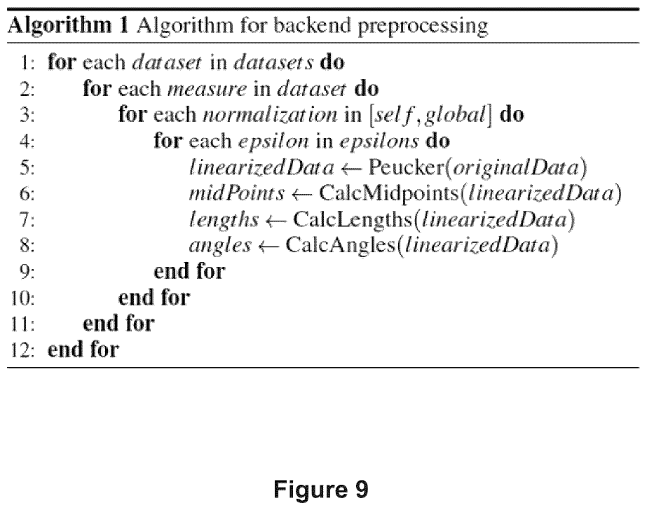

FIG. 9 illustrates an exemplary algorithm for backend preprocessing, in accordance with some embodiments.

In some embodiments, at various points during a data analysis session, analysts indicate that a particular data set is of interest. This indication might occur at the beginning of a session or it might occur intermittently as new datasets are introduced. When these moments occur, SketchQL preprocesses the data into a form that will make later sketch-queries more performant. Specifically, this preprocessing occurs at one or more dimensional levels-of-detail and for every measure of interest. Using a dataset showing baby name popularity over time as an example, where the dimension data fields (e.g., categorical data fields) are ‘Name’ and ‘Date’ and the measure data field (e.g., numerical data fields or quantitative data field) is ‘Popularity’. In some embodiments, preprocessing first normalizes the data in two ways: (1) self-normalization (or local normalization), which normalizes the dataset to the minimum and maximum measure values within that dataset and (2) global normalization, which normalizes the dataset to the database-wide minimum and maximum measure values.

In some embodiments, normalization can be implemented by normalizing against global external limits such as “0” for minimum pricing (e.g. if the data does not contain a perfect “0” value) or [−180,180] for global longitudinal span. For example, the baby name popularity data can be normalized between [0-localMaximum] to give local percentage information without truncating the y-axis, and the storm tracks data can be normalized to [0°, 360°-] longitude and [−90°, −90°] latitude for compatibility with mapping libraries.

Table 1 illustrates an example SQL schema of the storm tracks normalized data table.

TABLE 1

| create table if not exists | |
|---|---|
| public.storm_tracks_global_mapnorm_normalized_data | |
| ( | |
| data_row_id | bigint, |
| name | text, |
| datetime | timestamp, |
| latitude_orig | double precision, |
| longitude_orig | double precision, |
| latitude | double precision, |
| longitude | double precision, |
| global_min_dt | timestamp, |
| global_max_dt | timestamp, |
| local_min_latitude | double precision, |
| local_max_latitude | double precision, |
| local_min_longitude | double precision, |
| local_max_longitude | double precision, |
| normalized_date | numeric, |
| latitude_local_normalized | double precision, |
| latitude_global_normalized | double precision, |
| longitude_local_normalized | double precision, |
| longitude_global_normalized | double precision, |

);

In some embodiments, SketchQL implements a Douglas-Peucker algorithm to Peucker-linearize (e.g., linearize) the data (e.g., univariate or multi-variate data), whereupon are left with a series of connected line segments. Each line segment has (1) a midpoint, (2) a length, and (3) every pair of line segments establishes an inter-segment angle (e.g., the angle formed where two segments meet).

In some embodiments, the midpoints and lengths are necessarily already in the range of 0 to 1 as they were calculated within the 0-1 normalized space. To put angles in the same 0 to 1 space (which will be necessary later for calculating error), some implementations divide the angle by 360 degrees to put the calculated angle in a 0-to-1 circle. These midpoints, lengths, and angles are stored for every linearized dataset. In some embodiments, this is performed for multiple epsilon-resolutions (e.g., tolerance values) for every dataset. When preprocessing is complete, the data is ready for future queries.

In some embodiments, multiple epsilon values are applied to capture a larger set of linearization resolutions, some of which may match the frontend sketch better than others. Some implementations use the self-normalization and global normalization because they enable searches in both percentage space (e.g., “find the stocks that increased by 20% halfway through the chart”) and global space (e.g. “find the stocks that increased by $27 between June and July”).

In some embodiments, every measure of every dataset has multiple different [position, length, angle] sets—one for each [normalization, epsilon] combination (see algorithm). For example, if the Babynames database has 3 names [John, Mary, James], 2 normalization schemes (self and global), 4 Peucker-epsilon values [0.1, 0.2, 0.3, 0.4], then the backend will have a total of 3×2×4=24 different line segment sets in its database. To execute a search, in some embodiments, the user selects whether to search in the self or global normalization schema, which means that, in this example, the system only needs to compare the sketch against 3×4=12 different data linearizations.

Because the end goal of the Douglas-Peucker signal decomposition is to provide signal-alignment building blocks, some embodiments take each DP-simplified segment and calculate its geometric properties. These properties serve as points of signal comparison and ultimately signal alignment. In some embodiments, for each segment of the DP-simplified signal, various properties are calculated (see FIG. 3D, panel C), including:
Length: A multi-value tuple representing the segment's length along each measure (e.g. latitude, longitude)
Midpoint: A multi-value tuple representing the segment's midpoint position along each measure.
Time midpoint: A single-value number representing the average time value of the segment's two endpoints.
Velocity: A multi-value tuple representing the segment's change over time (dy/dt) for every measure.

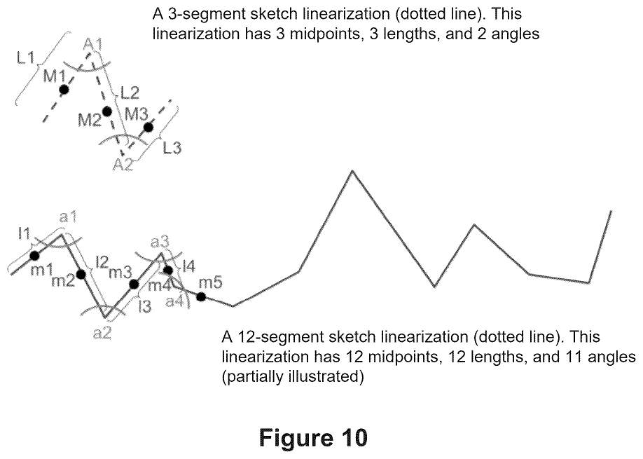

When a sketch is a continuous (e.g., unbroken) sketch, it gives rise to a connected series of line segments (versus a disconnected sketch gives rise to a disconnected set of line segments—see next section). In some embodiments, to use the sketch line-segments to query the preprocessed database of midpoints, lengths, and angles, SketchQL first calculates midpoints, lengths, and angles for the sketch line-segments. At this point, both the sketch line-segments and the data-line segments have comparable properties—normalized midpoints, lengths, and angles (see FIG. 10). In FIG. 10, SketchQL calculates a shape-query error score by calculating the difference between M1 and m1, M2 and m2, M3, and m3, L1 and l1, L2 and 12, L3 and 13, A1 and a1, and A2 and a2. Each of these is in the same 0-1 range, so it can perform a simple subtraction to find the absolute difference (2D midpoint position differences are calculated using Manhattan distance rather than perpendicular distance for simplicity.) At this point, if all of these differences are added up, one would obtain an error score for this matching. If the sketch exactly matched the data, then all midpoints, lengths, and angles would be the same and the difference would be zero—a perfect match. Anything less than this perfection will show differences in those measurements. Shapes that are very similar will have only slight differences while shapes that are very different will have large differences.

FIG. 10 shows an example of aligning a continuous sketch to a data signal, in accordance with some embodiments. The sketch-query has midpoints M1-M3, lengths L1-L3, and angles A1-A2. The data linearization has midpoints m1-mn, lengths l1-ln, and angles a1-an. The sketch linearization is slid down the data linearization from left to right, differencing midpoints, lengths, and angles along the way. The lowest difference score is reported as the best score for this sketch:data pairing.

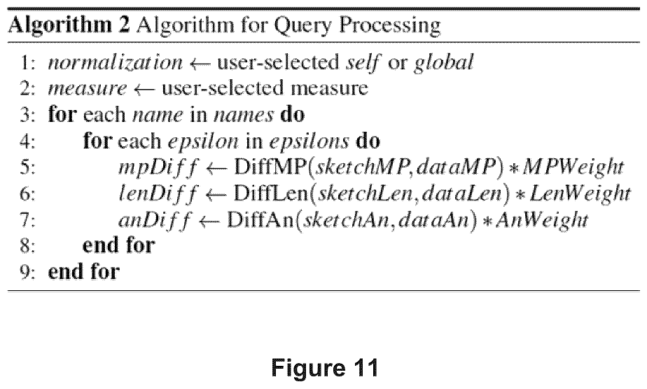

FIG. 11 illustrates an example algorithm for query processing, in accordance with some embodiments.

In some embodiments, each of the differences can be weighted. For example, the angle difference is weighted (i.e., assign or give higher penalties for differences) because a 0.2 (note that the values are normalized) change in midpoint distance results in only a 20% shift along one of the axes but it results in a 72 degree rotation, which fundamentally changes the nature of that line slope. Thus, in some embodiments, SketchQL is configured to penalize rotation differences much higher than translation or scale differences. In some embodiments, weighting is also be used to improve search capabilities. For example, a user could set the horizontal translation weight to zero, removing all penalties for horizontal positioning. If the horizontal axis is Time, for example, this would enable the user to search for a shape at any period of time without preference for one time over another. Similarly, weighting the vertical translation by zero would enable the user to you search for a 20% increase in stock price (say) but without consideration for where that stock was when it began its 20% rise. At this point, one difference score has been calculated for this sketch/data alignment. But there are many more alignments. For example, in some embodiments, SketchQL computes the difference when aligning midpoints M1:m1, M2:m2, and M3:m3. In some embodiments, SketchQL can also try aligning M1:m2, M2:m3, and M3:m4 by simply sliding the sketch down the data to try the next line segment pairing. This pairing will also give a difference. Next, SketchQL slides it again and look at the differences if it attempts to align M1:m3, M2:m4, M3:m5. etc. This will give us LengthOfData−LengthOfSketch+1 difference scores. For example, aligning a 3-segment sketch with a 12-segment data signal, as illustrated in FIG. 6, will generate 10 difference scores. In some embodiments, SketchQL takes the minimum score from this set and considers that the best score for this sketch:data matching. In some embodiments, SketchQL does this for all preprocessed datasets within one of the normalization schemes (e.g., if the user elects to search within ‘self’ normalization, each Name has 4 datasets, one for each epsilon value). SketchQL then groups by the level-of-detail dimension (‘Name’ in this case) and takes the minimum (e.g., “John” had best scores from the 4 epsilon linearizations). SketchQL takes the best of these and declares that score to be ‘John's score. The best score for each dimensional dataset (‘Name’ in our example here) is then returned to the frontend.

With the DP-simplified signals and calculated per-segment geometric properties, the segments of different signals can be compared and a final signal:signal similarity score can be calculated. In some embodiments, to compute similarity between the DP-simplified signals, the system generates a difference score for every signal:signal pair by comparing the segment properties discussed in FIG. 3D, panel D. A zero-difference would indicate that the signals are identical. A segment:segment difference matrix, as illustrated in panel E of FIG. 3D, can be built out, where each segment:segment-difference score is calculated as the sum of the absolute property differences between the two segments, each scaled by a user-settable error penalty scalar, i.e.:

$$\sum ( \vert Length A - Length B \vert \cdot ScalarLength + \vert MidpointA - MidpointB \vert \cdot ScalarMidpoint + \vert TimeMidpointA - TimeMidpointB \vert \cdot ScalarTimeMidpoint ) + \vert VelocityA - VelocityB \vert \cdot ScalarVelocity )$$

Penalties let the user tune SKETCHQL's interpretation of the sketched trend. For example, increasing the length penalty scalar would discourage the system from matching signals whose segment lengths were materially different from the sketch's segment lengths, while setting the time penalty scalar to zero would allow the system to match similarly-shaped signals no matter when they occurred. These penalties can be set by the user using the advanced options menu in the user interface. Note that the length, midpoint, and velocity differences are multi-measure tuples (e.g. [latitude, longitude]) and are calculated per-measure and then summed. This ability to transition smoothly through the trend search space and continuously control trend matching not only among the different scoring factors (using user-adjustable scoring penalties) but also within the multi-dimensional space of the data itself (using user-adjustable per-dimension DP epsilon values) is one of SKETCHQL's contributions. The final analysis result of this scoring is a segment:segment difference matrix. This matrix can be used to perform a least-errors alignment between the two signals.

In some embodiments, signal:signal alignment is performed by finding the path through the segment:segment error matrix that minimizes the path-total of the per-segment errors calculated above. As signals may have different numbers of segments, the smaller signal must be fully contained within the larger signal i.e. there can be no ‘null’ overlaps. In some embodiments, segment skipping (FIG. 3D, panel E) is allowed. For example, segments 1 and 2 of the first signal could overlap with segments 3 and 5 of the second signal, skipping segment 4. Skipped segments incur a user-settable skipping penalty, which may be zero.

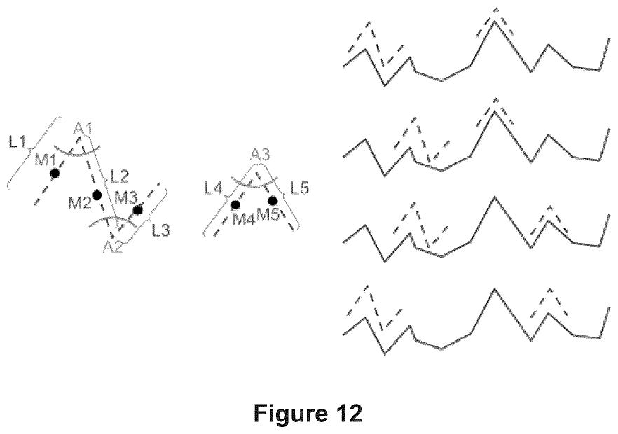

FIG. 12 illustrates an example of aligning a discontinuous sketch, in accordance with some embodiments. On the left are the two separate linearizations of a discontinuous sketch. On the right are examples of different alignment combinations that must be considered in the search for the lowest difference score, in accordance with some embodiments.

The final signal:signal score is the cumulative sum of the segment:segment error along the least-errors path augmented with the skipping penalty e.g. a three-segment alignment with difference values of 0.1, 0.2, and 0.3 and two skips in it might have a value of

$$0.1 + 1 * ScalarSkipPenalty + 0.2 + 1 * ScalarSkipPenalty + 0.3$$

To this signal:signal score are added two final error penalties. The first error penalty accounts for the difference in segment count between the two signals

$$\vert signal 1. numSegments - signal 2. numSegments \vert \cdot ScalarSegmentCountDiff$$

Without this num-segments penalty, single-segment signals tend to become artificial cluster centers (below) as every signal has at least one segment. This penalty encourages ‘like’ signals to be similar in curvature. The second error penalty is a ‘stretch’ penalty that encourages the first segments of each signal to be close to each other and the last segments of each signal to be close to each other.

$$( \vert signal 1. firstSegment - signal 2. firstSegment \vert + \vert signal 1. lastSegment - signal 2. lastSegment \vert ) \cdot ScalarStretchPenalty$$

By stretching the shorter signal to align with the entire longer signal, SketchQL encourages the signal alignment to match complete shapes rather than just local subsequences. Finally, the least-errors alignment uses dynamic programming with early exit to cache computed values and avoid recomputing segment differences. The dynamic programming analysis uses a maximumError parameter (e.g., set via a ‘precision’ slider in the user interface) to prune potential paths whose preliminary error has already exceeded the given threshold; this results in faster computation by avoiding alignment computation between very different signals. In total, this analysis gives us a sparse all×all signal:signal comparison matrix.

In some embodiments, when a discontinuous sketch (e.g., such as the sketch in FIG. 12) is received, SketchQL maps the multiple parts of that sketch onto a continuous data line segment set. Unlike the continuous sketch case above, which simply slides the sketch along the data signal, the discontinuous sketch scenario has to search for the best combination of sketch alignments. FIG. 12 shows a two-part discontinuous sketch. The right portion of FIG. 12 shows that there are multiple options for aligning the sketch with the data. The alignment is more complicated because the sketch parts can move independently with the restrictions that 1) they do not overlap and 2) the sketch parts stay in order. One cannot in general assume that we can fit the first segment part and then fit the second, for example, because the second part's score in some configuration may be so low or so high as to render the first part's alignment better than expected or worse than expected. Thus we need a way of searching all possible options.

In some embodiments, for speed of prototyping, SketchQL implements a search of all alignment combinations. However, this process can be slow. In some embodiments, SketchQL implements dynamic programming processes and intelligent use of the given constraints to only calculate differences where needed.

In some embodiments, some of the approaches discussed above can be replaced in a modular manner. For example, in some embodiments, sketch:data comparisons are performed by linearizing both of them and then comparing the linearizations. In some embodiments, SketchQL is configured to switch to one of the two algorithms, or even a third algorithm, in accordance with a determination that it is more efficient, faster, or better. Even the sub-algorithm of how to find the lowest-score sketch:data matching in the multi-segment scenario could be replaced.

In some embodiments, when the frontend receives the query results from the backend, it has a difference score for each dataset. The frontend can then use these scores to present the data to the user e.g. show only the best (lowest-difference) names, sort the names by score, etc.

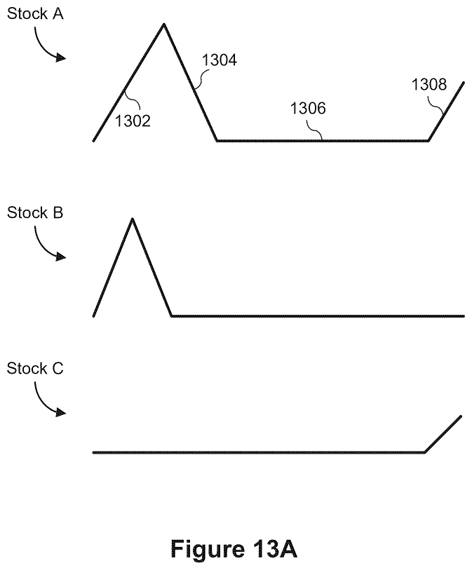

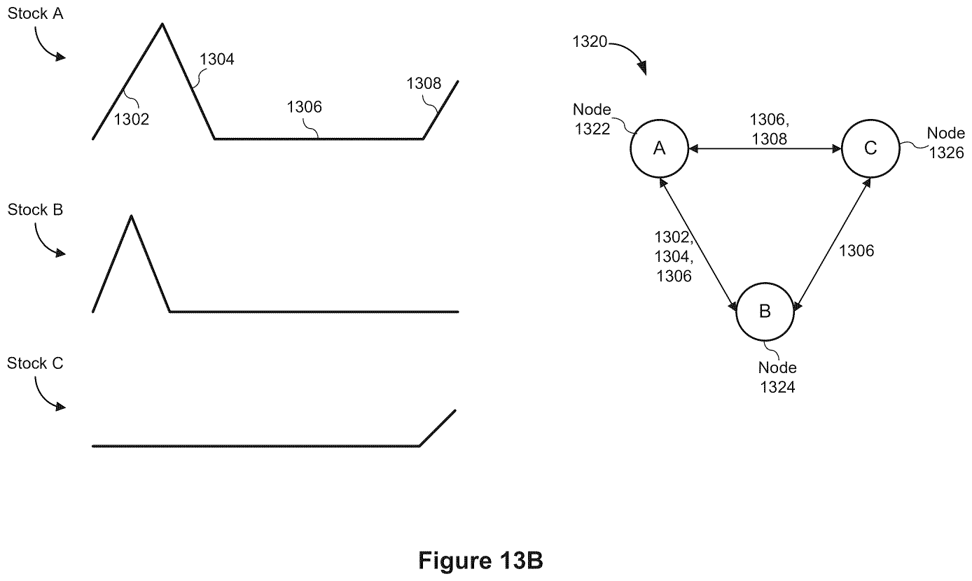

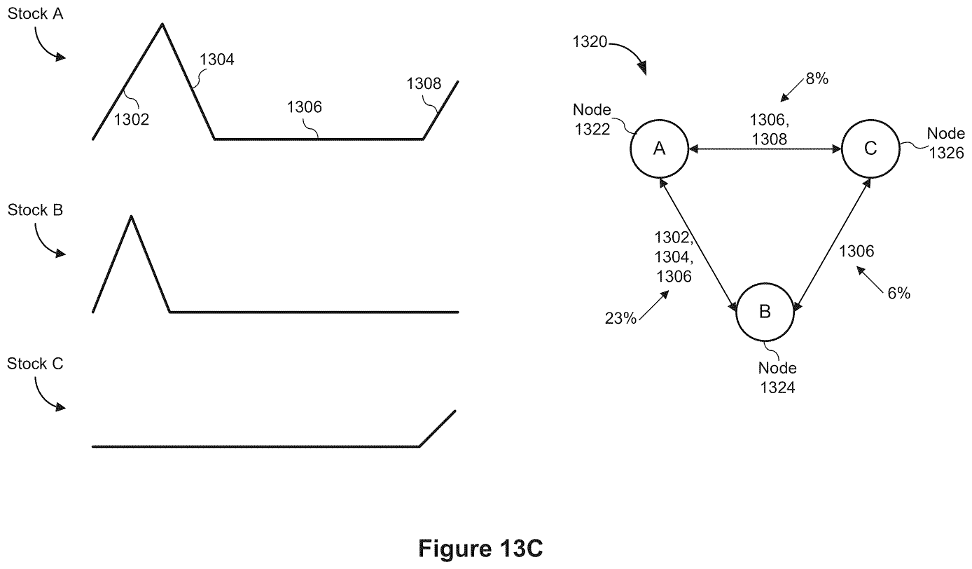

FIGS. 13A to 13C illustrate a process for generating a connected graph of shape data, in accordance with some embodiments.

The example of FIG. 13 depicts the stocks domain that includes stock prices over time. FIG. 13A illustrates segment-wise linearizations of three stocks, namely Stock A, Stock B, and Stock C. The segment-wise linearization of Stock A includes a first rising segment 1302, a falling segment 1304, a flat segment 1306, followed by a second rising segment 1308. Each of these segments has a slope, length, and position (see, e.g., discussion with reference to FIG. 10).

FIG. 13B illustrates generating a connected graph 1320 based on the segment-wise linearizations of Stocks A, B, and C, in accordance with some embodiments. The connected graph includes a node 1322 representing Stock A, a node 1324 representing Stock B, and a node 1326 representing Stock C. In some embodiments, a respective pair of nodes is connected by a respective edge. In some embodiments, a respective edge has a respective edge length that represents a pairwise similarity between the pair of two nodes connected by the edge. For example, FIG. 13B shows that Stock A and Stock B are similar because they both include a first rising segment 1302, a falling segment 1304, and a flat segment 1306. FIG. 13B also shows that Stock A and Stock C are similar because they both include a flat segment 1306 and a second rising segment 1308. FIG. 13B also shows that Stock B and Stock C are similar because they both include a flat segment 1306.

In some embodiments, a connected graph comprises at least 50 nodes, at least 100 nodes, at least 250 nodes, at least 500 nodes, at least 1000 nodes, at least 2500 nodes, at least 5000 nodes, at least 10,000 nodes, at least 25,000 nodes, at least 50,000 nodes, at least 100,000 nodes, at least 250,000 nodes, at least 500,000 nodes, at least 1 million nodes, at least 2.5 million nodes, at least 5 million nodes, at least 10 million nodes, at least 25 million nodes, at least 50 million nodes, at least 100 million nodes, at least 250 million nodes, at least 500 million nodes, or more nodes.

FIG. 13C illustrates that in some embodiments, a shape propensity (e.g., probability) (e.g., the values 7%, 8%, and 23% shown in FIG. 13C) can be calculated for a respective pair of nodes connected by a respective edge. In some embodiments, the connected graph 1320 is an ontological knowledge graph where the domain is the stock market, the nodes represent entities (e.g., stocks) and the edges represent relationships (e.g., shape relationships, stock price trends) between the nodes.

FIGS. 14A to 14F illustrate query refinement using cluster analysis, in accordance with some embodiments.

In accordance with some embodiments of the present disclosure, database(s) 350 include datasets (e.g., are datasets 351 and/or linearized datasets 352) that are organized into a plurality of data clusters according to data patterns in the datasets.

As described in FIG. 3B, database(s) 350 include machine learning database 138. Machine learning database 138 includes one or more models 372. In some embodiments, the one or more models 372 include one or more clustering models for clustering the datasets into data clusters. In some embodiments, the model 372 is an unsupervised clustering model. In some embodiments, the model is a supervised clustering model. Clustering algorithms suitable for use as models are described, for example, at pages 211-256 of Duda and Hart, Pattern Classification and Scene Analysis, 1973, John Wiley & Sons, Inc., New York, (hereinafter “Duda 1973”) which is hereby incorporated by reference in its entirety for all purposes. The clustering problem can be described as one of finding natural groupings in a dataset. To identify natural groupings, two issues can be addressed. First, a way to measure similarity (or dissimilarity) between two samples can be determined. This metric (e.g., similarity measure) can be used to ensure that the samples in one cluster are more like one another than they are to samples in other clusters. Second, a mechanism for partitioning the data into clusters using the similarity measure can be determined. One way to begin a clustering investigation can be to define a distance function and to compute the matrix of distances between all pairs of samples in a training dataset. If distance is a good measure of similarity, then the distance between reference entities in the same cluster can be significantly less than the distance between the reference entities in different clusters. However, clustering may not use a distance metric. For example, a nonmetric similarity function s(x, x′) can be used to compare two vectors x and x′. s(x, x′) can be a symmetric function whose value is large when x and x′ are somehow “similar.” Once a method for measuring “similarity” or “dissimilarity” between points in a dataset has been selected, clustering can use a criterion function that measures the clustering quality of any partition of the data. Partitions of the data set that extremize the criterion function can be used to cluster the data. Particular exemplary clustering techniques that can be used in the present disclosure can include, but are not limited to, hierarchical clustering (agglomerative clustering using a nearest-neighbor algorithm, farthest-neighbor algorithm, the average linkage algorithm, the centroid algorithm, or the sum-of-squares algorithm), k-means clustering, fuzzy k-means clustering algorithm, and Jarvis-Patrick clustering. In some embodiments, the clustering includes unsupervised clustering (e.g., with no preconceived number of clusters and/or no predetermination of cluster assignments).

FIG. 14A depicts an example of a dataset of stock data, where the different stocks are organized into data clusters using a hierarchical clustering algorithm. In some embodiments, the datasets can be organized into data clusters using a soft clustering algorithm, such as a Fuzzy C-Means (FCM) algorithm, soft k-means algorithm (e.g., Probabilistic K-Means), self-organizing maps (SOM) algorithm (with Fuzzy Memberships), and a possibilistic c-means (PCM) algorithm.

FIG. 14A shows that in some embodiments, the results of the hierarchical clustering can be visualized using a dendrogram 1402. FIG. 14A shows a sketch input 1404 that is received via user interface 110.

FIG. 14B illustrates that in some embodiments, the system (e.g., server system 130 or client device 102) determines, based on the shape of the sketch input 1404, that the sketch input 1404 likely belongs to branch 1406 (e.g., a higher-level hierarchy) of the dendrogram 1402.

FIG. 14C illustrates that in some embodiments, the system can identify a lower-level hierarchy 1408 (e.g., cluster) corresponding to the branch 1406. FIG. 14D shows the system causes display of representative curves 1410 (e.g., representative curve 1410-1 to 1410-3, representative data patterns) that are representative of all the sub-clusters at lower-level hierarchy 1408. In other words, the system refines the sketch input query by filtering the initial datasets to a subset of datasets whose data patterns match the shape (e.g., pattern) of the sketch input 1404, and provides the representative curves 1410 as options for a user to complete their sketch input query (e.g., auto completion).

In some embodiments, the system determines an even lower-level hierarchy 1412 corresponding to the branch 1406, and causes display of representative curves corresponding to this hierarchy. FIG. 14E illustrates. In this example, hierarchy 1412 is lower than hierarchy 1408 in FIG. 14D. The system causes display of representative curves 1414 (e.g., representative curve 1414-1 to 1414-7), that are representative of all the sub-clusters at the hierarchy 1412.

In accordance with some embodiments, the display of representative curves on the user interface 110, such as curves 1410 in FIG. 14D and curves 1414 in FIG. 14E, can guide a user by informing the user about data patterns that currently exist in the database(s) 350 when starting with the shape (e.g., data pattern, such as an “upward slope”) corresponding to sketch input 1404. If the sketch input 1404 were to be followed by one of the sketch paths indicated by any of the representative curves 1410 or representative curves 1414, the resulting data pattern would correspond to data that currently exists in the database(s) 350. On the other hand, if the sketch input 1404 were to be followed by a path (e.g., sketch or pattern) that does not match any of the representative curves 1410 or representative curves 1414, such as sketch input 1416 in FIG. 14F, it would indicate a divergence into a null set in database(s) 350 because the existing data in database(s) 350 do not have data patterns that match a shape profile having the combination of sketch input 1404 and sketch input 1416.

In some instances, when the system detects that a subsequent portion of the sketch input 1404 (e.g., sketch input 1416) does not match a sketch path corresponding to any of the representative curves (e.g., curves 1410 and 1414), the system generates an alert condition (e.g., via alert generation module 334) that includes the combined shape of the sketch inputs 1404 and 1416. This is illustrated in step 1420 of FIG. 14F. After generating the alert, the system can analyze data stream(s), as illustrated in step 1422 of FIG. 14F. In some embodiments, a data stream comprises a real-time or near real-time data stream. Input data 1426 from the data streams can generated and sent from various sources such as IoT devices, web applications, or social media platforms. In some embodiments, the system 130 includes a stream processing engine 1428 that is configured to analyze and act on the input data 1426. For example, the stream processing engine 1428 can filter, aggregate, transform, and/or enrich data in motion, ensuring that the data is ready for analytics 1430. Various techniques and methods can be applied to discover patterns and trends in the data, such as descriptive analytics, predictive analytics, and/or prescriptive analytics. In some embodiments, when the system determines that the data stream(s) include data having a pattern or distribution that matches a combined shape (e.g., pattern) of the sketch inputs 1404 and 1416, the system determines that the alert condition is satisfied and generates a workflow instruction and/or action, as illustrated in step 1424.

Accordingly, the disclosed sketch-based interface can not only search and analyze existing data but also interact with (e.g., analyze) real-time data streams. Users could sketch trends or patterns they anticipate or wish to track, and the system could dynamically adjust to monitor and alert users on these trends. If the data matches an anticipated trend, as described in FIG. 14F, an alert can be sent as a message or Slack push notification, for example.

Although FIGS. 14A to 14F illustrate filtering and refining sketch inputs by applying hierarchical clustering, it would be apparent to one of ordinary skill in the art that other clustering techniques would also be applicable. For example, in some embodiments, the system can implement “soft” clustering techniques (e.g., instead of hierarchical) where a data point can exist in multiple data clusters. For example, a downward slope is part of a “cliff” cluster and also part of a “bounce” cluster. In this example, the algorithm would then be modified to suggest autocompletions based on the degree to which a sketch belongs to the various clusters.

FIG. 14G illustrates another example of signal clustering, in accordance with some embodiments.

In some embodiments, in order to help users understand the major trend shapes already present in their data, the data can be clustered using the distance scoring described above, and then selected cluster representatives to illustrate the general shape trends to the user. Cluster representatives were the cluster medoids—the ‘central’ signals with the least average distance to all other cluster members. To implement this, the all×all signal:signal comparison matrix is used to perform agglomerative hierarchical clustering with Ward linkage to find groups of signals that share similar properties (see panels 1F.2 and 1G.2 of FIG. 3D). FIG. 14G shows hierarchical clustering of baby name popularity data with the different baby names clustered according to the four properties.

The top panel in FIG. 14G shows an agglomerative hierarchical clustering dendrogram sliced to define six clusters. The bottom left panel shows clustered baby name popularity data; dotted lines indicate the clusters' identity vis-a-vis the dendrogram. The bottom right panel shows medoid representatives for each cluster. The medoid is the signal with the lowest average distance from all other signals in the cluster. In some embodiments, in the user interface 110, medoids can be scaled according to their cluster size, conveying the size of the representative population.

Some embodiments use hierarchical clustering as this technique is particularly useful in cases where the number of clusters is not known in advance. The dendrogram produced by hierarchical clustering provides a representation of how signals relate to each other, revealing the gradual merging of similar signals at different levels of similarity. In some embodiments, the user interface 110 allows users to control the cluster level-of-detail by sliding up and down the clustering dendrogram.

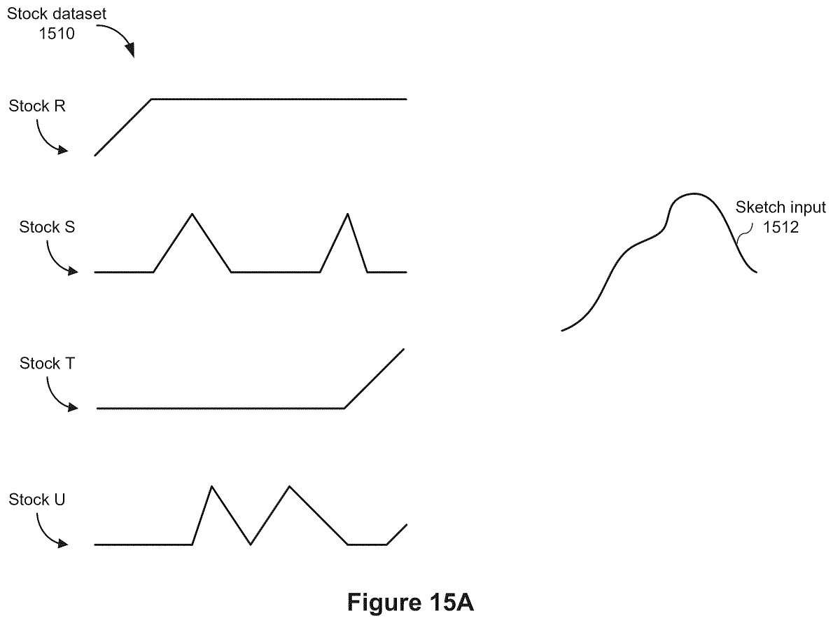

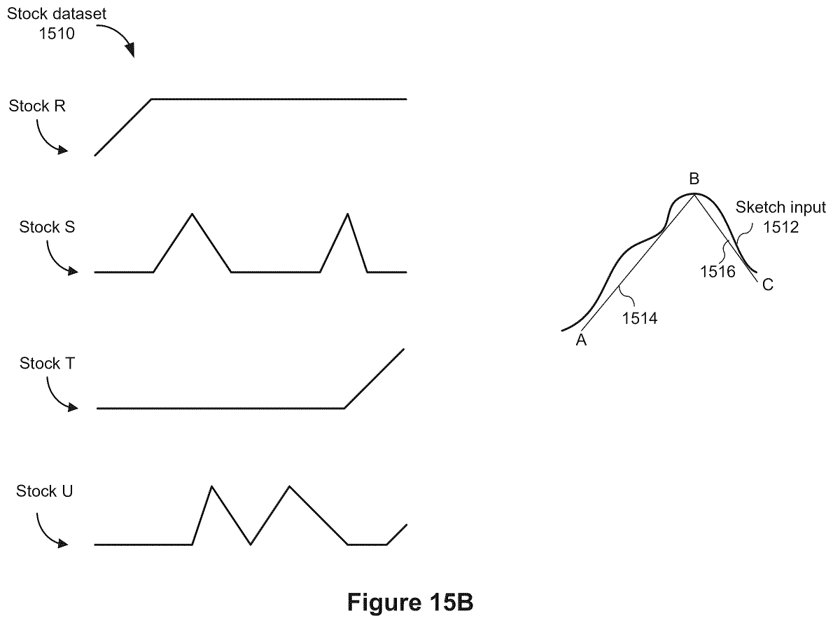

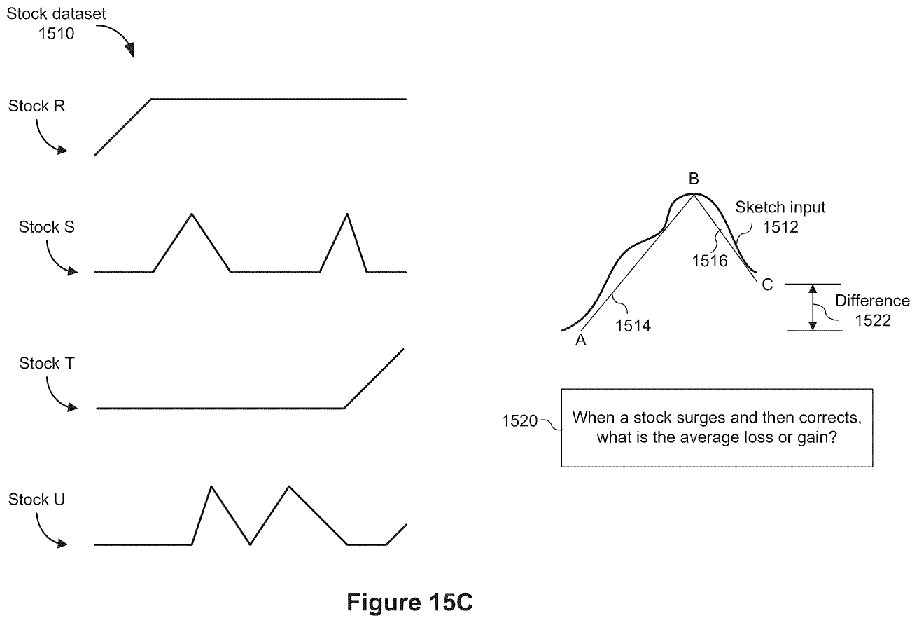

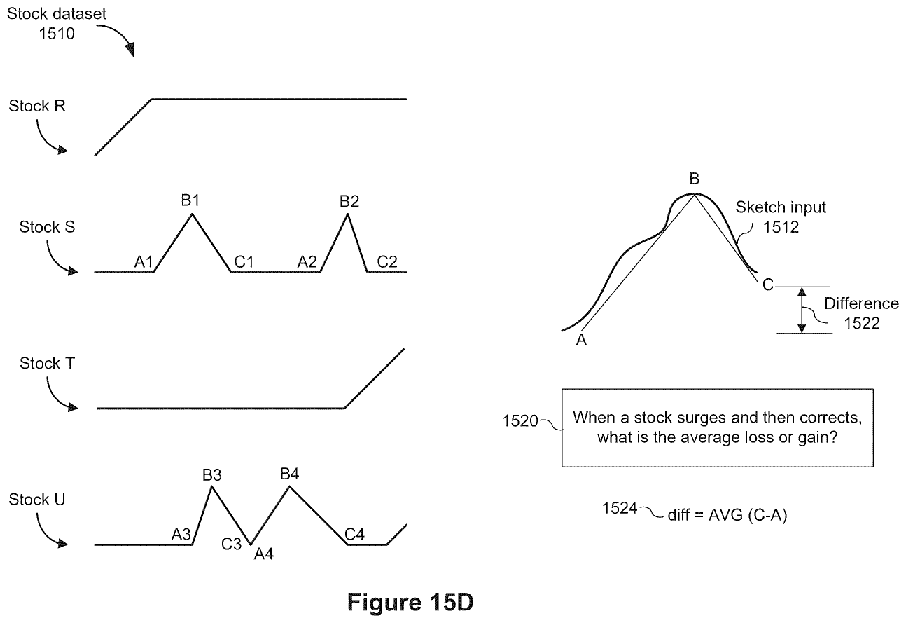

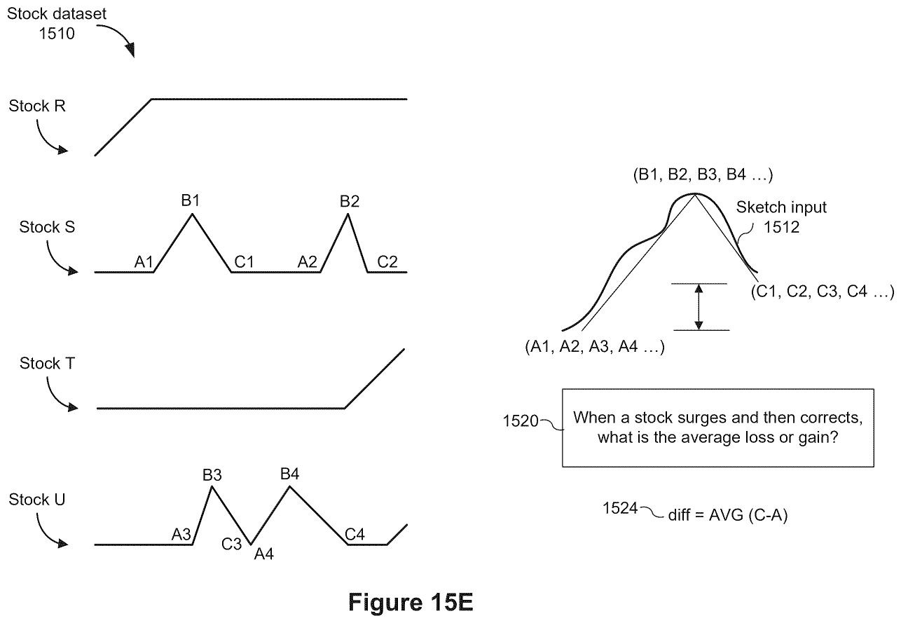

FIGS. 15A to 15E illustrate an abstract query analytics process, in accordance with some embodiments. The example of FIG. 15 has to do with a stock dataset 1510 that includes stock prices over time. FIG. 15A illustrates segment-wise linearizations of four stocks, namely Stock R, Stock S, Stock T, and Stock U. FIG. 15A also shows a sketch input 1512 for querying the stock dataset 1510 (e.g., to identify stocks whose stock prices match trend depicted by the sketch input 1512). FIG. 15B shows that the sketch input 1512 can be linearized into line segment AB (e.g., line segment 1514) and line segment BC (e.g., line segment 1516).

In FIG. 15C, the system receives an analytics query 1520. In this example, the user is interested to determine an average loss or gain when a stock surges and then corrects. In other words, the user is looking to determine an average of a difference between points C and A, indicated by difference 1522 in FIG. 15C.

In some embodiments, the shape (or pattern) defined by contiguous linear segments AB and BC in FIG. 15C can be used as a virtual pointer or proxy to identify stocks in the stock dataset with similar shapes or patterns. For example, FIG. 15D shows that Stock S includes (a) contiguous linear segments A1B1 and B1C1 and (b) contiguous linear segments A2B2 and B2C2, which are similar to the contiguous linear segments AB and BC corresponding to the sketch input 1512. FIG. 15D also shows that Stock U includes (c) contiguous linear segments A3B3 and B3C3 and (d) contiguous linear segments A4B4 and B4C4, which are similar to the contiguous linear segments AB and BC corresponding to the sketch input 1512. Thus, taking the average of the difference between C and A (i.e., diff=AVG (C-A), equation 1524) across all of those different stocks yields the answer to the query. This is illustrated in FIGS. 15E and 15F. Thus, shapes or patterns defined by line segments such as the contiguous linear segments AB and BC can be used as a proxy for larger and more complex sets of data.

FIGS. 16A to 16P are screenshots illustrating user interactions with the SketchQL user interface 110, in accordance with some embodiments. As discussed above with reference to FIGS. 5A to 5G, the SketchQL user interface 110 allows users to query and explore data patterns using an intuitive sketch-based input system.

In FIG. 16A, the user interface 110 displays an initial data visualization 1602 that depicts trends in their data. In this example, the trends represent daily generative AI usage (in minutes) over time, and the user is presented with the underlying data in a line chart format. In some embodiments, the visualization 1602 serves as the starting point for further interaction, where the user can explore and refine trends based on their specific analytical goals. In FIG. 16A, the user selects an option 1604 to “Add new sketch.”

FIG. 16B shows that in response to user selection of the option 1604, the user interface 110 displays sketch input dialog 520 that includes drawing canvas 522 where the user can begin to draw their desired trends or patterns. In FIG. 16B, the user selects a measure color 1606, corresponding to the measure “GAI usage (minutes)”, from the palette.

In FIG. 16C, the user sketches a desired data pattern (e.g., as sketch input or drawing input 1608) on the drawing canvas 522. The user can also add annotations to provide context or highlight key points, as discussed with reference to FIG. 5B. This feature enables the user to refine their query visually, specifying the data pattern (e.g., trend) the user wishes to track, such as a sharp rise or a decline in the data. The use of color helps to differentiate between different data measures.

In this example, the user would like to analyze the organization's AI usage from last year, where there are some groups that adopt AI quickly like a fad, and then the novelty fades, but then these groups find some real use cases and then adoption begins to rise again. The drawing input 1608 depicts a sketch showing such a trend. Imagine how hard it is to express such a trend in natural language, even in SQL. Having drawn the sketch, the user selects the “query” button 1610.

FIG. 16D shows that the system processes the input and returns the queried trends 1612 that match the drawn pattern. SketchQL uses the visual input to identify relevant data points, matching the user's sketch with the underlying dataset. Additionally, SketchQL saves the search (e.g., drawing input 1608) to sketch library 134, allowing the user to easily reuse previous queries in future analyses. FIG. 16D shows that the search query is shown as representation 1611 with corresponding shape 1613 matching the sketch input 1608.

In FIG. 16E, the user selects the “GAI & SAT” tab 1614 in the user interface 110. The user also selects the option 1604 to “Add new sketch.”

FIG. 16F illustrates that, in response to the user selection, the sketch input dialog 520 with the drawing canvas 522 are displayed on the user interface 110.

In FIG. 16G, the user selects color 1606 (e.g., blue), corresponding to the measure “GAI usage (minutes),” and inputs a drawing input 1616 representing those who tried AI but never picked it up again.

In FIG. 16H, the user selects color 1618 (e.g., orange), corresponding to the measure “Customer CSAT,” draws another sketch 1620 (e.g., drawing input) where Customer CSAT stayed flat or declined. The user selects the “query” button 1610. In response to this query, SketchQL processes these intricate patterns accurately, filtering and sorting the data (e.g., data visualizations) according to the complex query.

FIG. 16I shows that the user interface 110 displays a data visualization 1622 indicating that the GAI usage data and customer CSAT data of the Product Department match the patterns indicated in the drawing inputs 1616 and 1620. SketchQL also takes the user queries (e.g., drawing inputs 1616 and 1620) and saves it in the sketch library 134 as a cohort 1624 that the user can use in subsequent analysis. In some embodiments, the user can also query the same measure in multiple different ways that would then cause SketchQL to return multiple different sets of query results. The user can handle these results any way they would like. For example, the user can apply an “OR” operation to obtain a combined set with all members of both sets, or apply an “AND” operation to obtain only the members belonging to both sets.

FIG. 16I indicates user selection of the “Cohort” tab 1626 in the user interface 110. Here the user can compare the two cohorts—those who needed help to leverage AI (as reflected in data visualization 1628) and the everyone else (as reflected in data visualization 1630). In some embodiments, the cohort can be saved as a segment on data cloud and for use in other analytical applications. Now, the user would like to bring it to full circle, translating the sketch-driven analysis back to a natural language and passing through an AI Agent (e.g., models 372) to understand even further. In FIG. 16K, the user selects the “Tableau Agent” tab 1632 in the user interface 1632 and selects button 1634 to acknowledge that they understand the implications of using Tableau Agent.

In FIG. 16L, the user inputs a query 1638 (e.g., “Explain this trend”) in an input box 1636, to ask the AI agent to explain the data trends. FIG. 16M shows that in some embodiments, the AI agent paraphrases the user's query 1638 into a paraphrased query 1640 and provides an explanation 1642 of the data trends. In FIG. 16N, the user inputs a follow-up question 1644 (e.g., “Provide suggestions for possible strategies”) to the AI agent via the input box 1636. FIGS. 160 and 16P illustrate that the AI agent provides answers corresponding with strategic analysis suggesting how to transform the teams to drive more success, all powered by data and AI powered by human intuition. In summary, SketchQL turns data exploration and forecasting into an intuitive experience. It enables users to seamlessly uncover data stories and stay ahead of emerging trends, all with just a sketch.

In some embodiments, an example use case of SketchQL is trend discovery in business analytics. For example, a business analyst is working with a sales dataset and is interested in discovering any upward trends that correspond to promotional events. Instead of writing a query or using complex filters, the analyst sketches the shape of an upward spike in the canvas, representing a spike in sales. SketchQL analyzes the sketch and finds all the data points that match the drawn trend. The system highlights the periods during which these spikes occurred and presents them to the analyst.

In some embodiments, another example use case of SketchQL is the detection of seasonal patterns in climate data. For example, a meteorologist is analyzing temperature data over the course of several years and wants to identify seasonal temperature fluctuations. Instead of specifying the exact mathematical conditions of seasonal patterns in a query, the meteorologist simply sketches a pattern resembling a sine wave, representing seasonal cycles. SketchQL processes the sketch, finds data with similar cyclical behavior, and identifies the exact times and patterns in the dataset that match the sketched trend.

In some embodiments, another example use case of SketchQL is in forecasting stock market trends. For example, an investor wants to predict future trends in stock prices by sketching anticipated price movements. The investor can sketch a projection of a stock's price trend and ask the system to find historical patterns with similar trends. SketchQL interprets the sketch and compares it against historical stock data to identify matching patterns. If a match is found, the system can trigger notifications or updates on real-time data as trends unfold.

In some embodiments, another example use case of SketchQL is in education and data exploration. For example, in an educational setting, students can use SketchQL to learn about data trends interactively. For instance, a student might sketch the trend of increasing temperatures over time and query the system to find data on global warming. By drawing their hypotheses, students can better understand the underlying data patterns and visualize abstract concepts like growth rates, accelerations, or declines.

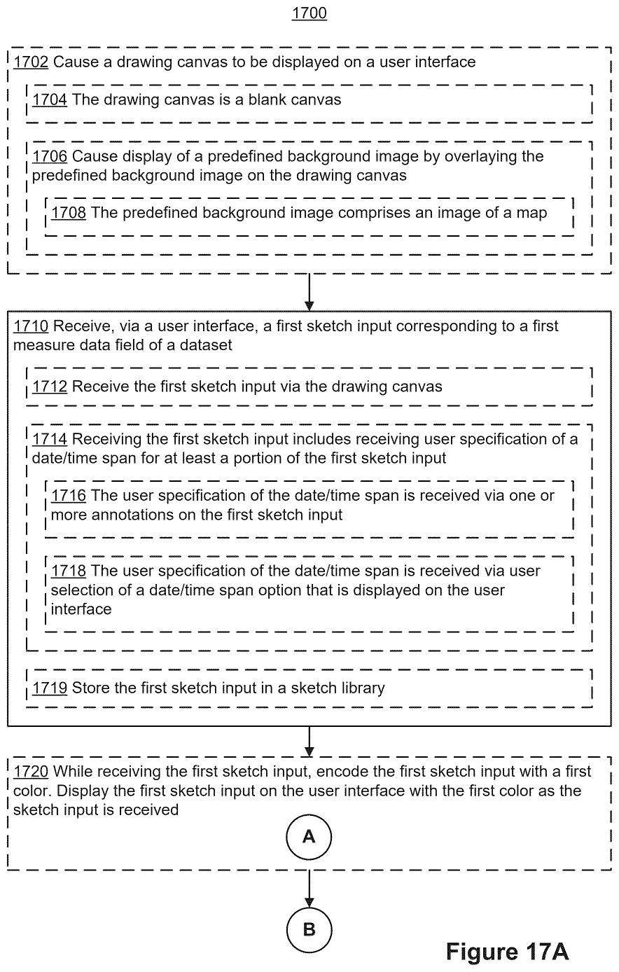

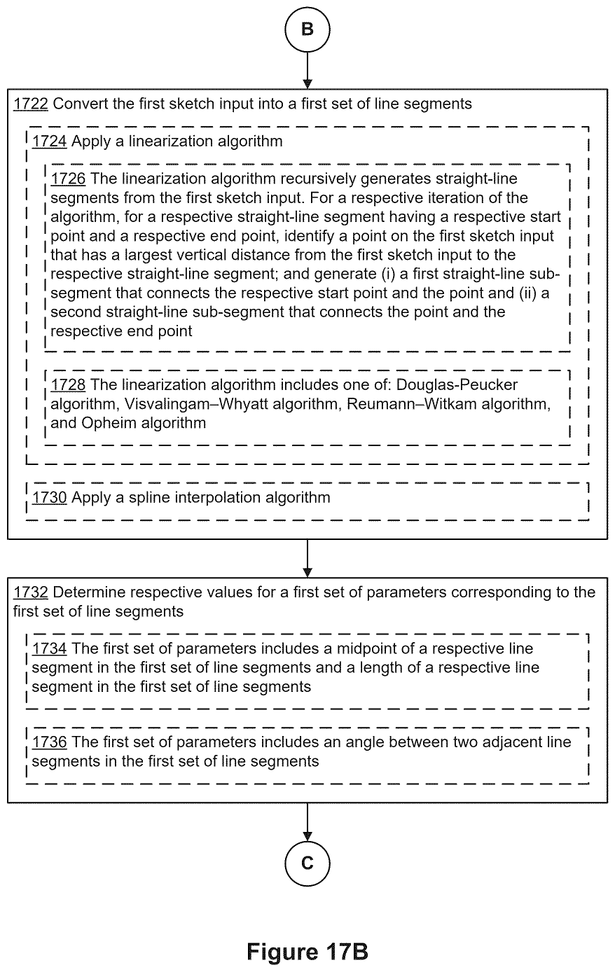

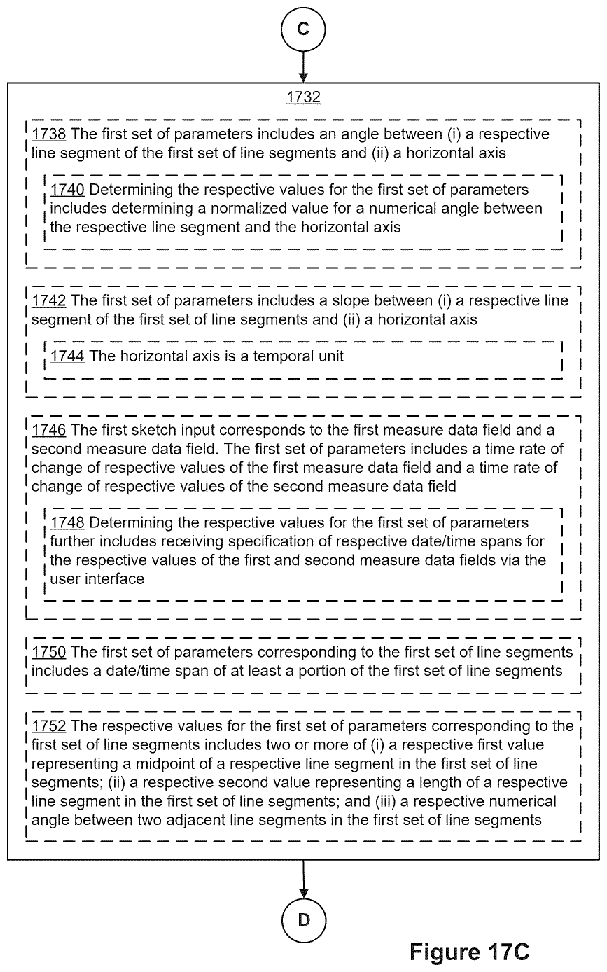

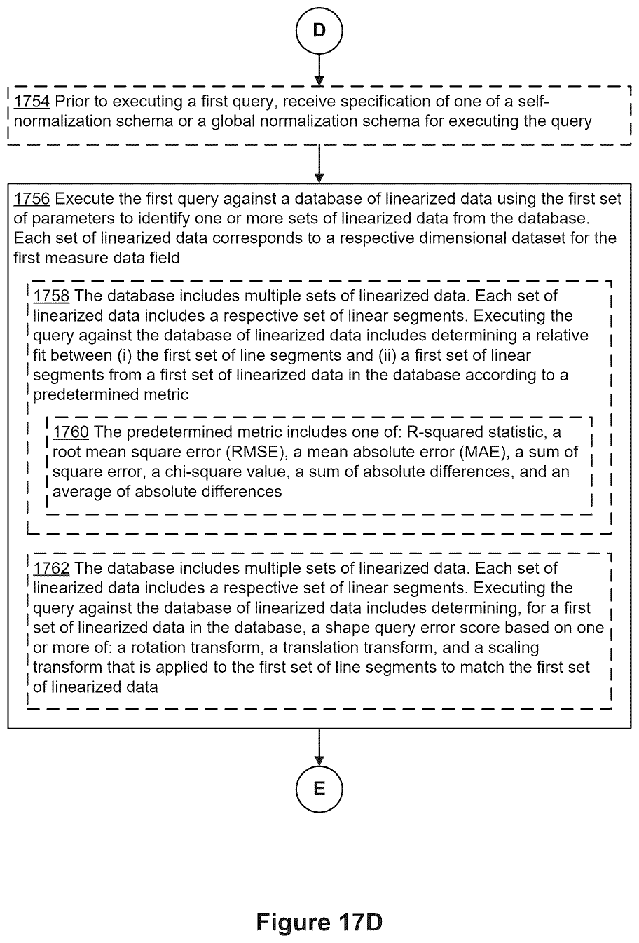

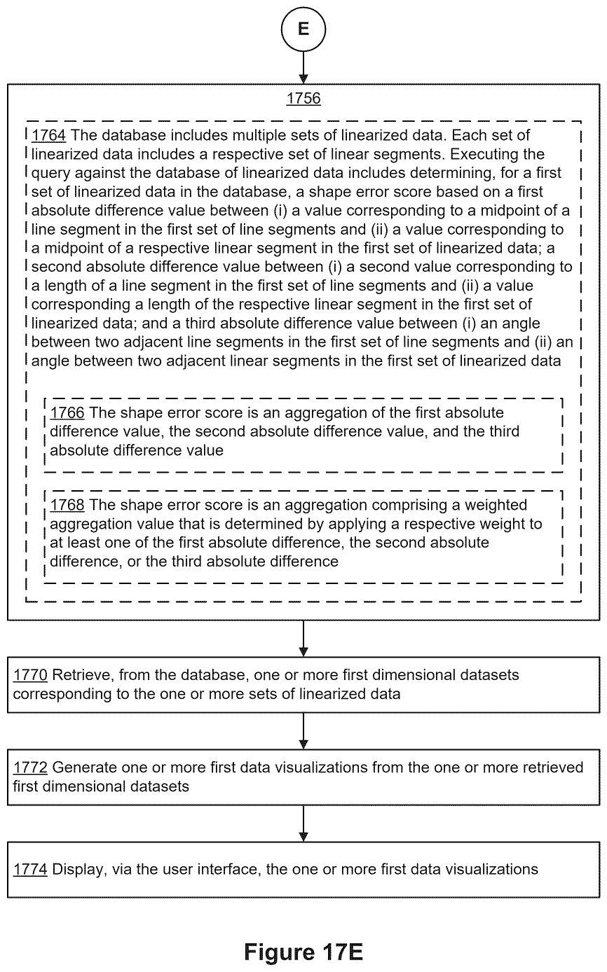

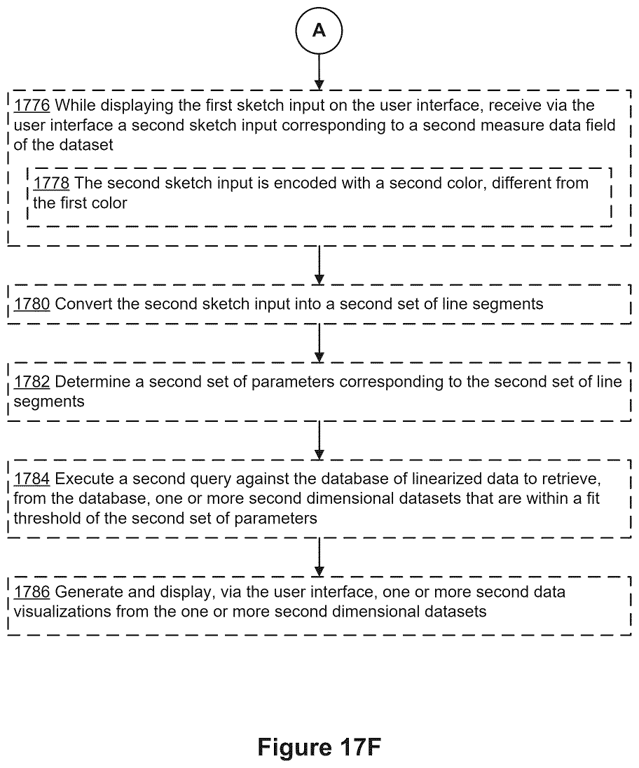

FIGS. 17A to 17F provide a flowchart of an example process for analyzing sketch input data, in accordance with some embodiments. The method 1700 is performed at a computer system (e.g., client device 102 or server system 130) that includes one or more processors (e.g., processor(s) 202 or processor(s) 302) and memory (e.g., memory 206 or memory 314). The memory stores one or more programs configured for execution by the one or more processors. In some embodiments, the operations shown in FIGS. 1, 4A to 4C, 4A to 4C, 5A to 5G, 6A to 6D, 7A to 7D, 8, 9, 10, 11, 12, 13A to 13C, 14A to 14F, 15A to 15E, and 16A to 16P correspond to instructions stored in the memory 206 or other non-transitory computer-readable storage medium. The computer-readable storage medium may include a magnetic or optical disk storage device, solid state storage devices such as Flash memory, or other non-volatile memory device or devices. In some embodiments, the instructions stored on the computer-readable storage medium include one or more of: source code, assembly language code, object code, or other instruction format that is interpreted by one or more processors. Some operations in the method 1700 may be combined with operations in the method 1800, method 1900, method 2000, method 2100, and/or method 2200, and/or the order of some operations may be changed.

In accordance with some embodiments the method 1700 enables users to interact with complex datasets by providing a sketch-based input mechanism, which allows for intuitive and visual representation of data exploration intent. This eliminates the need for users to rely on complex query languages or predefined keywords, making data analysis more accessible to non-technical users. By converting the sketch input into a set of line segments and determining corresponding parameters such as midpoints, lengths, and angles, the system translates freeform sketches into structured query terms. This structured representation facilitates precise matching against preprocessed datasets, ensuring accurate retrieval of relevant data trends. The execution of a query against a database of linearized data using the parameters derived from the sketch input allows for efficient identification of datasets that align with the sketched patterns. This approach leverages preprocessed linearized data, reducing computational overhead and improving query performance. The generation of data visualizations from the retrieved datasets provides users with immediate and actionable insights. Displaying these visualizations via the user interface ensures that users can quickly interpret the results of their queries, enhancing the overall efficiency of the data analysis process. The integration of sketch-based querying with data visualization bridges the gap between abstract user intent and concrete data patterns, enabling users to explore temporal or spatial trends in a more natural and expressive manner. This capability supports a wide range of applications, from business analytics to scientific research.

Referring to FIG. 17A, in some embodiments, the computer system, prior to receiving the first sketch input, displays (1702) a drawing canvas (e.g., drawing canvas 522) on a user interface (e.g., user interface 110).

In some embodiments, the drawing canvas is (1704) a blank canvas. this is illustrated in FIG. 5B. For example, a blank canvas is a canvas without any background image or graphic.

In some embodiments, displaying the drawing canvas further includes displaying (or causing display of) (1706) a predefined background image by overlaying the predefined background image on the drawing canvas.

In some embodiments, the predefined background image comprises (1708) an image of a map (e.g., map 550, FIG. 5D). For example, in some embodiments, providing an image of a map facilitates sketch inputs directed to geographical paths such as storm paths and flight paths. In some embodiments, the image of the map is encoded with geographical coordinates (e.g., longitudinal/latitudinal coordinates).

The computer system receives (1710), via a user interface, a first sketch input (e.g., sketch input 524, sketch input 552, or sketch input 1608) corresponding to a first measure data field of a dataset. In some embodiments, a sketch input is also referred to as a drawing input or a line contour. A measure data field (e.g., a measure field or simply a “measure”) is a quantitative variable that can be aggregated, summed, averaged, or otherwise mathematically calculated. Measures represent the numeric data used to perform calculations or analysis. As an example, a first measure field can be “number of babies born” or “profits of Company ABC.” In some embodiments, the first sketch input is a single continuous sketch. In some embodiments, the first sketch input includes two of more disconnected sketch segments. In some embodiments, the first sketch input corresponds to a first geographical data field of a dataset. For example, the geographical data field can be field such as “Location of Storm” or “Flight path of Flight ABC123.”

In some embodiments, the computer system receives (1712) the first sketch input is received via the drawing canvas. This is illustrated in, for example, FIGS. 5B, 5E, and 16C.

In some embodiments, receiving the first sketch input includes receiving (1714) user specification of a date/time span for at least a portion of the first sketch input.

In some embodiments, the user specification of the date/time span is received (1716) via one or more annotations on the first sketch input (e.g., via annotation palette 530 or text option 534 (text annotation)).

In some embodiments, the user specification of the date/time span is received (1718) via user selection of a date/time span option that is displayed on the user interface. For example, in some embodiments, the user interface 110 displays one or more timeline options such as a time span for the sketch, or a time difference (e.g., time delta) between two points on the sketch.

In some embodiments, the computer system stores (1719) (e.g., saves) the first sketch input in a sketch library (e.g., sketch library 134). For example, the sketch library features shapes from previous searches, which can be retrieved for future queries.

In some embodiments, the computer system, while receiving the first sketch input, encodes (1720) the first sketch input with a first color, where the first color represents the first measure data field. The computer system displays (or causes display of) the first sketch input on the user interface with the first color as the sketch input is received. This is illustrated in FIGS. 16B and 16C, which show user selection of measure color 1606 (e.g., blue), corresponding to the measure “GAI usage (minutes)”, and the sketch input 1608 is displayed with the same color (i.e., blue) as the measure color 1606.

Referring to FIG. 17B, the computer system converts (1722) the first sketch input into a first set of line segments.

In some embodiments converting the first sketch input into a first set of line segments includes (1724) applying a linearization algorithm (e.g., a linear interpolation algorithm). For example, in some embodiments, the first sketch input can be approximated as a set of polylines. Example linearization algorithms include Douglas-Peucker algorithm (or Ramer-Douglas-Peucker algorithm, which is an algorithm that decimates a curve composed of line segments to a similar curve with fewer points, by recursively dividing the line); Visvalingam-Whyatt algorithm (an algorithm that decimates a curve composed of line segments to a similar curve with fewer points. Given a polygonal chain (often called a polyline), the algorithm attempts to find a similar chain composed of fewer points.); Reumann-Witkam routine (an algorithm that simplifies polylines by removing points that fall outside a user-defined tolerance); Opheim routine (The O(n) Opheim routine is very similar to the Reumann-Witkam routine, and can be seen as a constrained version of that Reumann-Witkam routine. Opheim uses both a minimum and a maximum distance tolerance to constrain the search area), Lang simplification, or any other linear fit algorithms.

In some embodiments, the linearization algorithm recursively (1726) generates straight-line segments from the first sketch input. The computer system, for a respective iteration of the algorithm, for a respective straight-line segment having a respective start point and a respective end point, identifies a point on the first sketch input that has a largest vertical distance from the first sketch input to the respective straight-line segment; and generates (i) a first straight-line sub-segment that connects the respective start point and the point and (ii) a second straight-line sub-segment that connects the point and the respective end point. This is illustrated in FIGS. 7A to 7D. Normally, a linearization algorithm such as the Douglas-Peucker algorithm is applied by calculating a diagonal distance (e.g., the distance is a perpendicular distance from the straight-line segment to the curve). However, that perpendicular vector runs through two data fields (e.g., profit and time), which is not very intuitive. Some embodiments of the present disclosure apply the linearization algorithm by using a vertical vector. In other words, a vertical distance (corresponding to a change in measure value) is used in the linearization algorithm. As an example, suppose the first sketch input is a query for profit over time, the vertical vector has units of $ instead of some hybrid dimension.

In some embodiments, the linearization algorithm includes (1728) one of: Douglas-Peucker algorithm, Visvalingam-Whyatt algorithm, Reumann-Witkam algorithm, and Opheim algorithm.

In some embodiments, converting the first sketch input into a first set of line segments includes applying (1730) a spline interpolation algorithm (e.g., linear spline, quadratic spline, or cubic spline interpolation). For example, in some embodiments, the computer system converts the first sketch input into a set of data points and constructs (e.g., fits) multiple low-degree polynomials between adjacent points of the set of data points.

The computer system determines (1732) respective values (e.g., values 356) for a first set of parameters (e.g., set of parameters 354) corresponding to the first set of line segments.

In some embodiments, the first set of parameters (e.g., set of parameters 354) corresponding to the first set of line segments includes (1734) a midpoint of a respective line segment in the first set of line segments; and a length of a respective line segment in the first set of line segments.

In some embodiments, the first set of parameters (e.g., set of parameters 354) corresponding to the first set of line segments includes (1736) an angle between two adjacent line segments in the first set of line segments.

With continued reference to FIG. 17C, in some embodiments, the first set of parameters (e.g., set of parameters 354) corresponding to the first set of line segments includes (1738) an angle between (i) a respective line segment of the first set of line segments and (ii) a horizontal axis.

In some embodiments, determining the respective values (e.g., values 356) for the first set of parameters includes determining (1740) a normalized value for a numerical angle between the respective line segment and the horizontal axis. For example, the normalized value is a number between zero and one inclusive. In some embodiments, the normalized value is determined by dividing the numerical angle by 360 degrees. A slope of +45 degrees will have a normalized value of 0.125, whereas a slope of −90 degrees is equivalent to a slope of +270 degrees, and therefore will have a normalized value of 0.75.

In some embodiments, the first set of parameters (e.g., set of parameters 354) corresponding to the first set of line segments includes (1742) a slope (e.g., a gradient) between (i) a respective line segment of the first set of line segments and (ii) a horizontal axis.

In some embodiments, the horizontal axis is (1744) a temporal unit (e.g., has units of time, or date/time, is a time axis). In other words, the slope is the velocity of the measure.

In some embodiments, the first sketch input corresponds (1746) to the first measure data field and a second measure data field. The first set of parameters corresponding to the first set of line segments includes a time rate of change (e.g., time derivative, rate of change with respect to time, such as a velocity) of respective values of the first measure data field; and a time rate of change (e.g., time derivative, rate of change with respect to time, such as a velocity) of respective values of the second measure data field. For example, in some embodiments, the sketch input is a query for multiple measures. In one example, this is illustrated in FIG. 16H, which shows sketch input 1616 corresponding to the measure “GAI usage (minutes)” and sketch input 1620 corresponding to the measure “customer CSAT.” In another example, the first sketch input can be a sketch to query a storm path, where the first measure data field is longitude, and the second measure data field is latitude. In yet another example, the first sketch input can be a sketch to query a flight path, where the measure fields are longitude, latitude, and altitude. In some embodiments, the first set of parameters includes angles between all possible pairs of measures.

In some embodiments, determining the respective values (e.g., values 356) for the first set of parameters (e.g., set of parameters 354) includes receiving (1748) specification of respective date/time spans for the respective values of the first and second measure data fields via the user interface. For example, in some embodiments, the user interface 110 displays timeline options that a user can select. In some embodiments, the computer system receives annotations of time/time ranges or a time delta between two points of the sketch input.

In some embodiments, the first set of parameters corresponding to the first set of line segments includes (1750) a date/time span of at least a portion of the first set of line segments. For example, the date/time span can indicate that “this data point happened on Mar. 3, 1962” or “this corresponds to a time period in January 1963.” In some embodiments, indicating the date/time span enables the computer system to compare curves and establish that a curve that happened in 1963 is “closer” along the time axis than a curve in, say, the year 1995.

In some embodiments, the respective values for the first set of parameters corresponding to the first set of line segments includes (1752) two or more of: a respective first value (e.g., a normalized value from 0 to 1) representing a midpoint of a respective line segment in the first set of line segments; a respective second value (e.g., a normalized value from 0 to 1) representing a length of a respective line segment in the first set of line segments; and a respective numerical angle (e.g., a numerical value) between two adjacent line segments in the first set of line segments.

Referring to FIG. 17D, in some embodiments, prior to executing a first query (e.g., search query), the computer system receives (1754) specification of one of a self-normalization schema or a global normalization schema for executing the query. For example, in some embodiments, the self-normalization schema or a global normalization schema are expressed as Boolean values, where a value of “0” represents the self-normalization schema and a value of “1” represents the global normalization schema, or vice versa. The Boolean value will be sent to the backend and causes the query to be run against either the self or global normalized points, angles, and lengths.

The computer system executes (1756) the first query against a database (e.g., database(s) 350) of linearized data using the first set of parameters to identify one or more sets of linearized data from the database, each set of linearized data corresponding to a respective dimensional dataset for the first measure data field. In some embodiments, the database includes multiple line segment sets. A dimension is a categorical variable that describes the attributes or characteristics of the data. Dimensions are typically used to segment, filter, or group data for analysis. In some embodiments, each set of linearized data corresponds to a respective value of a dimensional data field for the first measure field. Using the example of baby name popularity over time, where the dimensions are ‘Name’ and ‘Date,’ and the measure is ‘Popularity’, and the dimension ‘Name’ has values John, Mary, and James, a first set of linearized data can be the popularity of the name “John” over time and the second set of linearized data can be the popularity of the name “Mary” over time, where each dimensional dataset has a respective dimension level of detail for the first measure field. In some embodiments, data in the database is generated on-the-fly. In some embodiments, the data in the database is pre-processed.

In some embodiments, the database includes (1758) multiple sets of linearized data. Each set of linearized data includes a respective set of linear segments. Executing the query against the database of linearized data includes determining a relative fit between (i) the first set of line segments and (ii) a first set of linear segments from a first set of linearized data in the database according to a predetermined metric.

In some embodiments, the predetermined metric includes (1760) one of: R-squared statistic, a root mean square error (RMSE), a mean absolute error (MAE), a sum of square error, a chi-square value, a sum of absolute differences, and an average of absolute differences.

In some embodiments, the database includes (1762) multiple sets of linearized data. Each set of linearized data including a set of linear segments. Executing the query against the database of linearized data using the first set of parameters includes determining, for a first set of linearized data in the database, a shape query error score based on one or more of: a rotation transform, a translation transform, and a scaling transform that is applied to the first plurality of line segments to match the first set of line segments.

Referring to FIG. 17E, in some embodiments, the database includes (1764) multiple sets of linearized data, each set of linearized data including a set of linear segments. Executing the query against the database of linearized data using the first set of parameters includes determining, for a first set of linearized data in the database, a shape error score based on a first absolute difference value (i.e., a zero or positive value) between (i) a value corresponding to a midpoint of a line segment in the first set of line segments and (ii) a value corresponding to a midpoint of a respective linear segment in the first set of linearized data; a second absolute difference value (i.e., a zero or positive value) between (i) a second value corresponding to a length of a line segment in the first set of line segments and (ii) a value corresponding a length of the respective linear segment in the first set of linearized data; and a third absolute difference value (i.e., a zero or positive value) between (i) an angle between two adjacent line segments in the first set of line segments and (ii) an angle between two adjacent linear segments in the first set of linearized data. For example, if the sketch exactly matched the data, then all midpoints, lengths, and angles would be the same and the difference would be zero—a perfect match. Anything less than this perfection will show differences in those measurements. Shapes that are very similar will have only slight differences whereas shapes that are very different will have large differences.

In some embodiments, the shape error score is (1766) an aggregation of the first absolute difference value, the second absolute difference value, and the third absolute difference value.

In some embodiments, the shape error score is (1768) an aggregation comprising a weighted aggregation value that is determined by applying a respective weight (e.g., a scalar value) to at least one of the first absolute difference value, the second first absolute difference value, or the third absolute difference value.

The computer system retrieves (1770), from the database, one or more first dimensional datasets (e.g., data from the one or more first dimensional datasets) corresponding to the one or more sets of linearized data.

The computer system generates (1772) one or more first data visualizations from the one or more retrieved first dimensional datasets. This is illustrated in, for example, FIGS. 16D and 161.

The computer system displays (1774) (or causes display of), via the user interface, the one or more first data visualizations. This is illustrated in, for example, FIGS. 16D and 161.

With continued reference to FIG. 17F, in some embodiments, the computer system, while displaying the first sketch input on the user interface, receives (1776) via the user interface a second sketch input corresponding to a second measure data field of the dataset. This is illustrated in FIG. 16H.

In some embodiments, the second sketch input is (1778) encoded with a second color, different from the first color. For example, FIG. 16H shows that the first sketch input 1616 corresponding to the measure “GAI usage (minutes)” is encoded in the color blue and second sketch input 1620 corresponding to the measure “customer CSAT” is encoded in the color orange.

In some embodiments, the computer system converts (1780) the second sketch input into a second set of line segments.

In some embodiments, the computer system determines (1782) a second set of parameters corresponding to the second set of line segments.

In some embodiments, the computer system executes (1784) a second query against the database of linearized data to retrieve, from the database, one or more second dimensional datasets that are within a fit threshold of the second set of parameters.

In some embodiments, the computer system generates and displays (1786) (or causes display of), via the user interface, one or more second data visualizations from the one or more second dimensional datasets. This is illustrated in FIG. 16H.

Although FIGS. 17A to 17F illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

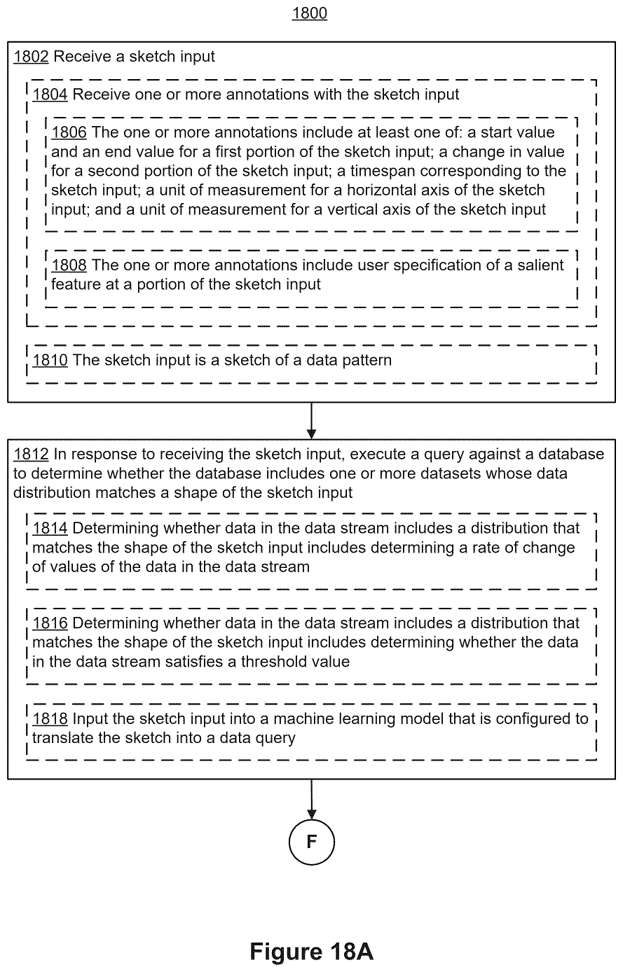

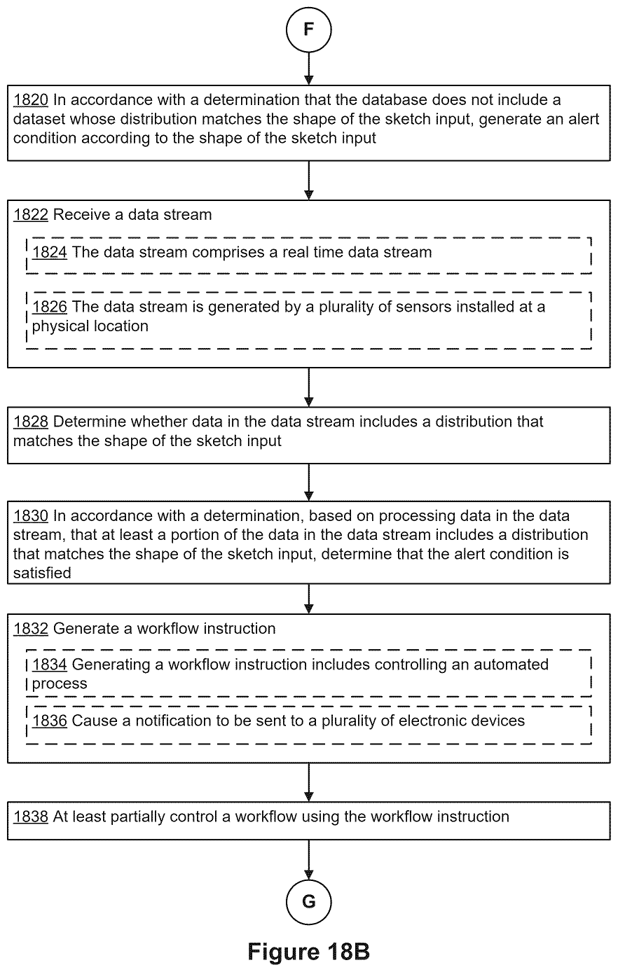

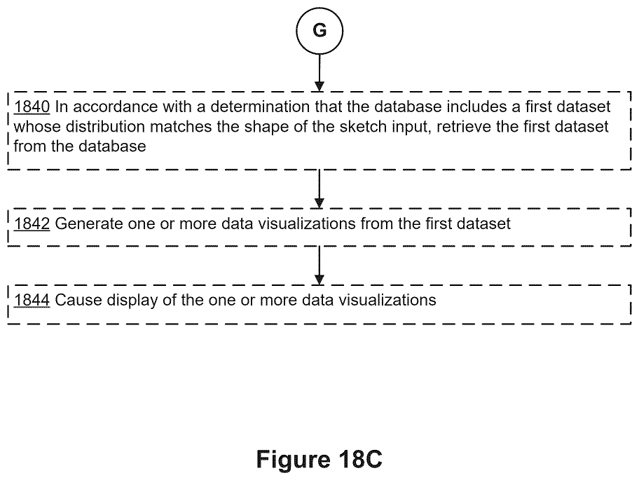

FIGS. 18A to 18C provide a flowchart of an example process for generated automated workflows, in accordance with some embodiments. The method 1800 is performed at a computer system (e.g., client device 102 or server system 130) that includes one or more processors (e.g., processor(s) 202 or processor(s) 302) and memory (e.g., memory 206 or memory 314). The memory stores one or more programs configured for execution by the one or more processors. In some embodiments, the operations shown in FIGS. 1, 4A to 4C, 4A to 4C, 5A to 5G, 6A to 6D, 7A to 7D, 8, 9, 10, 11, 12, 13A to 13C, 14A to 14F, 15A to 15E, and 16A to 16P correspond to instructions stored in the memory 206 or other non-transitory computer-readable storage medium. The computer-readable storage medium may include a magnetic or optical disk storage device, solid state storage devices such as Flash memory, or other non-volatile memory device or devices. In some embodiments, the instructions stored on the computer-readable storage medium include one or more of: source code, assembly language code, object code, or other instruction format that is interpreted by one or more processors. Some operations in the method 1800 may be combined with operations in the method 1700, method 1900, method 2000, method 2100, and/or method 2200, and/or the order of some operations may be changed.

In accordance with some embodiments, method 1800 converts an imprecise, freeform sketch into a compact, machine-actionable representation that a computer system can evaluate once against historical data, and then monitor efficiently against incoming data streams to drive automated control. For example, upon receiving the sketch input, the system parameterizes the sketch shape (e.g., as line segments with associated midpoints, lengths, angles, slopes, and time context) and executes a query (e.g., a single query) against a database of linearized datasets. This initial matching step produces a deterministic outcome, i.e., either a set of matches or a formalized “alert condition” if no matches exist. In some embodiments, the alert condition is a compact shape descriptor derived from the sketch that can be used for subsequent high-throughput stream comparisons. This conversion reduces the problem from continuous ad hoc visual interpretation to repeated numeric comparisons against normalized shape parameters, which decreases CPU cycles and memory bandwidth when applied to both historical and streaming data. When the database lacks a match and the system generates the alert condition, the computer transitions from a batch query mode to an event-driven monitoring mode for live data streams. As new data arrives, the system computes distribution and rate-of-change metrics, and compares them to the precomputed shape descriptor of the alert condition. Because the alert is defined in terms of normalized, bounded parameters, the stream-processing component can perform lightweight per-record or per-window comparisons, benefiting from early-exit pruning and threshold evaluation. This improves latency and throughput under real-time constraints, enabling timely detection of shape-conforming events and reducing false positives relative to simple threshold-only triggers. Upon detection of a shape match in the data stream, the system deterministically signals satisfaction of the alert and generates a workflow instruction. Integrating shape detection with workflow orchestration produces a direct technical advantage: it shortens the control loop between data observation and system action. By emitting machine-readable control signals, the system can at least partially automate downstream processes (e.g., notifications, device state changes, or task execution) without requiring a human-in-the-loop review for every event, thereby reducing interaction overhead and variability.

In accordance with some embodiments, these steps disclosed in method 1800 improve the functioning of the computer system by (i) translating high-dimensional, temporal data comparison into efficient operations over normalized shape parameters, reducing computational overhead for both historical queries and stream monitoring; (ii) enabling real-time, event-driven detection of complex patterns that are difficult to express as static thresholds, improving precision and recall of alerts; (iii) decreasing end-to-end latency from pattern occurrence to action through automated workflow generation, which results in faster, more consistent system responses; and (iv) providing a scalable mechanism to specify and reuse shape-based alert conditions, which lowers repeated query costs and supports high-volume data streams.

Referring to FIG. 18A, the computer system receives (1802) a sketch input. This is illustrated, for example, by sketch input 524, sketch input 552, or sketch input 1608. For example, in some embodiments, the sketch input is received with a user interface (e.g., user interface module 110) of the computer system. In some embodiments, the sketch input is received via a user interface (e.g., user interface 110) of an electronic device that is communicative coupled to the computer system.

In some embodiments, the computer system receives (1804) one or more annotations with the sketch input (e.g., via annotation palette 530 or as text annotation via text option 534) (e.g., annotations as illustrated in FIG. 3C). The annotations can include written notes or labels added to explain details of the sketch input, or indications of salient portions (e.g., important landmark portions) of the sketch. In some embodiments, the annotations can be interpreted via interpretation module 333, and can be used to provide context or highlight key points.

In some embodiments, the one or more annotations include (1806) at least one of: a start value and an end value (or a range of values) for a first portion of the sketch input (e.g., in both x-axis and y-axis; such as spike occurs within an hour); a change in value for a second portion of the sketch input; a timespan of the sketch input (the entire sketch input); a unit of measurement (e.g., hour or month, meter, mass) for a horizontal axis of the sketch input; and a unit of measurement (e.g., count, amount, degrees Celsius) for a vertical axis of the sketch input.

In some embodiments, the one or more annotations include (1808) user specification of a salient feature (e.g., noticeable characteristic) at a portion of the sketch input. For example, the salient feature can be a sudden rise or a sharp drop at the portion of the sketch input.

In some embodiments, the sketch input comprises (1810) a data pattern. For example, in some embodiments, the sketch input is a data pattern or a data trend that the user wishes to monitor. In some embodiments, the sketch input is a geographical data pattern. In some embodiments, the sketch input comprises a complex data pattern. For example, in accordance with some embodiments of the present disclosure, complex data patterns that may be difficult to express through traditional text queries can be expressed through a sketch.

The computer system, in response to receiving the sketch input, executes (1812) a query against a database (e.g., database(s) 350) to determine whether the database includes one or more datasets whose data distribution matches a shape of the sketch input. For example, in some embodiments, executing the query against the database includes determining whether the database includes one or more datasets that, when visualized, comprise a shape, pattern, and/or data distribution that matches a first shape of the sketch input. In some embodiments, the database comprises a database of linearized data. Executing the query against the database includes converting the sketch input into a set of line segments, determining respective values for a first set of parameters corresponding to the first set of line segments, and executing the query against the database of linearized data using the set of parameters to identify one or more sets of linearized data from the database. Details of these processes are described in method 1700, and are not repeated here for the sake of brevity.

In some embodiments, determining whether data in the data stream includes a distribution that matches the shape of the sketch input includes determining (1814) a rate of change of values of the data in the data stream.

In some embodiments, determining whether data in the data stream includes a distribution that matches the shape of the sketch input includes determining (1816) whether the data in the data stream satisfies a threshold value.

In some embodiments, executing the query against the database includes inputting (1818) the sketch input into a machine learning model (e.g., models 372) that is configured to translate the sketch into a data query.

With continued reference to FIG. 18B, the computer system, in accordance with a determination that the database does not include a dataset whose distribution matches the shape of the sketch input, generates (1820) (e.g., adds or sets) an alert condition according to the shape of the sketch input. In some embodiments, the computer system stores the alert on the computer system (e.g., in alerts database 140).

The computer system receives (1822) a data stream.

In some embodiments, the data stream comprises (1824) a real time data stream.

In some embodiments, the data stream is generated (1826) by a plurality of sensors installed at a physical location (e.g., physical structure 160). For example, the sensors can include surveillance cameras 162, hazard detection units 164, thermostats 166, or any other types of sensors that are capable of being installed at a physical location.

The computer system determines (1828) whether data in the data stream includes a distribution that matches the shape of the sketch input.

The computer system, in accordance with a determination (1830), based on processing data in the data stream (e.g., processing the data as it is received), that at least a portion of the data in the data stream includes a distribution that matches the shape of the sketch input (e.g., within a threshold), determines that the alert condition is satisfied.

The computer system generates (1832) a workflow instruction.

In some embodiments, generating a workflow instruction includes controlling (1834) an automated process, such as causing a system to power down (e.g., shut down) or putting a system in a standby mode.

In some embodiments, generating the workflow instruction includes causing (1836) a notification to be sent to a plurality of electronic devices (e.g., as a message or a Slack push notification).

The computer system at least partially controls (1838) a workflow using the workflow instruction.

Referring to FIG. 18C, in some embodiments, the computer system, in accordance with a determination (1840) that the database includes a first dataset whose distribution matches the shape of the sketch input: retrieves the first dataset from the database; generates (1842) one or more data visualizations from the first dataset; and causes (1844) display of the one or more data visualizations.

Although FIGS. 18A to 18C illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

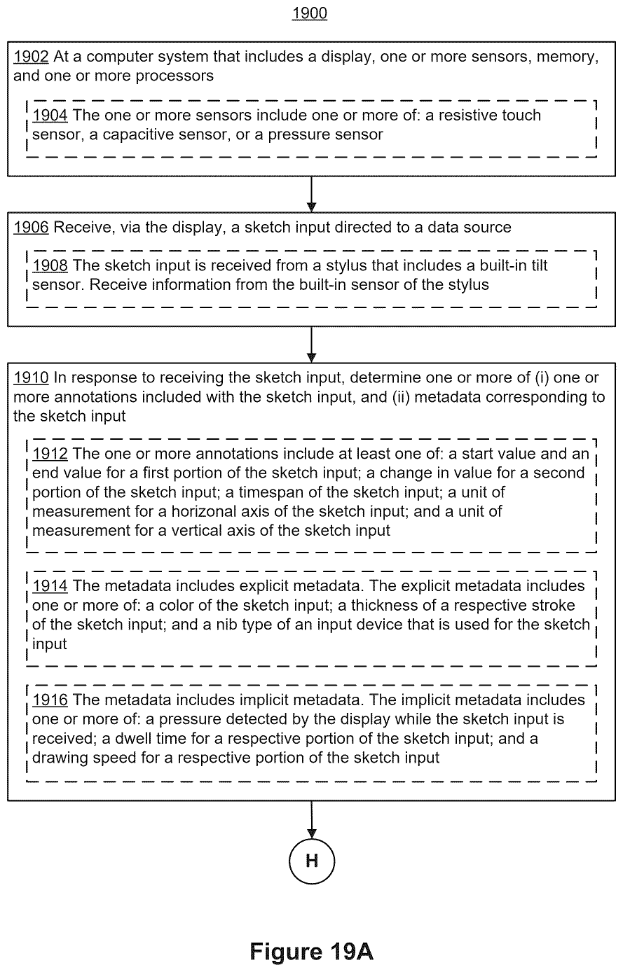

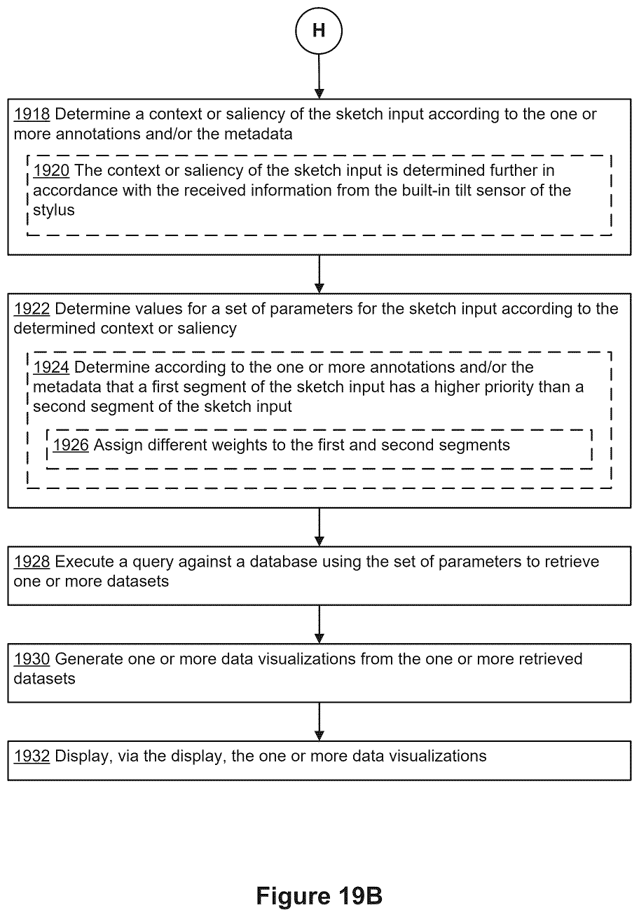

FIGS. 19A and 19B provide a flowchart of an example process for analyzing sketch input data, in accordance with some embodiments. The method 1900 is performed at a computer system (e.g., client device 102 or server system 130) that includes one or more processors (e.g., processor(s) 202 or processor(s) 302) and memory (e.g., memory 206 or memory 314). The memory stores one or more programs configured for execution by the one or more processors. In some embodiments, the operations shown in FIGS. 1, 4A to 4C, 4A to 4C, 5A to 5G, 6A to 6D, 7A to 7D, 8, 9, 10, 11, 12, 13A to 13C, 14A to 14F, 15A to 15E, and 16A to 16P correspond to instructions stored in the memory 206 or other non-transitory computer-readable storage medium. The computer-readable storage medium may include a magnetic or optical disk storage device, solid state storage devices such as Flash memory, or other non-volatile memory device or devices. In some embodiments, the instructions stored on the computer-readable storage medium include one or more of: source code, assembly language code, object code, or other instruction format that is interpreted by one or more processors. Some operations in the method 1900 may be combined with operations in the method 1700, method 1800, method 2000, method 2100, and/or method 2200, and/or the order of some operations may be changed.

In accordance with some embodiments, method 1900 produces a concrete improvement in how the computer system captures intent, searches data, and renders results by transforming a noisy, multimodal sketch into a compact, saliency-weighted numeric description that the machine can process efficiently. When the computer system receives a drawing input from a user via a display, the computer system does not transmit raw ink paths and high-frequency sensor streams. Instead, it fuses annotations with explicit and implicit metadata—such as color, stroke thickness, nib type, pressure, dwell time, drawing speed, and stylus tilt—to infer context and segment saliency. The computer system then converts the sketch into bounded parameters, including per-segment midpoints, lengths, angles, slopes, and time spans, with weights that reflect which parts of the sketch matter most to the user. This saliency-aware parameterization yields multiple technical benefits. First, it compresses high-entropy input into a small, structured descriptor, reducing network payload and accelerating server-side processing. Second, the weighted parameters enable early pruning of poor candidates in the database, so the system performs fewer full comparisons, consumes fewer CPU cycles and less memory bandwidth, and delivers predictable, lower latency during interactive queries. Third, by adapting matching tolerances based on captured signals (for example, treating high-pressure or slow strokes as tighter constraints and light or fast strokes as looser constraints), the system becomes robust to drawing imprecision, improving precision and recall while reducing false positives and negatives.

In some embodiments, because the backend operates on normalized, bounded features with consistent weighting, the computer system can rank results deterministically and return relevant matches in a single pass, which shortens time to first meaningful visualization and reduces the number of user re-queries. The initial results more closely reflect the user's intended pattern, so the interface avoids unnecessary re-render cycles and round-trips. Overall, these mechanisms improve system robustness and scalability across large datasets and many concurrent users by limiting exhaustive comparisons and leveraging efficient, parametric matching. In sum, the approach enhances the functioning of the computer system by enabling faster, more accurate, and resource-efficient querying and visualization driven by saliency-aware, multimodal intent capture.

Referring to FIG. 19A, the method 1900 is performed at a computer system (e.g., client device 102 or server system 130). The compute system includes a display (e.g., display 212 or display 308), one or more sensors (e.g., built-in sensors 284), memory, and one or more processors. In some embodiments, the display comprises a touch-sensitive display. For example, in some embodiments, the display 212 is a capacitive touchscreen that is configured to detect touch by sensing changes in an electric field. In some embodiments, the display 212 comprises a resistive touchscreen that is configured to detect touch via pressure transducers 286 when a physical pressure applied to the display, as described with reference to FIG. 4A.

In some embodiments, the one or more sensors include (1904) one or more of: a resistive touch sensor (e.g., touch sensor 288), a capacitive sensor (e.g., capacitive sensor 290), or a pressure sensor (e.g., pressure transducer 286).

The computer system receives (1906), via the display, a sketch input directed to a data source.

In some embodiments, the drawing input is received (1908) from a stylus (e.g., stylus 404) that includes a built-in tilt sensor (e.g., a gyroscope or an accelerometer, that can measure the orientation of the stylus in 3D space). In some embodiments, the computer system receives information from the built-in sensor of the stylus.

The computer system, in response to receiving the sketch input, determines (1910) one or more of (i) one or more annotations included with the sketch input, and (ii) metadata corresponding to the sketch input.

In some embodiments, the one or more annotations include (1912) at least one of: a start value and an end value (or a range of values) for a first portion of the sketch input (e.g., in both x-axis and y-axis; such as spike occurs within an hour); a change in value for a second portion of the sketch input; a timespan of the sketch input (the entire sketch input); a unit of measurement (e.g., hour or month, meter, mass) for a horizonal axis of the sketch input; and a unit of measurement (e.g., count, currency, degrees Celsius) for a vertical axis of the sketch input.

In some embodiments, the metadata includes (1914) explicit metadata. The explicit metadata includes one or more of: a color of the sketch input (e.g., color 434); a thickness of a respective stroke (e.g., portion) of the sketch input; and a nib type (e.g., nib type 432) (e.g., extra fine, fine, medium, broad, italic, stub, and oblique) of an input device that is used for the drawing input. For example, in some embodiments, an extra fine or a fine nib type (which produces fine lines) can be used to convey precision of the sketch shape, whereas using a broad nib type may convey an importance of the shape.

In some embodiments, the metadata includes (1916) implicit metadata. The implicit metadata includes one or more of: a pressure detected by the display while the sketch input is received; a dwell time for a respective portion of the sketch input; and a drawing speed for a respective portion of the sketch input (e.g., a speed at which a respective portion of the sketch input is drawn). For example, in some embodiments, the display comprises a pressure sensitive display screen that is configured to register how hard a user presses (on the user's finger or on an input device) while creating the sketch input. In some embodiments, intent is inferred depending on how hard the user presses on the screen, or enables finer control over interactions. In some embodiments, the relative speed pen can be used as a mental map of the speed of the query dataset. For example, in the case of the querying a storm path, the computing device can receive a sketch input where different portions are sketched with different pen speeds, which are indicative of a relative speeds of storm path as a storm traverses different geographical regions corresponding of the map.

Referring to FIG. 19B, the computer system determines (1918) a context or saliency of the sketch input according to the one or more annotations and/or the metadata.

In some embodiments, the computer system determines (1920) the context or saliency of the sketch input further in accordance with the received information from the built-in tilt sensor of the stylus. For example, ins some embodiments, the computer system is configured to receive information from the stylus about its tilt angle and applies this data to adjust line thickness or other drawing parameters based on the tilt.

The computer system determines (1922) values (e.g., values 356) for a set of parameters (e.g., set of parameters 354) for the sketch input according to the determined context or saliency. For example, method 1700 describes details of a set of parameters and their respective values. These details are not repeated here for the sake of brevity.

In some embodiments, the computer system determines (1924) according to the one or more annotations and/or the metadata that a first segment of the sketch input has a higher priority than a second segment of the sketch input.

In some embodiments, the computer system assigns (1926) different weights to the first and second segments.

The computer system executes (1928) a query against a database (e.g., database(s) 350) using the set of parameters to retrieve one or more datasets.

The computer system generates (1930) one or more data visualizations from the one or more retrieved dimensional datasets.

The computer system displays (1932), via the user interface, the one or more data visualizations.

Although FIGS. 19A and 19B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

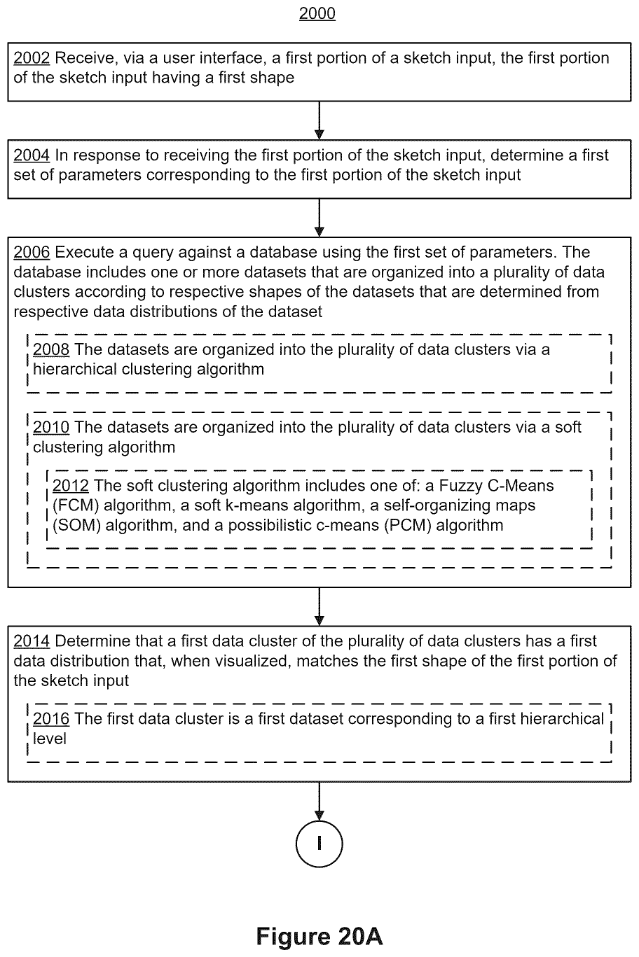

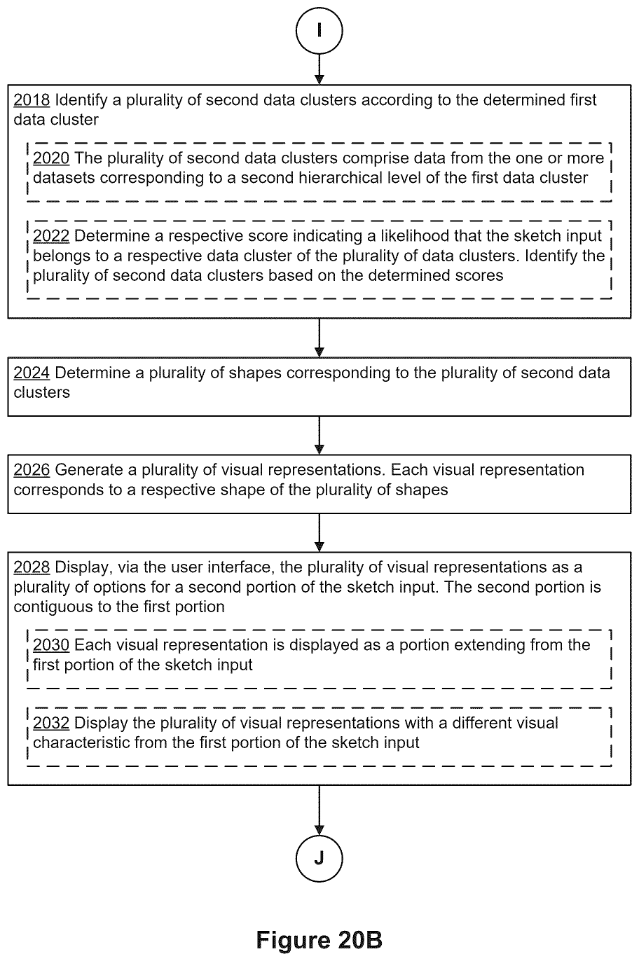

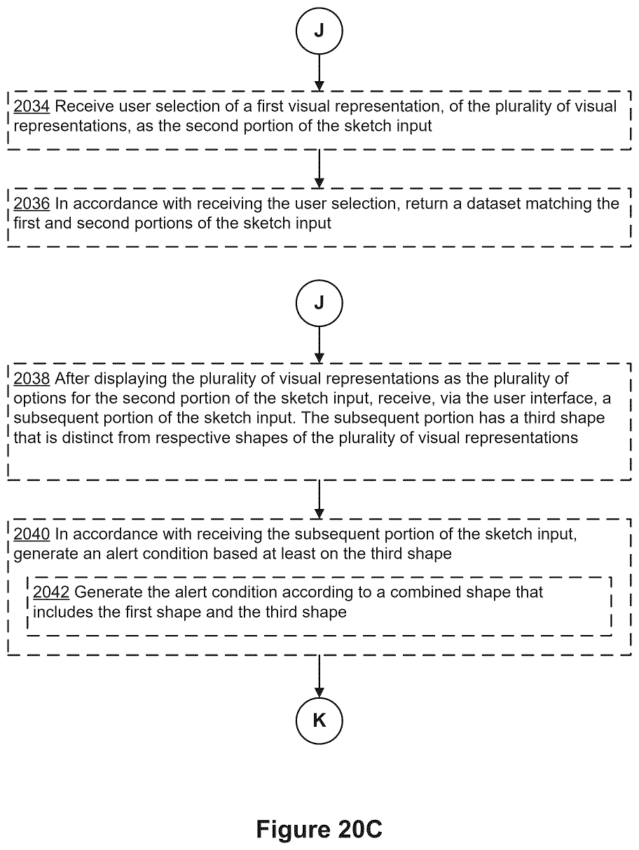

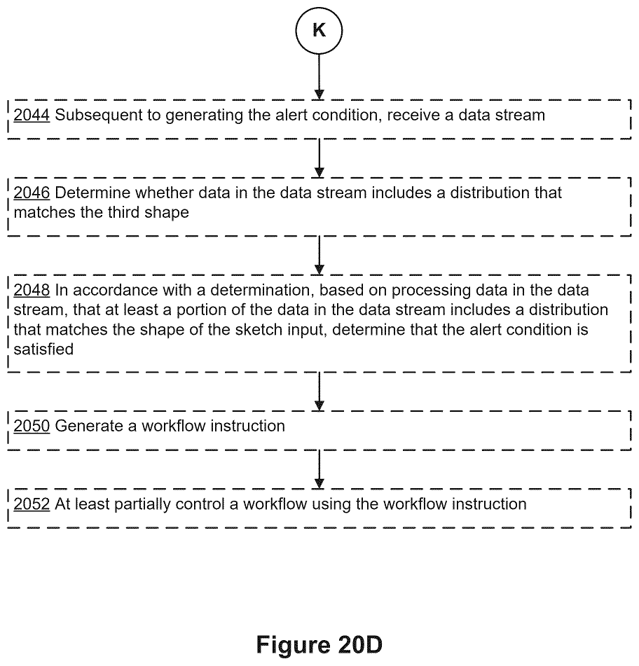

FIGS. 20A to 20D provide a flowchart of an example process for analyzing sketch input data, in accordance with some embodiments. The method 2000 is performed at a computer system (e.g., client device 102 or server system 130) that includes one or more processors (e.g., processor(s) 202 or processor(s) 302) and memory (e.g., memory 206 or memory 314). The memory stores one or more programs configured for execution by the one or more processors. In some embodiments, the operations shown in FIGS. 1, 4A to 4C, 4A to 4C, 5A to 5G, 6A to 6D, 7A to 7D, 8, 9, 10, 11, 12, 13A to 13C, 14A to 14F, 15A to 15E, and 16A to 16P correspond to instructions stored in the memory 206 or other non-transitory computer-readable storage medium. The computer-readable storage medium may include a magnetic or optical disk storage device, solid state storage devices such as Flash memory, or other non-volatile memory device or devices. In some embodiments, the instructions stored on the computer-readable storage medium include one or more of: source code, assembly language code, object code, or other instruction format that is interpreted by one or more processors. Some operations in the method 2000 may be combined with operations in the method 1700, method 1800, method 1900, method 2100, and/or method 2200, and/or the order of some operations may be changed.

In accordance with some embodiments, method 2000 produces a concrete improvement in how the computer system interprets partial sketches, narrows the search space, and guides the user toward valid completions while preserving system performance. When the system receives only a first portion of a sketch, it immediately converts that portion into a normalized parameter set and executes a query against datasets that have been preorganized into shape-based clusters. By matching the initial shape to an appropriate first cluster, the system avoids exhaustive, dataset-wide comparisons and instead focuses computation on a small subset of likely continuations. This early clustering match enables rapid pruning of poor candidates, lowering CPU cycles and memory bandwidth, and reducing latency to the next interactive step.

In some embodiments, the computer system then identifies one or more second clusters that are statistically most consistent with the user's initial shape and synthesizes representative shapes from those clusters as visual “autocompletion” options. Presenting these options as contiguous extensions of the first sketch portion, with distinct visual characteristics, has two technical effects: it reduces user ambiguity and re-query iterations, and it stabilizes the rendering pipeline by limiting expensive recomputations to a bounded set of high-likelihood shapes. Whether the clustering is hierarchical (with level-of-detail slicing) or soft (with graded membership scores), the scoring-driven selection of second clusters provides deterministic, ranked guidance that shortens time to a successful query and improves precision/recall of matches.

Further, in some embodiments as disclosed in the method 2000, if the user draws a subsequent shape that diverges from all suggested continuations, the computer system converts that combined shape into a compact alert descriptor rather than repeatedly failing queries. This conversion yields a reusable, normalized shape specification that can be monitored efficiently against incoming data streams using lightweight per-window comparisons and thresholding, instead of ad hoc visual alignment. As a result, the computer system supports event-driven detection with predictable latency and reduced false positives relative to simple threshold triggers. Upon detecting a matching distribution in the stream, the computer system automatically generates workflow instructions, shortening the loop from pattern occurrence to action and enabling partial or full automation without human intervention on every event.

Overall, method 2000 enhances the functioning of the computer system by: (i) transforming partial sketches into saliency-preserving parameters and using cluster-based pruning to reduce computational cost; (ii) providing ranked, contiguous visual autocompletions that reduce re-queries and stabilize UI updates; and (iii) converting out-of-database continuations into efficient, stream-monitorable alerts that drive automated workflows. These mechanisms collectively increase throughput, lower latency, and improve accuracy at scale across large datasets and concurrent users.

Referring to FIG. 20A, the computer system receives (2002), via a user interface (e.g., user interface 110), a first portion of a sketch input, the first portion of the sketch input having a first shape (e.g., pattern or contour). For example, FIG. 14A illustrates the computer system receive sketch input 1404.

The computer system, in response to receiving the first portion of the sketch input, determines (2004) a first set of parameters (e.g., set of parameters 354) corresponding to the first portion of the sketch input. In some embodiments, the computer system determines values (e.g., values 356) for the first set of parameters corresponding to the first portion of the sketch input. For example, method 1700 describes details of a set of parameters and their respective values. These details are not repeated here for the sake of brevity.

The computer system executes (2006) a query against a database (e.g., database(s) 350) using the first set of parameters. The database includes one or more datasets (e.g., data) that are organized into a plurality of data clusters (e.g., by applying cluster analysis, a supervised learning algorithm, or an unsupervised learning algorithm using models 372) according to respective shapes (e.g., patterns) of the datasets that are determined from respective data distributions of the dataset. This is described, for example, in FIGS. 14A to 14F. For example, in some embodiments, the data clusters are organized according to similarities in their respective data patterns, distributions, and/or shapes.

In some embodiments, the datasets are (2008) organized into the plurality of data clusters via a hierarchical clustering algorithm. In some embodiments, the hierarchy of clusters are visually represented in a hierarchical tree that is also called a dendrogram (e.g., dendrogram 1502), which displays the order in which clusters have been merged or divided and shows the similarity or distance between data points.

In some embodiments, the datasets are (2010) organized into the plurality of data clusters via a soft clustering algorithm. For example, in the soft clustering approach, a data point can belong to multiple categories. In some instances, soft clustering is used when uncertainty exists in cluster boundaries or when there are overlapping clusters.

In some embodiments, the soft clustering algorithm includes (2012) one of: a Fuzzy C-Means (FCM) algorithm, a soft k-means algorithm (Probabilistic K-Means), a self-organizing maps (SOM) algorithm (with Fuzzy Memberships), and a possibilistic c-means (PCM) algorithm.

The computer system determines (2014) that a first data cluster of the plurality of data clusters has a first data distribution that, when visualized, matches the first shape (e.g., pattern) of the first portion of the sketch input.

In some embodiments, the first dataset is (2016) a dataset corresponding to a first hierarchical level (e.g., branch 1406). For example, the first hierarchical level has a first maximum number of clusters (e.g., maximum of two clusters).

Referring to FIG. 20B, the computer system identifies (2018) a plurality of second clusters according to the determined first data cluster.

The plurality of second data clusters comprise (2020) data from the one or more datasets corresponding to a second hierarchical level of the first data cluster (e.g., lower-level hierarchy 1408 or lower-level hierarchy 1412). For example, the second hierarchical level is more granular than the first hierarchical level. The second hierarchical level corresponds to a second maximum number of clusters that is greater than the first maximum of clusters.

In some embodiments, identifying the plurality of second data clusters according to the determined first cluster includes determining (2022) a respective score indicating a likelihood that the sketch input belongs to a respective data cluster of the plurality of data clusters; and identifying the plurality of second data clusters based on the determined scores. For example, in some embodiments, the plurality of second clusters are identified by ranking the plurality of clusters by their scores. In some embodiments, the plurality of second clusters are identified based on having a respective score that exceeds a threshold score.

The computer system determines (2024) a plurality of shapes corresponding to the plurality of second data clusters.

The computer system generates (2026) a plurality of visual representations (e.g., representative curves 1410 and representative curves 1414). Each visual representation corresponds to a respective shape (e.g., one representative shape) of the plurality of shapes.

The computer system displays (2028) (or causes display of), via the user interface, the plurality of visual representations as a plurality of options for a second portion of the sketch input. The second portion is contiguous to the first portion. This is illustrated in FIGS. 14D and 14E.

In some embodiments, each visual representation is (2030) displayed as a portion (e.g., a dashed portion) extending from the first portion of the sketch input. This is illustrated in FIGS. 14D and 14E.

In some embodiments, the computer system displays (2032) (or causes display of) the plurality of visual representations with a different visual characteristic (e.g., different color, different line types (solid lines versus dashed lines), or different line thicknesses) from the first portion of the sketch input. This is illustrated in FIGS. 14D and 14E.

Referring to FIG. 20C, in some embodiments, the computer system receives (2034) user selection of a first visual representation, of the plurality of visual representations, as the second portion of the sketch input. The computer system, in accordance with receiving the user selection, returns (2036) a dataset matching the first and second portions of the sketch input.

In some embodiments, the computer system, after displaying the plurality of visual representations as the plurality of options for the second portion of the sketch input, receives (2038), via the user interface, a subsequent portion of the sketch input, the subsequent portion having a third shape that is distinct from respective shapes of the plurality of visual representations. This is illustrated in FIG. 14F as sketch input 1416.

In some embodiments, the computer system, in accordance with receiving the subsequent portion of the sketch input, generates (2040) an alert condition based at least on the third shape. For example, the computer system generates an alert condition because the shape that the user is interested in does not currently exist not in the database.

In some embodiments, the computer system generates (2042) the alert condition according to a combined shape that includes the first shape and the third shape. This is illustrated in FIG. 14F, which shows the computer system generate an alert condition according to the combined shape of sketch input 1404 and sketch input 1416.

With continued reference to FIG. 20D, in some embodiments, the computer system, subsequent to generating the alert condition, receives (2044) a data stream. The computer system determines (2046) whether data in the data stream includes a distribution that matches the third shape. The computer system, in accordance with a determination, based on processing data in the data stream, that at least a portion of the data in the data stream includes a distribution that matches the shape of the sketch input, determines (2048) that the alert condition is satisfied. The computer system generates a workflow instruction (2050). The computer system at least partially controls a workflow using the workflow instruction (2052). This is illustrated in FIG. 14F.

Although FIGS. 20A to 20D illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

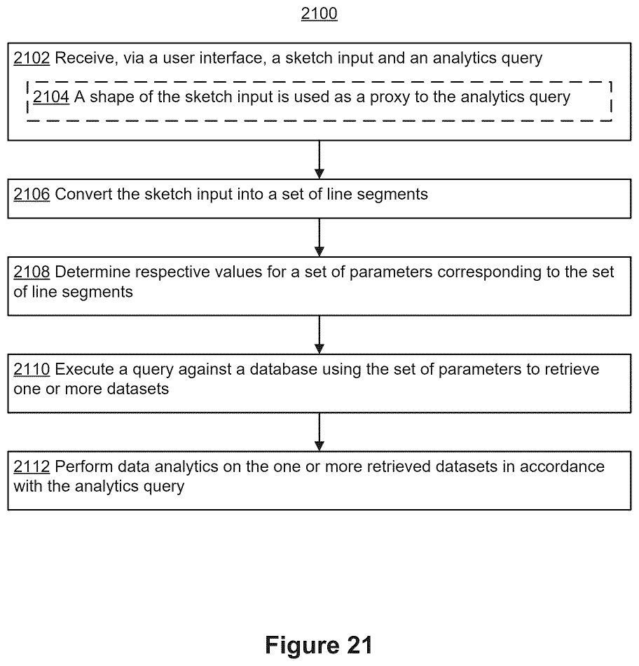

FIG. 21 provides a flowchart of an example process for proxy data analytics, in accordance with some embodiments. The method 2100 is performed at a computer system (e.g., client device 102 or server system 130) that includes one or more processors (e.g., processor(s) 202 or processor(s) 302) and memory (e.g., memory 206 or memory 314). The memory stores one or more programs configured for execution by the one or more processors. In some embodiments, the operations shown in FIGS. 1, 4A to 4C, 4A to 4C, 5A to 5G, 6A to 6D, 7A to 7D, 8, 9, 10, 11, 12, 13A to 13C, 14A to 14F, 15A to 15E, and 16A to 16P correspond to instructions stored in the memory 206 or other non-transitory computer-readable storage medium. The computer-readable storage medium may include a magnetic or optical disk storage device, solid state storage devices such as Flash memory, or other non-volatile memory device or devices. In some embodiments, the instructions stored on the computer-readable storage medium include one or more of: source code, assembly language code, object code, or other instruction format that is interpreted by one or more processors. Some operations in the method 2100 may be combined with operations in the method 1700, method 1800, method 1900, method 2100, and/or method 2200, and/or the order of some operations may be changed.

The computer system receives (2102), via a user interface (e.g., user interface 110), a sketch input (e.g., sketch input 1512) and an analytics query (e.g., analytics query 1520).

In some embodiments, a shape of the sketch input is (2104) used as a proxy to the analytics query. This is discussed in, for example, FIGS. 15A to 15E.

The computer system converts (2106) the sketch input into a set of line segments. Details of converting the sketch input into a set of line segments are described with respect to method 1700, and are not repeated here for the sake of brevity.

The computer system determines (2108) respective values (e.g., values 356) for a set of parameters (e.g., set of parameters 354) corresponding to the set of line segments. In some embodiments, the computer system determines values for the set of parameters. For example, method 1700 describes details of a set of parameters and their respective values. These details are not repeated here for the sake of brevity.

The computer system executes (2110) a query against a database (e.g., database(s) 350) using the set of parameters to retrieve one or more datasets. For example, method 1700 describes details of executing a query against a database using the set of parameters to retrieve one or more datasets. These details are not repeated here for the sake of brevity.

The computer system performs (2112) data analytics on the one or more retrieved datasets in accordance with the analytics query.

Although FIG. 21 illustrates a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

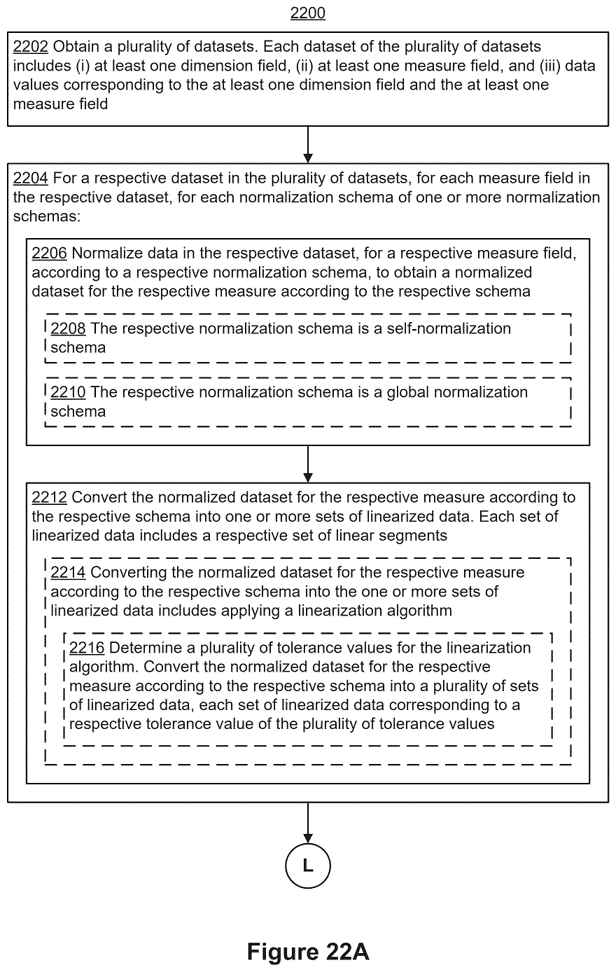

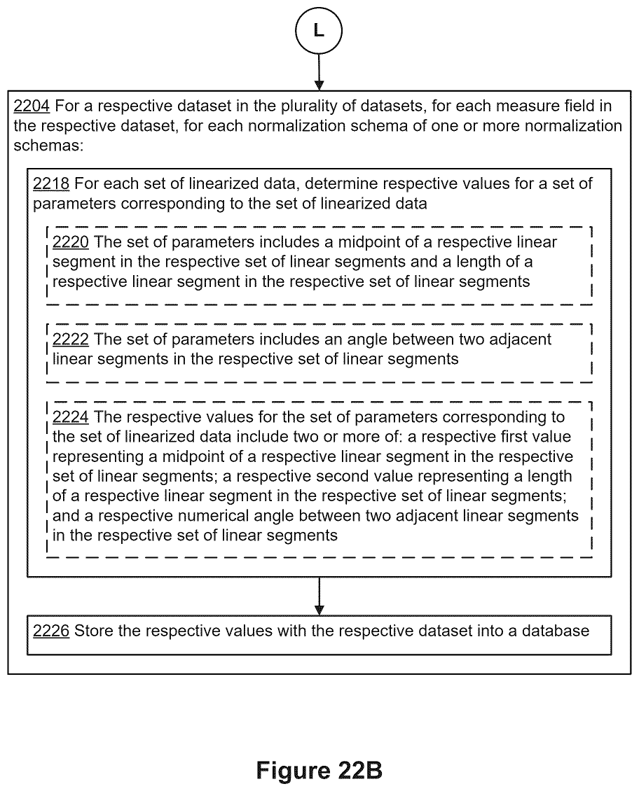

FIGS. 22A and 22B provide a flowchart of an example process for analyzing data, in accordance with some embodiments. The method 2200 is performed at a computer system (e.g., client device 102 or server system 130) that includes one or more processors (e.g., processor(s) 202 or processor(s) 302) and memory (e.g., memory 206 or memory 314). The memory stores one or more programs configured for execution by the one or more processors. In some embodiments, the operations shown in FIGS. 1, 4A to 4C, 4A to 4C, 5A to 5G, 6A to 6D, 7A to 7D, 8, 9, 10, 11, 12, 13A to 13C, 14A to 14F, 15A to 15E, and 16A to 16P correspond to instructions stored in the memory 206 or other non-transitory computer-readable storage medium. The computer-readable storage medium may include a magnetic or optical disk storage device, solid state storage devices such as Flash memory, or other non-volatile memory device or devices. In some embodiments, the instructions stored on the computer-readable storage medium include one or more of: source code, assembly language code, object code, or other instruction format that is interpreted by one or more processors. Some operations in the method 2200 may be combined with operations in the method 1700, method 1800, method 1900, method 2000, and/or method 2100, and/or the order of some operations may be changed.

Referring to FIG. 22A, the computer system obtains (2202) a plurality of datasets. Each dataset of the plurality of datasets includes (i) at least one dimension field (e.g., dimension data field), (ii) at least one measure field (e.g., measure data field), and (iii) data values corresponding to the at least one dimension field and the at least one measure field.

The computer system, for (2204) a respective dataset in the plurality of datasets, for each measure field in the respective dataset, for each normalization schema of one or more normalization schemas, normalizes (2206) data in the respective dataset, for a respective measure field, according to a respective normalization schema, to obtain a normalized dataset for the respective measure according to the respective schema.

In some embodiments, the respective normalization schema is (2208) a self-normalization schema.

In some embodiments, the respective normalization schema is (2210) a global normalization schema.

The computer system converts (2212) the normalized dataset for the respective measure according to the respective schema into one or more sets of linearized data. Each set of linearized data includes a respective set of linear segments.

In some embodiments, converting the normalized dataset for the respective measure according to the respective schema into the one or more sets of linearized data includes applying (2214) a linearization algorithm.

In some embodiments, the computer system determines (2216) a plurality of tolerance values (e.g., epsilon values, where “epsilon” represents a threshold distance that defines the maximum allowed deviation between the original curve and the simplified curve generated by the algorithm) for the linearization algorithm. The converting includes converting the normalized dataset for the respective measure according to the respective schema into a plurality of sets of linearized data. Each set of linearized data corresponds to a respective tolerance value of the plurality of tolerance values.

Referring to FIG. 22B, the computer system, for (2204) a respective dataset in the plurality of datasets, for each measure field in the respective dataset, for each normalization schema of one or more normalization schemas, for each set of linearized data, determines (2218) respective values for a set of parameters corresponding to the set of linearized data.

In some embodiments, the set of parameters includes (2220) a midpoint of a respective linear segment in the respective set of linear segments and a length of a respective linear segment in the respective set of linear segments.

In some embodiments, the set of parameters includes (2222) an angle between two adjacent linear segments in the respective set of linear segments.

In some embodiments, the respective values for the set of parameters corresponding to the set of linearized data includes (2224) two or more of: a respective first value (e.g., a normalized value from 0 to 1) representing a midpoint of a respective linear segment in the respective set of linear segments and a respective second value (e.g., a normalized value from 0 to 1) representing a length of a respective linear segment in the respective set of linear segments, and a respective numerical angle (e.g., a numerical value) between two adjacent linear segments in the respective set of linear segments.

The computer system stores (2226) (e.g., saves) the respective values with the respective dataset into the database (e.g., database(s) 350).

Although FIGS. 22A and 22B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

Turning now to some example embodiments:

(A1) In one aspect, some embodiments include a method for analyzing data. In some embodiments, the method is performed at a computer system that includes one or more processors and memory. The method includes (i) receiving, via a user interface, a first sketch input corresponding to a first measure data field of a dataset; (ii) converting the first sketch input into a first set of line segments; (iii) determining respective values for a first set of parameters corresponding to the first set of line segments; (iv) executing a first query against a database of linearized data using the first set of parameters to identify one or more sets of linearized data from the database, each set of linearized data corresponding to a respective dimensional dataset for the first measure data field; (v) retrieving, from the database, one or more first dimensional datasets corresponding to the one or more sets of linearized data; (vi) generating one or more first data visualizations from the one or more retrieved first dimensional datasets; and (vii) displaying, via the user interface, the one or more first data visualizations.

(A2) In some embodiments of A1, converting the first sketch input into a first set of line segments includes applying a linearization algorithm.

(A3) In some embodiments of A2, the linearization algorithm recursively generates straight-line segments from the first sketch input; and the method includes, for a respective iteration of the algorithm: for a respective straight-line segment having a respective start point and a respective end point: (a) identifying a point on the first sketch input that has a largest vertical distance from the first sketch input to the respective straight-line segment; and (b) generating (i) a first straight-line sub-segment that connects the respective start point and the point and (ii) a second straight-line sub-segment that connects the point and the respective end point.

(A4) In some embodiments of A2 or A3, the linearization algorithm includes one of: Douglas-Peucker algorithm, Visvalingam-Whyatt algorithm, Reumann-Witkam algorithm, and Opheim algorithm.

(A5) In some embodiments of any of A1-A4, converting the first sketch input into a first set of line segments includes applying a spline interpolation algorithm.

(A6) In some embodiments of any of A1-A5, the first set of parameters corresponding to the first set of line segments includes: a midpoint of a respective line segment in the first set of line segments; and a length of a respective line segment in the first set of line segments.

(A7) In some embodiments of any of A1-A6, the first set of parameters corresponding to the first set of line segments includes an angle between two adjacent line segments in the first set of line segments.

(A8) In some embodiments of any of A1-A7, the first set of parameters corresponding to the first set of line segments includes an angle between (i) a respective line segment of the first set of line segments and (ii) a horizontal axis.

(A9) In some embodiments of A8, determining the respective values for the first set of parameters includes determining a normalized value for a numerical angle between the respective line segment and the horizontal axis.

(A10) In some embodiments of any of A1-A9, the first set of parameters corresponding to the first set of line segments includes a slope between (i) a respective line segment of the first set of line segments and (ii) a horizontal axis.

(A11) In some embodiments of A10, the horizontal axis has a temporal unit.

(A12) In some embodiments of any of A1-A11, the first sketch input corresponds to the first measure data field and a second measure data field; and the first set of parameters corresponding to the first set of line segments includes (1) a time rate of change of respective values of the first measure data field; and (2) a time rate of change of respective values of the second measure data field.

(A13) In some embodiments of A12, determining the respective values for the first set of parameters further includes receiving specification of respective date/time spans for the respective values of the first and second measure data fields via the user interface.

(A14) In some embodiments of any of A1-A13, the first set of parameters corresponding to the first set of line segments includes a date/time span of at least a portion of the first set of line segments.

(A15) In some embodiments of any of A1-A14, the respective values for the first set of parameters corresponding to the first set of line segments includes two or more of: (i) a respective first value representing a midpoint of a respective line segment in the first set of line segments; (ii) a respective second value representing a length of a respective line segment in the first set of line segments; and (iii) a respective numerical angle between two adjacent line segments in the first set of line segments.

(A16) In some embodiments of any of A1-A15, the database includes multiple sets of linearized data, each set of linearized data including a respective set of linear segments; and executing the query against the database of linearized data includes determining a relative fit between (i) the first set of line segments and (ii) a first set of linear segments from a first set of linearized data in the database according to a predetermined metric.

(A17) In some embodiments of A16, the predetermined metric includes one of: R-squared statistic, a root mean square error (RMSE), a mean absolute error (MAE), a sum of square error, a chi-square value, a sum of absolute differences, and an average of absolute differences.

(A18) In some embodiments of any of A1-A17, the database includes multiple sets of linearized data, each set of linearized data including a set of linear segments. Executing the query against the database of linearized data using the first set of parameters includes: (i) determining, for a first set of linearized data in the database, a shape query error score based on one or more of: a rotation transform, a translation transform, and a scaling transform that is applied to the first set of line segments to match the first set of linearized data.

(A19) In some embodiments of any of A1-A18, the database includes multiple sets of linearized data, each set of linearized data including a set of linear segments. Executing the query against the database of linearized data using the first set of parameters includes determining, for a first set of linearized data in the database, a shape error score based on a first absolute difference value between (i) a value corresponding to a midpoint of a line segment in the first set of line segments and (ii) a value corresponding to a midpoint of a respective linear segment in the first set of linearized data; a second absolute difference value between (i) a second value corresponding to a length of a line segment in the first set of line segments and (ii) a value corresponding a length of the respective linear segment in the first set of linearized data; and a third absolute difference value between (i) an angle between two adjacent line segments in the first set of line segments and (ii) an angle between two adjacent linear segments in the first set of linearized data.

(A20) In some embodiments of A19, the shape error score is an aggregation of the first absolute difference value, the second absolute difference value, and the third absolute difference value.

(A21) In some embodiments of A19 or A20, the shape error score is an aggregation comprises a weighted aggregation value that is determined by applying a respective weight to at least one of the first absolute difference value, the second absolute difference value, or the third absolute difference value.

(A22) In some embodiments of any of A1-A21, the method further comprises, prior to executing the first query, receiving specification of one of a self-normalization schema or a global normalization schema for executing the query.

(A23) In some embodiments of any of A1-A22, the method further comprises, while receiving the first sketch input: (i) encoding the first sketch input with a first color; and (ii) displaying the first sketch input on the user interface with the first color as the sketch input is received.

(A24) In some embodiments of A23, the method further comprises, (i) while displaying the first sketch input on the user interface, receiving via the user interface a second sketch input corresponding to a second measure data field of the dataset; (ii) converting the second sketch input into a second set of line segments; (iii) determining a second set of parameters corresponding to the second set of line segments; (iv) executing a second query against the database of linearized data to retrieve, from the database, one or more second dimensional datasets that are within a fit threshold of the second set of parameters; and (v) generating and displaying, via the user interface, one or more second data visualizations from the one or more second dimensional datasets.

(A25) In some embodiments of A24, the second sketch input is encoded with a second color, different from the first color.

(A26) In some embodiments of any of A1-A25, the method further comprises storing the first sketch input in a sketch library.

(A27) In some embodiments of any of A1-A26, the method further comprises: prior to receiving the first sketch input, displaying a drawing canvas on the user interface, wherein the first sketch input is received via the drawing canvas.

(A28) In some embodiments of A27, the drawing canvas is a blank canvas.

(A29) In some embodiments of A27, displaying the drawing canvas further includes displaying a predefined background image overlaid on the drawing canvas.

(A30) In some embodiments of A29, the predefined background image comprises an image of a map.

(A31) In some embodiments of any of A1-A30, receiving the first sketch input includes receiving user specification of a date/time span for at least a portion of the first sketch input.

(A32) In some embodiments of A31, the user specification of the date/time span is received via one or more annotations on the first sketch input.

(A33) In some embodiments of A31 or A32, the user specification of the date/time span is received via user selection of a date/time span option that is displayed on the user interface.

(B1) In another aspect, some embodiments include a method for analyzing data. In some embodiments, the method is performed at a computer system that includes one or more processors and memory. The method includes (a) receiving a sketch input; (b) in response to receiving the sketch input: (b-i) executing a query against a database to determine whether the database includes one or more datasets whose data distribution matches a shape of the sketch input; and (b-ii) in accordance with a determination that the database does not include a dataset whose distribution matches the shape of the sketch input, generating an alert condition according to the shape of the sketch input; (c) receiving a data stream; (d) determining whether data in the data stream includes a distribution that matches the shape of the sketch input; (e) in accordance with a determination, based on processing data in the data stream, that at least a portion of the data in the data stream includes a distribution that matches the shape of the sketch input: (e-1) determining that the alert condition is satisfied; and (e-2) generating a workflow instruction; and (e-3) at least partially controlling a workflow using the workflow instruction.

(B2) In some embodiments of B1, receiving the sketch input includes receiving one or more annotations with the sketch input.

(B3) In some embodiments of B2, the one or more annotations include at least one of: (a) a start value and an end value for a first portion of the sketch input; (b) a change in value for a second portion of the sketch input; (c) a timespan corresponding to the sketch input; (d) a unit of measurement for a horizontal axis of the sketch input; and (e) a unit of measurement for a vertical axis of the sketch input.

(B4) In some embodiments of B2 or B3, the one or more annotations include user specification of a salient feature at a portion of the sketch input.

(B5) In some embodiments of any of B1-B4, the data stream comprises a real time data stream.

(B6) In some embodiments of any of B1-B5, wherein determining whether data in the data stream includes a distribution that matches the shape of the sketch input includes determining a rate of change of values of the data in the data stream.

(B7) In some embodiments of any of B1-B6, wherein determining whether data in the data stream includes a distribution that matches the shape of the sketch input includes determining whether the data in the data stream satisfies a threshold value.

(B8) In some embodiments of any of B1-B7, wherein generating a workflow instruction includes controlling an automated process.

(B9) In some embodiments of any of B1-B8, wherein generating the workflow instruction includes causing a notification to be sent to a plurality of electronic devices.

(B10) In some embodiments of any of B1-B9, wherein executing the query against the database includes inputting the sketch input into a machine learning model that is configured to translate the sketch into a data query.

(B11) In some embodiments of any of B1-B10, wherein the sketch input comprises a data pattern.

(B12) In some embodiments of any of B1-B11, wherein the data stream is generated by a plurality of sensors installed at a physical location.

(B13) In some embodiments of any of B1-B12, the method further comprises: in accordance with a determination that the database includes a first dataset whose distribution matches the shape of the sketch input: (a) retrieving the first dataset from the database; (b) generating one or more data visualizations from the first dataset; and (c) causing display of the one or more data visualizations.

(C1) In another aspect, some embodiments include a method that is performed at a computer system that includes a display, one or more sensors, memory, and one or more processors. The method includes (a) receiving, via the display, a sketch input directed to a data source; in response to receiving the sketch input: (b) determining one or more of (b-i) one or more annotations included with the sketch input, and (b-ii) metadata corresponding to the sketch input; (c) determining a context or saliency of the sketch input according to the one or more annotations and/or the metadata; (d) determining values for a set of parameters for the sketch input according to the determined context or saliency; (e) executing a query against a database using the set of parameters to retrieve one or more datasets; (f) generating one or more data visualizations from the one or more retrieved datasets; and (g) displaying, via the display, the one or more data visualizations.

(C2) In some embodiments of C1, the one or more annotations include at least one of: (a) a start value and an end value for a first portion of the sketch input; (b) a change in value for a second portion of the sketch input; (c) a timespan of the sketch input; (d) a unit of measurement for a horizonal axis of the sketch input; and (e) a unit of measurement for a vertical axis of the sketch input.

(C3) In some embodiments of C1 or C2, the metadata includes explicit metadata; and the explicit metadata includes one or more of: (a) a color of the sketch input; (b) a thickness of a respective stroke of the sketch input; and (c) a nib type of an input device that is used for the sketch input.

(C4) In some embodiments of any of C1-C3, the metadata includes implicit metadata; and the implicit metadata includes one or more of: (a) a pressure detected by the display while the sketch input is received; (b) a dwell time for a respective portion of the sketch input; and (c) a drawing speed for a respective portion of the sketch input.

(C5) In some embodiments of any of C1-C4, wherein determining the context or saliency of the sketch input includes determining according to the one or more annotations and/or the metadata that a first segment of the sketch input has a higher priority than a second segment of the sketch input.

(C6) In some embodiments of C5, further comprising assigning different weights to the first and second segments.

(C7) In some embodiments of any of C1-C6, the one or more sensors include one or more of: a resistive touch sensor, a capacitive sensor, or a pressure sensor.

(C8) In some embodiments of any of C1-C7, (a) the sketch input is received from a stylus that includes a built-in tilt sensor; and (b) the method further comprises receiving information from the built-in tilt sensor of the stylus, wherein the context or saliency of the sketch input is determined further in accordance with the received information.

(D1) In another aspect, some embodiments include a method that is performed at a computer system that includes one or more processors and memory. The method comprises (a) receiving, via a user interface, a first portion of a sketch input, the first portion of the sketch input having a first shape; (b) in response to receiving the first portion of the sketch input, determining a first set of parameters corresponding to the first portion of the sketch input; (c) executing a query against a database using the first set of parameters, wherein the database includes one or more datasets that are organized into a plurality of data clusters according to respective shapes of the datasets that are determined from respective data distributions of the dataset; (d) determining that a first data cluster of the plurality of data clusters has a first data distribution that, when visualized, matches the first shape of the first portion of the sketch input; (e) identifying a plurality of second data clusters according to the determined first data cluster, and determining a plurality of shapes corresponding to the plurality of second data clusters; (f) generating a plurality of visual representations, each visual representation corresponding to a respective shape of the plurality of shapes; and (g) displaying, via the user interface, the plurality of visual representations as a plurality of options for a second portion of the sketch input, wherein the second portion is contiguous to the first portion.

(D2) In some embodiments of D1, (a) the datasets are organized into the plurality of data clusters via a hierarchical clustering algorithm; (b) the first data cluster is a first dataset corresponding to a first hierarchical level; and (c) the plurality of second data clusters comprise data from the one or more datasets corresponding to a second hierarchical level of the first data cluster.

(D3) In some embodiments of D1 or D2, (a) the datasets are organized into the plurality of data clusters via a soft clustering algorithm; and (b) identifying the plurality of second data clusters according to the determined first cluster includes: (b-i) determining a respective score indicating a likelihood that the sketch input belongs to a respective data cluster of the plurality of data clusters; and (b-ii) identifying the plurality of second data clusters based on the determined scores.

(D4) In some embodiments of D3, the soft clustering algorithm includes one of: a Fuzzy C-Means (FCM) algorithm, a soft k-means algorithm, a self-organizing maps (SOM) algorithm, and a possibilistic c-means (PCM) algorithm.

(D5) In some embodiments of any of D1-D4, wherein each visual representation is displayed as a portion extending from the first portion of the sketch input.

(D6) In some embodiments of any of D1-D5, the method further comprises displaying the plurality of visual representations with a different visual characteristic from the first portion of the sketch input.

(D7) In some embodiments of any of D1-D6, the method further comprises (a) receiving user selection of a first visual representation, of the plurality of visual representations, as the second portion of the sketch input; and (b) in accordance with receiving the user selection, returning a dataset matching the first and second portions of the sketch input.

(D8) In some embodiments of any of D1-D7, the method further comprises, after displaying the plurality of visual representations as the plurality of options for the second portion of the sketch input: (a) receiving, via the user interface, a subsequent portion of the sketch input, the subsequent portion having a third shape that is distinct from respective shapes of the plurality of visual representations; and (b) in accordance with receiving the subsequent portion of the sketch input, generating an alert condition based at least on the third shape.

(D9) In some embodiments of D8, the method further comprises generating the alert condition according to a combined shape that includes the first shape and the third shape.

(D10) In some embodiments of D8 or D9, the method further comprises: (a) subsequent to generating the alert condition, receiving a data stream; (b) determining whether data in the data stream includes a distribution that matches the third shape; and (c) in accordance with a determination, based on processing data in the data stream, that at least a portion of the data in the data stream includes a distribution that matches the shape of the sketch input: (d) determining, that the alert condition is satisfied; and (e) generating a workflow instruction; and (f) at least partially controlling a workflow using the workflow instruction.

(E1) In another aspect, some embodiments include a method that is performed at a computer system that includes one or more processors and memory. The method comprises (a) receiving, via a user interface, a sketch input and an analytics query; (b) converting the sketch input into a set of line segments; (c) determining respective values of a set of parameters corresponding to the set of line segments; (d) executing a query against a database using the set of parameters to retrieve one or more datasets; and (e) performing data analytics on the one or more retrieved datasets in accordance with the analytics query.

(E2) In some embodiments of E1, a shape of the sketch input is used as a proxy to the analytics query.

(F1) In another aspect, some embodiments include a method for preparing data for subsequent analysis. In some embodiments, the method is performed at a computer system that includes one or more processors and memory. The method comprises (a) obtaining a plurality of datasets, wherein each dataset of the plurality of datasets includes (i) at least one dimension field, (ii) at least one measure field, and (iii) data values corresponding to the at least one dimension field and the at least one measure field; (b) for a respective dataset in the plurality of datasets, for each measure field in the respective dataset, for each normalization schema of one or more normalization schemas: (c) normalizing data in the respective dataset, for a respective measure field, according to a respective normalization schema, to obtain a normalized dataset for the respective measure according to the respective schema; (d) converting the normalized dataset for the respective measure according to the respective schema into one or more sets of linearized data, wherein each set of linearized data includes a respective set of linear segments; (e) for each set of linearized data, determining respective values for a set of parameters corresponding to the set of linearized data; and (f) saving the respective values with the respective dataset into a database.

(F2) In some embodiments of F1, converting the normalized dataset for the respective measure according to the respective schema into the one or more sets of linearized data includes applying a linearization algorithm.

(F3) In some embodiments of F2, the method further comprises determining a plurality of tolerance values for the linearization algorithm; wherein the converting includes converting the normalized dataset for the respective measure according to the respective schema into a plurality of sets of linearized data, each set of linearized data corresponding to a respective tolerance value of the plurality of tolerance values.

(F4) In some embodiments of any of F1-F3, the set of parameters includes (a) a midpoint of a respective linear segment in the respective set of linear segments; and (b) a length of a respective linear segment in the respective set of linear segments.

(F5) In some embodiments of any of F1-F4, wherein the set of parameters includes an angle between two adjacent linear segments in the respective set of linear segments.

(F6) In some embodiments of any of F1-F5, wherein the respective values for the set of parameters corresponding to the set of linearized data include two or more of: (a) a respective first value representing a midpoint of a respective linear segment in the respective set of linear segments; (b) a respective second value representing a length of a respective linear segment in the respective set of linear segments; and (c) a respective numerical angle between two adjacent linear segments in the respective set of linear segments.

(F7) In some embodiments of any of F1-F6, wherein the respective normalization schema is a self-normalization schema.

(F8) In some embodiments of any of F1-F7, wherein the respective normalization schema is a global normalization schema.

In another aspect, some embodiments include a computer system that includes one or more processors and memory coupled to the one or more processors. The memory stores one or more programs configured for execution by the one or more processors. The one or more programs include instructions for performing any of the methods described herein (e.g., A1-A33, B1-B13, C1-C8, D1-D10, E1-E2, and F1-F8 above).

In another aspect, some embodiments include a non-transitory computer-readable storage medium that stores one or more programs configured for execution by one or more processors of a computer system. The one or more programs include instructions for performing any of the methods described herein (e.g., A1-A33, B1-B13, C1-C8, D1-D10, E1-E2, and F1-F8 above).

Various embodiments described herein may be combined. In addition, one or more operations described with one method may be included in another method. For brevity, such details are not repeated herein.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

As used herein, the term “exemplary” means “serving as an example, instance, or illustration,” and does not necessarily indicate any preference or superiority of the example over any other configurations or embodiments.

As used herein, the term “and/or” encompasses any combination of listed elements. For example, “A, B, and/or C” entails each of the following possibilities: A only, B only, C only, A and B without C, A and C without B, B and C without A, and a combination of A, B, and C.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method for analyzing data, performed at a computer system that includes one or more processors and memory, the method comprising
receiving, via a user interface, a first sketch input corresponding to a first measure data field of a dataset;
converting the first sketch input into a first set of line segments;
determining respective values for a first set of parameters corresponding to the first set of line segments;
executing a first query against a database of linearized data using the first set of parameters to identify one or more sets of linearized data from the database, each set of linearized data corresponding to a respective dimensional dataset for the first measure data field;
retrieving, from the database, one or more first dimensional datasets corresponding to the one or more sets of linearized data;
generating one or more first data visualizations from the one or more retrieved first dimensional datasets; and
displaying, via the user interface, the one or more first data visualizations.

2. The method of claim 1, wherein:
converting the first sketch input into a first set of line segments includes applying a linearization algorithm that recursively generates straight-line segments from the first sketch input; and
the method further comprises:
for a respective iteration of the algorithm, and for a respective straight-line segment having a respective start point and a respective end point:
identifying a point on the first sketch input that has a largest vertical distance from the first sketch input to the respective straight-line segment; and
generating (i) a first straight-line sub-segment that connects the respective start point and the point and (ii) a second straight-line sub-segment that connects the point and the respective end point.

3. The method of claim 1, wherein the first set of parameters corresponding to the first set of line segments includes:
a midpoint of a respective line segment in the first set of line segments; and
a length of a respective line segment in the first set of line segments.

4. The method of claim 1, wherein the first set of parameters corresponding to the first set of line segments includes an angle between two adjacent line segments in the first set of line segments.

5. The method of claim 1, wherein:
the first set of parameters corresponding to the first set of line segments includes an angle between (i) a respective line segment of the first set of line segments and (ii) a horizontal axis; and
determining the respective values for the first set of parameters includes determining a normalized value for a numerical angle between the respective line segment and the horizontal axis.

6. The method of claim 1, wherein the first set of parameters corresponding to the first set of line segments includes a slope between (i) a respective line segment of the first set of line segments and (ii) a horizontal axis having a temporal unit.

7. The method of claim 1, wherein:
the first sketch input corresponds to the first measure data field and a second measure data field; and
the first set of parameters corresponding to the first set of line segments includes:
a time rate of change of respective values of the first measure data field; and
a time rate of change of respective values of the second measure data field.

8. The method of claim 7, wherein determining the respective values for the first set of parameters further comprises:
receiving specification of respective date/time spans for the respective values of the first and second measure data fields via the user interface.

9. The method of claim 1, wherein the first set of parameters corresponding to the first set of line segments includes a date/time span of at least a portion of the first set of line segments.

10. The method of claim 1, wherein the respective values for the first set of parameters corresponding to the first set of line segments includes two or more of:
a respective first value representing a midpoint of a respective line segment in the first set of line segments;
a respective second value representing a length of a respective line segment in the first set of line segments; and
a respective numerical angle between two adjacent line segments in the first set of line segments.

11. A computer system, comprising:
one or more processors; and
memory coupled to the one or more processors, the memory storing one or more programs configured for execution by the one or more processors, the one or more programs including instructions for:
receiving, via a user interface, a first sketch input corresponding to a first measure data field of a dataset;
converting the first sketch input into a first set of line segments;
determining respective values for a first set of parameters corresponding to the first set of line segments;
executing a first query against a database of linearized data using the first set of parameters to identify one or more sets of linearized data from the database, each set of linearized data corresponding to a respective dimensional dataset for the first measure data field;
retrieving, from the database, one or more first dimensional datasets corresponding to the one or more sets of linearized data;
generating one or more first data visualizations from the one or more retrieved first dimensional datasets; and
displaying, via the user interface, the one or more first data visualizations

12. The computer system of claim 11, wherein:
the database includes multiple sets of linearized data, each set of linearized data including a set of linear segments; and
the instructions for executing the first query against the database of linearized data using the first set of parameters include instructions for:
determining, for a first set of linearized data in the database, a shape error score based on
a first absolute difference value between (i) a value corresponding to a midpoint of a line segment in the first set of line segments and (ii) a value corresponding to a midpoint of a respective linear segment in the first set of linearized data;
a second absolute difference value between (i) a second value corresponding to a length of a line segment in the first set of line segments and (ii) a value corresponding a length of the respective linear segment in the first set of linearized data; and
a third absolute difference value between (i) an angle between two adjacent line segments in the first set of line segments and (ii) an angle between two adjacent linear segments in the first set of linearized data.

13. The computer system of claim 11, wherein the one or more programs further include instructions for:
prior to executing the first query, receiving specification of one of a self-normalization schema or a global normalization schema for executing the first query.

14. The computer system of claim 11, wherein the one or more programs further include instructions for:
storing the first sketch input in a sketch library.

15. The computer system of claim 11, wherein the instructions for receiving the first sketch input include instructions for:
receiving one or more user annotations on the first sketch input, the one or more user annotations including user specification of a date/time span for at least a portion of the first sketch input.

16. A non-transitory computer-readable storage medium storing one or more programs for execution by one or more processors of a computer system that includes one or more processors and memory, the one or more programs including instructions for:
receiving, via a user interface, a first sketch input corresponding to a first measure data field of a dataset;
converting the first sketch input into a first set of line segments;
determining respective values for a first set of parameters corresponding to the first set of line segments;
executing a first query against a database of linearized data using the first set of parameters to identify one or more sets of linearized data from the database, each set of linearized data corresponding to a respective dimensional dataset for the first measure data field;
retrieving, from the database, one or more first dimensional datasets corresponding to the one or more sets of linearized data;
generating one or more first data visualizations from the one or more retrieved first dimensional datasets; and
displaying, via the user interface, the one or more first data visualizations.

17. The non-transitory computer-readable storage medium of claim 16, the one or more programs further including instructions for:
while receiving the first sketch input:
encoding the first sketch input with a first color; and
displaying the first sketch input on the user interface with the first color as the first sketch input is received.

18. The non-transitory computer-readable storage medium of claim 17, the one or more programs further including instructions for:
while displaying the first sketch input on the user interface, receiving via the user interface a second sketch input corresponding to a second measure data field of the dataset;
converting the second sketch input into a second set of line segments;
determining a second set of parameters corresponding to the second set of line segments;
executing a second query against the database of linearized data to retrieve, from the database, one or more second dimensional datasets that are within a fit threshold of the second set of parameters; and
generating and displaying, via the user interface, one or more second data visualizations from the one or more second dimensional datasets.

19. The non-transitory computer-readable storage medium of claim 16, the one or more programs further including instructions for, wherein:
the database includes multiple sets of linearized data, each set of linearized data including a respective set of linear segments; and
the instructions for executing the first query against the database of linearized data include instructions for determining a relative fit between (i) the first set of line segments and (ii) a first set of linear segments from a first set of linearized data in the database according to a predetermined metric.

20. The non-transitory computer-readable storage medium of claim 16, wherein:
the database includes multiple sets of linearized data, each set of linearized data including a set of linear segments; and
executing the first query against the database of linearized data using the first set of parameters includes:
determining, for a first set of linearized data in the database, a shape query error score based on one or more of: a rotation transform, a translation transform, and a scaling transform that is applied to the first set of line segments to match the first set of linearized data.
